(19) United States
(12) Patent Application Publication
(10) Pub. No.: US 2004/0048978 A1
(43) Pub. Date: Mar. 11, 2004

(54) Photosensitive resin composition, solder resist comprising the same, cover lay film, and printed circuit board

(76) Inventors: Koji Okada, Shiga (JP); Kaoru Takagahara, Shiga (JP)

Correspondence Address: HOGAN & HARTSON L.L.P., 500 S. GRAND AVENUE, SUITE 1900, LOS ANGELES, CA, 90071-2611, US

(21) Appl. No.: 10/399,268

(22) PCT Filed: Oct. 15, 2001
(86) PCT No.: PCT/JP01/09053

(30) Foreign Application Priority Data
Oct. 16, 2000 (JP) 2000-315946

(51) Int. Cl. C08K 3/00

(52) U.S. Cl. 524/606

(57) ABSTRACT

The present invention relates to a photosensitive resin composition having excellent heat resistance, processability, and adhesion, and a solder resist comprising the composition, a cover lay film, and a printed circuit board obtained from or with these. The cover lay film is excellent in processability and adhesion at relatively low temperatures and has a low elastic coefficient after curing while keeping sufficient mechanical strength, so that the cover lay film is preferably used for a printed circuit board or a hard disk. The cover lay film is soluble and can be laminated at temperatures of not higher than 150° C., and a solder resist having excellent properties, such as heat resistance which can be laminated directly onto FPC without any adhesives and a cover lay film having few warps when laminated onto the FPC can be provided according to the present invention. The photosensitive resin composition comprises as essential components: a soluble polyimide (A) dissolved in solvent having a boiling point of not higher than 120° C.; and a compound (B) having at least one aromatic ring and at least 2 double bonds in one molecule, wherein the soluble polyimide is one obtained at least from an acid dianhydride having 1 to 6 aromatic rings or alicyclic acid dianhydride and/or a diamine having 1 to 6 aromatic rings. The solder resist, cover lay film, etc. are excellent in heat resistance and mechanical properties and do not damage the substrate because they can be laminated at relatively low temperatures.

### TECHNICAL FIELD

The present invention relates to a photosensitive resin composition having excellent heat resistance, processability, and adhesion, and a photosensitive film, a solder resist, a photosensitive cover lay film and a printed circuit board using them. A cover lay film of the present invention is excellent in processability and adhesion at relatively low temperatures while having sufficient mechanical strength, is low in elastic coefficient after cured, and is preferably used as a cover lay film for a printed circuit board or a hard disk.

### BACKGROUND ART

Recently, as electronic devices have been more and more multifunctional, high-performance, and downsized, electronic parts has been demanded to be downsizing and weight reduction of. Therefore, there has been a sharply growing demand for flexible printed circuit boards (hereinafter referred to as FPC) having pliability used as wiring boards for packaging electronic parts, in comparison with ordinary rigid printed circuit boards.

FPC has a structure of which a film called a cover lay film made of polyimide or the like is laminated on the surface of a circuit, for the purpose of protecting a surface of conductor of a circuit made of copper foil or the like. A common method for bonding a cover lay film thereon is working a cover lay film with adhesive on its one side into a predetermined shape, wrapping the cover lay film to a copper-clad laminate (hereinafter referred to us as CCL) composed of a circuit, aligning, and then thermo compression bonding by pressing and the like. However, epoxy-type adhesives and acrylic-type adhesives or the like are mainly used as adhesives. Therefore, these adhesives have problems with low heat resistance such as soldering heat resistance and adhesion strength at high temperatures, and poor pliability or the like, as a result, polyimide films used as cover lay films have not been fully exploited.

Further, when a cover lay film was bonded to a CCL using a conventional adhesive, it was necessary before bonding for the cover lay film to be worked of kinds of bore or window on a terminal area of the circuit and a joint with its parts. In addition to difficulty in boring a hole or the like on a thin cover lay film, positioning for placing the cover lay film having a hole or the like at a predetermined position of the CCL has been performed by almost manual. Accordingly, the accuracy of position has been poor, and processability for laminating has also been poor, which has led to a disadvantage, such as high costs.

Moreover, perforation of a cover lay film is performed by laser drilling or plasma etching after bonding the cover lay film to the CCL, however, in spite of very excellent accuracy of position, problems have been raised that it takes time to bore a hole and the cost on the apparatus itself and the cost on operating the apparatus are extremely high.

To improve the processability and accuracy of position at a hole or the like, a method for forming a protective layer by applying a photosensitive composition onto the conductor side has been developed. Further, photosensitive cover lay films have been developed, which has enabled to bore a hole at the position precisely as required by forming patterns by the exposure to light and developing after laminating a cover lay film onto the FPC. This has improved processability and accuracy of position.

However, the above-mentioned cover lay film has a disadvantage in low heat resistance and low strength of film because of generally using an acrylic-type adhesive. Accordingly, a further improvement has been demanded.

On the other hand, polyimides are suitable for a photosensitive materials for its high heat resistance and high strength of film thereof, however, for its lack of solubility in solvent and an alkali developer, when photosensitive polyimides are applied onto a cover lay film, polyimide must be subjected for use of a cover lay film to a series of steps of previously laminating on FPC in a state of a polyamic acid as its precursor, exposing, developing, and then imidizing. However, the imidization requires the temperature of at least 250° C., the substrate of FPC essentially composed of epoxy resin becomes deteriorated at such a high temperature, therefore, it has been difficult to apply polyimides onto the FPC because.

Photosensitive polyimides soluble in solvent have been developed. For example, the Japanese Laid-open No. 6-27667 discloses a composition having a vinyl ether group on its polymer side chain, but the composition is poor in developing properties.

Since wiring has become finer and magnetic heads have become downsized because of large storage capacities and speeding up of the hard disk, a method for directly forming a circuit on a suspension for ordinarily packaging a head is adopted (Refer to Japanese Laid-open No. 48-16620). A circuit board for circuit formation and a circuit board have more manufacturing processes as well as more complicated processes because these boards are prepared by a complicated process of sequentially forming a conductive layer after the formation of a polyimide resin layer on a continuous stainless long foil to perform dry etching of such as plasma etching and laser drilling or performing wet etching with hazardous chemicals such as hydrazine, which has led to the high cost.

It is, therefore, an object of the present invention to provide a photosensitive resin composition which is user-friendly because of its solubility in organic solvent, excellent heat resistance, processability, and adhesion, a solder resist, and a cover lay film functioning as an insulating protective film made of the composition, and a printed circuit board with these laminated on.

### DISCLOSURE OF THE INVENTION

A photosensitive resin composition of the present invention comprises as essential component: (A) a soluble polyimide dissolved in solvent having a boiling point of not higher than 120° C.; and (B) a compound having at least one aromatic ring and at least two carbon-carbon double bonds in one molecule, wherein the soluble polyimide is obtained by using at least an acid dianhydride having one to six aromatic rings or an alicyclic acid dianhydride, and/or a diamine having one to six aromatic rings.

It is another embodiment of the present invention that a photosensitive resin composition comprises (A) a soluble polyimide dissolved in solvent having a boiling point of not higher than 120° C.; (B) a compound having at least one aromatic ring and at least two carbon-carbon double bonds in one molecule; and (C) a photoreaction initiator and/or a sensitizer, wherein the soluble polyimide is obtained by using at least an acid dianhydride having one to six aromatic rings or an alicylic acid dianhydride, and/or a diamine having one to six aromatic rings.

The component (A) may include a polyimide represented by the general formula (1):

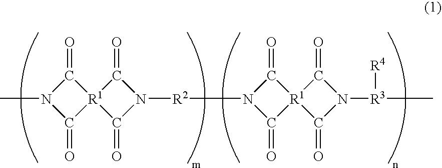

(wherein R¹ is a quadrivalent organic group, R² is a divalent organic group, R³ is a trivalent organic group, and R⁴ is a carboxy group or a hydroxyl group).

The polyimide represented by the general formula (1) may include a soluble polyimide having 200 to 3,000 COOH equivalent amount.

Further, the soluble poyimide may be represented by the following general formula (1):

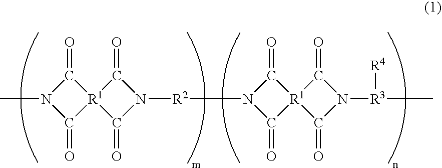

(wherein R¹ is a quadrivalent organic group, R² is a divalent organic group, R³ is a trivalent organic group, and R⁴ is a carboxy group, a hydroxyl group, or the following group (I):

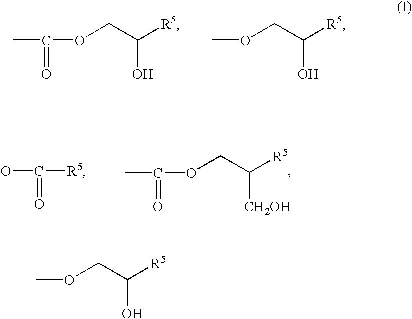

(wherein R⁵ is a monovalent organic group having at least one group selected from the groups consisting of an epoxy group, a carbon-carbon triple bond or a carbon-carbon double bond).

In addition, the polyimide represented by the general formula (1) may be obtained by using a diamine having at least two COOH groups of intramolecular thereof.

Moreover, the component (A) may be a polyimide obtained by containing a diamine having a siloxane bond.

The soluble polyimide may include the general formula (2):

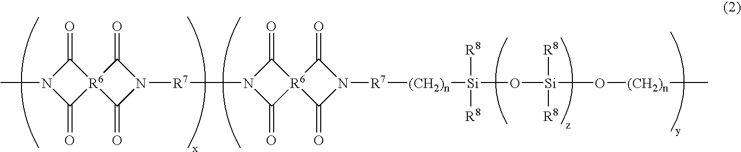

(wherein R⁶ is a quadrivalent organic group, R⁷ is a divalent organic group, and R⁸ is a monovalent organic group. x is an integer at least 1, y is an integer at least 1, z is an integer from 1 to 40, and n is an integer from 1 to 5).

Furthermore, the soluble polyimide may be a polyimide obtained by using 5 to 95 mole % of siloxane diamine in total diamines selected from the following general formula (3):

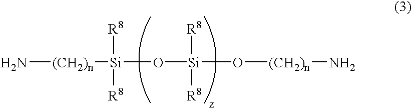

(wherein R⁸ represents alkyl having 1 to 12 carbons, phenyl, or methoxy groups, z is an integer from 1 to 40, n independently represents an integer from 1 to 20).

The soluble polyimide may be a polyimide obtained by using 5 to 99 mole % of diamine in total diamines selected from the following general formula (4):

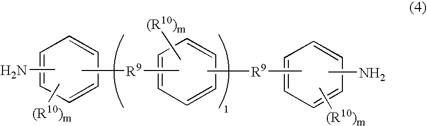

(wherein R⁹ represents —O—, —CH₂—, —CO—, a single bond, —C(CF₃)₂—, —C(CH₃)₂—, —COO—, or —SO₂—, R¹⁰ represents hydrogen, halogen, methoxy groups, —OH, —COOH or alkyl group having 1 to 5 carbons, 1 is 0, 1, 2, 3, or 4. m is 0, 1, 2, or 3).

The soluble polyimide may be obtained by using 10 to 100 mole % of acid dianhydride in total acid dianhydrides selected from the general formulae (5) and (6):

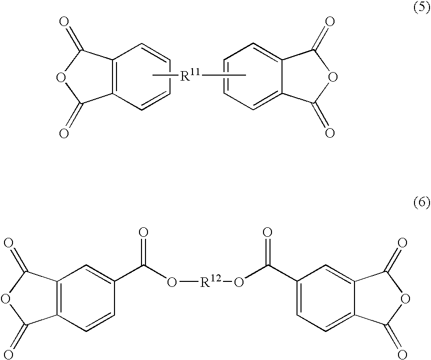

(wherein R¹¹ represents a single bond, —CO—, —O—, —C(CF₃)₂—, —SO₂—, or —C(CH₃)₂—, R¹² is a divalent organic group).

The soluble polyimide may be a polyimide obtained by using an acid dianhydride with 5 to 95 mole % in total acid dianhydrides represented by the general formula (6) wherein R¹² selected from the group (II):

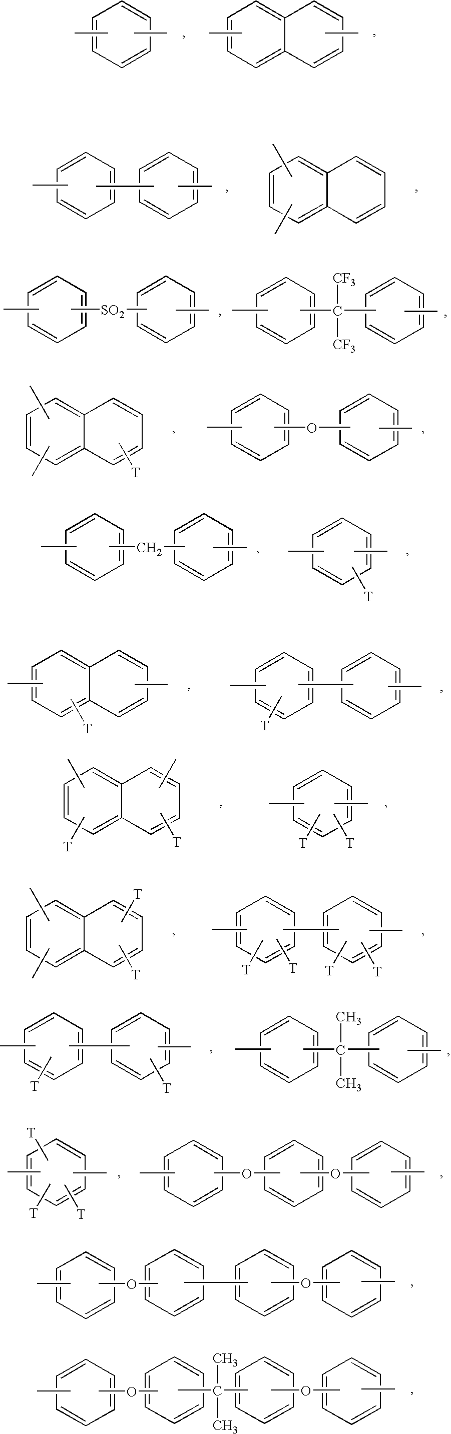

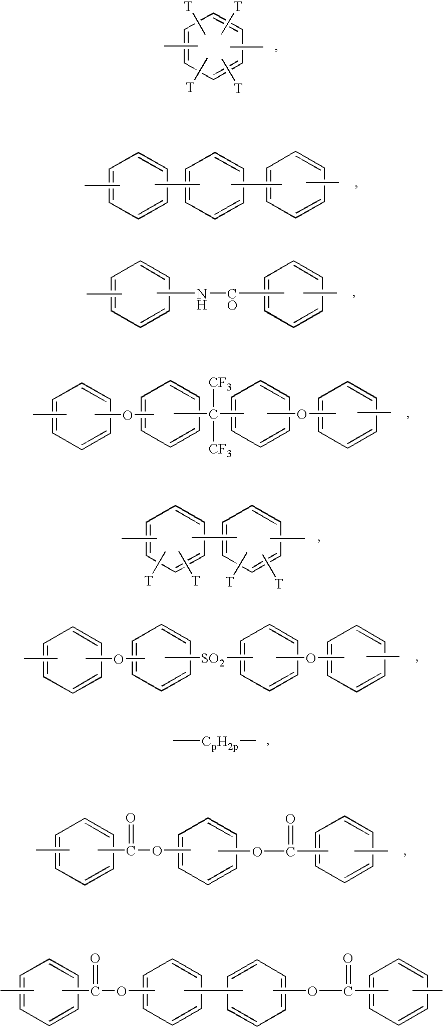

(wherein R¹² is a divalent organic group. p is an integer from 1 to 20.)

Group (II)

(T represents H, F, Cl, Br, I, MeO, or an alkyl group having 1 to 20 carbons).

The acid dianhydride may be represented by the general formula (7):

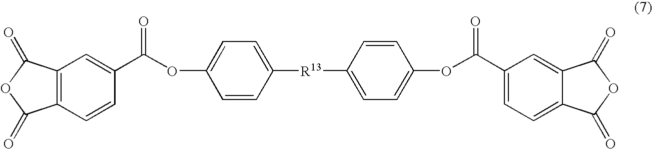

(wherein R¹³ is —O—, —CO—, a single bond, —C(CF₃)₂—, —C(CH₃)₂—, —COO—, or —SO₂—).

The soluble polyimide (A) may have a glass transition temperature from 100° C. to 300° C.

The polyimide may have an elastic coefficient after curing from 100 to 3,000 MPa.

The polyimide may have a pylolysis starting temperature after curing of not lower than 300° C.

The photosensitive resin composition according to the present invention may have a curing temperature of not higher than 200° C.

Further, the photosensitive resin composition after curing may have soldering heat resistance (300° C.) at least for 3 minutes.

Moreover, the composition after curing may have a coefficient of thermal expansion from 20 ppm to 500 ppm.

A photoreaction initiator contained in the resin composition according to the present invention may have a radical development potency using at least either of g line or i line.

The photosensitive resin composition after curing may have a glass transition temperature from 50° C. to 300° C.

The component (B) may be a copolymer monomer having a carbon-carbon double bond.

Alternatively, the component (B) may be polyfunctional (meta) acrylic compounds which comprises a polyfunctional (meta) acrylic compound and/or its similar material.

The polyfunctional (meta) acrylic compound may be two functions and may have a repeated unit (—O—CH₂CH₂—).

In the photosensitive resin composition, the component (B) may be at least one kind of diacrylate selected from Bisphenol F EO-modified diacrylate, Bisphenol A EO-modified diacrylate or Bisphenol S EO-modified diacrylate.

The photosensitive resin composition according to the present invention comprises 100 parts by weight of component (A); and 1 to 200 parts by weight of component (B).

Alternatively, the photosensitive resin composition comprises:

100 parts by weight of soluble component (A); 100 to 200 parts by weight of compound (B) having at least one aromatic ring and two carbon-carbon double bonds in one molecule; and 0.1 to 50 parts by weight of photoreaction initiator and/or sensitizer (C).

Alternatively, the photosensitive resin composition according to the present invention comprises: a soluble Polyimide (A); a compound (B) having at least one aromatic ring and at least two carbon-carbon double bonds in one molecule; and a photoreaction initiator and/or a sensitizer (C), wherein the component (A) may contain from 30 to 90 parts by weight in relative to 100 parts by weight of the total weight of (A) and (B), the component (B) may contain from 10 to 70 parts by weight in relative to 100 parts by weight of the total weight of (A) and (B), and the component(C) may contain from 0.01 to 10 parts by weight in relative to 100 parts by weight of the total weight of (A) and (B).

A photosensitive film according to the present invention comprises the above-mentioned resin composition and may be laminated at not higher than 150° C.

In addition, the photosensitive film according to the present invention may have a compression bonding temperature in B-stage state from 20° C. to 150° C.

A method for manufacturing a photosensitive film according to the present invention includes a process of applying an organic solvent solution of the above-mentioned photosensitive resin composition onto a base film and drying.

A solder resist according to the present invention comprises at least the above-mentioned photosensitive resin composition and may be soluble when not exposed to light, and may be insoluble in alkali water solution by polymerization reaction caused by the exposure to light.

A cover lay film according to the present invention comprises at least the above-mentioned photosensitive resin composition, wherein the cover lay film may have a compression bonding temperature from 20° C. to 150° C.

Further, the cover lay film according to the present invention comprises the above-mentioned photosensitive resin composition, which may be insoluble in alkali water solution by polymerization reaction caused by the exposure to light and may be soluble in the solution when it is not exposed to light.

Moreover, the cover lay film according to the present invention may have resolution not higher than line width/space width=100/100 μm.

Another embodiment of the cover lay film according to the present invention is a three-layer structure sheet composed of a base film, a photosensitive film, and a protective film laminated in order, wherein the protective film comprises of (a) a copolymer film of polyethylene and an ethylene vinyl alcohol resin, and (b) a laminate film of a polyethylene film, where a bonded surface with the photosensitive film can be formed on the copolymer film side of (a).

The photosensitive film has a thickness from 5 to 75 μm.

In addition, the copolymer film (a) which comprises the protective film has a thickness from 2 to 50 μm, and the polyethylene film (b) may have a thickness of 10 to 50 μm. Further, the base film may be a polyethylene terephthalate film.

The cover lay film according to the present invention may be used for a flexible printed circuit board, a suspension for a hard disk, or a head part of a hard disk memory device.

A printed circuit board according to the present invention may be formed by the lamination of the above-mentioned cover lay film.

### BRIEF DESCRIPTION OF THE DRAWING

FIG. 1 is a schematic cross-sectional view of a cover lay film according to the present invention.

FIGS. 2(a) to 2(d) respectively show a part of manufacturing process of a flexible printed circuit board employing a cover lay film of the present invention. FIG. 2(a) shows a process of releasing a cover lay film of the cover lay film and overlaying the film on a copper-clad laminate where a circuit is formed. FIG. 2(b) shows a process of laminating the cover lay film of the present invention to the copper-clad laminate where a circuit is formed. FIG. 2(c) shows a process of exposing to light by placing mask patterns. FIG. 2(d) shows a process of releasing a PET film to be developed.

FIG. 3 shows a FPC having a square of 10 cm² of line/space=200 μm/200 μm in an embodiment of the present invention.

### BEST MODE FOR CARRYING OUT THE INVENTION

A photosensitive resin composition contains (A) a soluble polyimide and (B) a compound having at least one aromatic ring and two carbon-carbon double bonds in one molecule as essential components.

Firstly, an explanation will be given to a method for manufacturing a soluble polyimide. The soluble polyimide can provide excellent heat resistance and mechanical properties with a film made of a resin composition containing thereof.

The term “solubility” of soluble polyimides contained in the photosensitive resin composition of the present invention means that the polyimide is soluble in the temperature range of room temperature to 100° C. in organic solvent having a boiling point not higher than 120° C. Concrete examples of organic solvents include, for example: formamide solvents such as N,N-diethylformamide, and N,N-dimethylformamide acetamide solvents such as N,N-dimethyl acetamide and N,N-diethylacetamide, pyrrolidone solvents such as N-methyl-2-pyrrolidone and N-vinyl-2-pyrrolidone, phenol solvents such as phenol, o-, m-, or p-cresol, xylenol, halogenated phenols, and catechol, ether solvents such as tetrahydrofuran, dioxane, and dioxolane, alcohol solvents such as methanol, ethanol, and buthanol, cellosolve solvents such as butyl cellosolve, solvents such as hexamethyl phosphoramide and γ-butyrolactone, and halide solvents such as chloroform, methylene chloride or the like. More particularly, “solubility”. in this specification means that at least 1 g of polyimide is dissolved in 100 g of the solvent at 20° C. to 50° C. At least 5 g of polyimide is preferably dissolved in 100 g of the above-mentioned solvent at 20° C. to 50° C., more preferably at least log of polyimide is dissolved.

The soluble polyimide according to the present invention is obtained by using an acid dianhydride having one to six aromatic rings and/or a diamine having one to six aromatic rings.

More particularly, the soluble polyimide of component (A) contains polyimide represented by the following general formula (1):

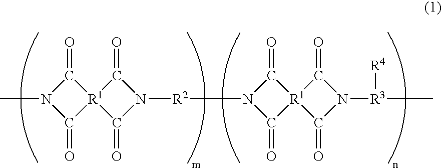

(wherein R¹ is a quadrivalent organic group, R² is a divalent organic group, R³ is a trivalent organic group, and R⁴ is a carboxy group or a hydroxyl group).

A hydroxyl group and/or a carboxy group have been introduced to the soluble polyimides represented by the general formula (1).

The introduction of a hydroxyl group and/or a carboxy group to the soluble polyimides improves solubility in alkali, so that an alkali solution can be preferably used as a developer. The polyimide having this hydroxyl group and/or carboxy group can be obtained by polymerization reaction between a diamine component partly containing diamine having a hydroxyl group and/or a carboxy group and an acid dianhydride component.

The soluble polyimide used in the present invention may have a carboxylic acid (COOH) equivalent amount from 200 to 3,000. “The COOH equivalent amount of this polyimide” is equivalent to the value (average value) obtained by dividing the molecular weight of polyimide by the number of carboxy groups existing in polyimide molecule. Such a polyimide having COOH equivalent amount from 200 to 3,000 is, for example, obtained by using diamine having a carboxy group as part of a material for the soluble polyimides. The COOH equivalent amount is preferably from 250 to 2,500, more preferably from 300 to 2,000. When the COOH equivalent amount exceeds 3,000, the resin composition containing polyimide becomes difficult to be dissolved in water solution-type alkali developer, which leads to a tendency of longer developing time. In view of the structure and the molecular weight of acid dianhydride of the material to be used for preparing soluble polyimides, the COOH equivalent amount of the soluble polyimides is usually not less than 200 as mentioned above. For example, the COOH equivalent amount of a polyimide, which is synthesized by a compound and diamino phthalic acid represented by the formula (5) (R¹¹ is a single bond) as one of relatively simplified models, is 227. If a compound represented by the above-mentioned formula (5), where R⁹ is —C(CF₃)₂— is used as in the above synthesis, the COOH equivalent amount will be 299.

To realize the above-mentioned COOH equivalent amount, it is preferable to use a diamine having at least two carboxy groups in a molecule. Polyimides having predetermined carboxylic acid equivalent amount and preferred physical properties are easily designed by a combination of this diamine and other diamine.

The soluble polyimide (A) can be obtained by a general manufacturing method of polyimides. For example, the polyimide can be obtained by a method for imidization by dehydration reaction after obtaining polyamic acid by reacting acid dianhydride and diamine in an organic solvent; or a method for reacting acid dianhydride and diisocyanate in an organic solvent. The former method for imidization by dehydration reaction after obtaining polyamic acid by the reaction of acid dianhydride and diamine is preferably used.

The combination of diamine having at least two carboxy groups (COOH group) in molecule or diamine having at least two carboxy groups in molecule and other diamines is preferable. This makes it possible to obtain soluble polyimides having carboxy groups.

The above-mentioned diamines having at least two carboxy groups in a molecule are not particularly limited. Examples of compounds include: diaminophthalic acids such as 2,5-diaminoterephthalic acid; carboxy biphenyl compounds such as 3,3′-diamino-4,4′-dicarboxy biphenyl, 4,4′-diamino-3,3′-dicarboxybiphenyl, 4,4′-diamino-2,2′,-dicarboxybiphenyl, 4,4′-diamino-2,2′,5,5′-tetracarboxybiphenyl; carboxydiphenylalkane such as 3,3′-diamino-4,4′-dicarboxyphenylmethane, 2,2-bis[3-amino-4-carboxyphenyl]propane, 2,2-bis[4-amino-3-carboxyphenyl]propane, 2,2-bis[3-amino-4-carboxyphenyl]hexafluoropropane, 4,4′-diamino-2,2′,5,5′-tetracarboxydiphenylmethane; carboxydiphenyl ether compounds such as 3,3′-diamino-4,4′-dicarboxydiphenyl ether, 4,4′-diamino-3,3′-dicarboxydiphenyl ether, 4,4′-diamino-2,2′-dicarboxydiphenyl ether, 4,4′-diamino-2,2′,5,5′-tetracarboxydiphenyl ether; diphenylsulfone compounds such as 3,3′-diamino-4,4′-dicarboxydiphenyldulfone, 4,4′-diamino-3,3′-dicarboxydiphenylsulfone, 4,4′-diamino-2,2′-dicarboxydiphenylsulfone, 4,4′-diamino-2,2′,5,5′-tetracarboxydiphenylsulfone; bis[(carboxyphenyl)phenyl]alkane compounds such as 2,2-bis[4-(4-amino-3-carboxyphenoxy)phenyl]propane; and bis [(carboxyphenoxy)phenyl]sulfone compounds such as 2,2-bis[4-(4-amino-3-carboxyphenoxy)phenyl]sulfone.

Examples of other diamines (diamines with no carboxy group or with one carboxy group in a molecule) include: diamines having one hydroxyl group or carboxy group in a molecule, siloxane diamines, and diamines other than these diamines.

Examples of diamines having one hydroxyl group or carboxy group include: diaminopnenols such as 2,4-diaminophenol; hydroxy biphenyl compounds such as 3,3′-diamino-4,4′-dihydroxybiphenyl, 4-4′-diamino-3,3′-dihydroxybiphenyl, 4,4′-diamino-2,2′-dihydroxyphenyl, 4,4′-diamino-2,2′,5,5′-tetrahydroxybiphenyl; hydroxydiphenylalkanes such as 3,3′-diamino-4,4′-dihydroxydiphenylmethane, 4,4′-diamino-3,3′-dihydroxydiphenylmethane, 4,4′-diamino-2,2′-dihydroxydiphenylmethane, 2,2-bis[3-amino-4-hydroxyphenyl]propane, 2,2-bis[4-amino-3-hydroxyphenyl]propane, 2,2-bis[3-amino-4-hydroxyphenyl]hexafluoropropane, 4,4′-diamino-2,2′,5,5′-tetrahydroxydiphenylmethane; hydroxydiphenyl ether compounds such as 3,3′-diamino-4,4′-dihydroxydiphenyl ether, 4,4′-diamino-3,3′-dihydroxydiphenyl ether, 4,4′-diamino-2,2′-dihydroxydiphenyl ether, 4,4′-diamino-2,2′,5,5′-tetrahydroxydiphenyl ether; diphenylsulfone compounds such as 3,3′-diamino-4,4′-dihydroxydiphenylsulfone, 4,4′-diamino-3,3′-dihydroxydiphenylsulfone, 4,4′-diamino-2,2′-dihydroxydiphenylsulfone, 4,4′-diamino-2,2′,5,5′-tetrahydroxydiphenylsulfone; bis(hydroxyphenyl)phenyl]alkane compounds such as 2,2-bis[4-(4-amino-3-hydroxyphenoxy)phenyl]propane; bis(hydroxyphenoxy)biphenyl compounds such as 4,4′-bis(4-amino-3-hydroxyphenoxy)biphenyl; bis[(hydroxyphenoxy)phenyl]sulfonized compounds such as 2,2-bis[4-(4-amino-3-hydroxyphenoxy)phenyl]sulfone; diamino benzoic acid such as 3,5′-diamino benzoic acids; and bis(hydroxyphenoxy)bisphenyl compounds such as 4,4′-diamino-3,3′-dihydroxydiphenylmethane, 4,4′-diamino-2,2′-dihydroxydiphenylmethane, 2,2-bis[3-amino-4-carboxyphenyl]propane, 4,4′-bis(4-amino-3-hydroxyphenoxy)biphenyl.

From the viewpoint of lowering the elastic coefficient to secure flexibility of the film, the soluble polyimides contained in the photosensitive resin composition according to the present invention may include the structure represented by the following general formula (2):

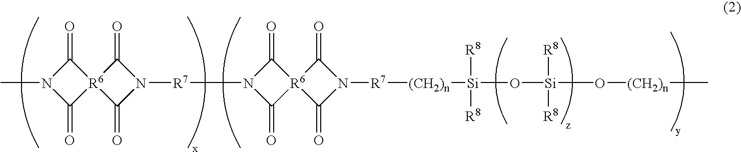

(wherein R⁶ is a quadrivalent organic group, R⁷ is a divalent organic group, R⁸ is a monovalent organic group. x is an integer at least 1, y is an integer at least 1, z is an integer from 1 to 40, and n is an integer from 1 to 5).

Siloxane diamines selected from the following general formula (3) may be used for polyimides represented by the above-mentioned formula (2):

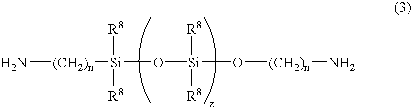

(R⁸ represents an alkyl group having 1 to 12 carbons, a phenyl group, or a methoxy group. z is an integer from 1 to 40, n is independently an integer from 1 to 20).

These siloxane diamines are preferably used to obtain soluble imide having excellent flexibility and solubility. Preferred examples of R¹ contained in the compound represented by the above-mentioned general formula (3) include a methyl group, an ethyl group, and a phenyl group, and more preferred example is a methyl group. n is preferably from 2 to 10, particularly from 2 to 5. z is preferably from 4 to 30, more preferably from 5 to 20, particularly from 8 to 15. Among them, if the range of the z value gives significant effects for the physical properties and if the value of z is small, the pliability of obtained polyimide will be poorer, and if the value of z is too large, the heat resistance of the polyimide will be less.

Additionally, the siloxane diamines represented by the above-mentioned formula (3) preferably employ from 5 to 95 mole % of amine in total amines to lower the elastic coefficient of the film. If siloxane diamines are contained at a ratio of less than 5 mole %, the added effect will be insufficient. If the siloxane diamines are contained at a ratio of more than 95 mole %, the film will become too soft, which results in large thermal expansion. The above-mentioned siloxane diamines are preferably contained in total amines as a material at a ratio of 5 to 70 mole %. The siloxane diamines are more preferably contained at a ratio of 10 to 50 mole %.

The diamine to be used as a material for the soluble polyimides of the present invention other than the above-mentioned diamines are not particularly limited, but examples of the diamine include: aromatic diamines having no heterocycle such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3′-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2′-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2′-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]-hexafluoropropane, 4,4′-bis[4-(4-amino-2-trifluoromethyl)phenoxy]-octafluorobiphenyl; aromatic diamines having heterocycles such as diaminotetraphenylthiophene; aliphatic or alicyclic diamines such as 1,1-metaxylylene diamine, 1,3-propane diamine, tetramethylenediamine, pentamethylenediamine, octamethylenediamine, nonamethylenediamine, 4,4-diaminoheptamethylenediamine, 1,4-diaminocyclohexane, isophorone diamine, tetrahydrodicyclopentadienylene diamine, hexahydro-4,7-methanoindanilenedimethylene diamine, tricyclo[6,2,1,0^{2.7}]-undecylenedimethyl diamine, 4,4′-methylenebis(cyclohexylamine). Phenylenediamines having a steroid group represented by the following general formula (8) as aromatic diamines other than the above-mentioned compounds are also used:

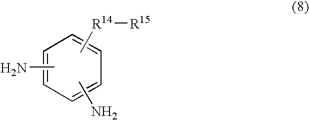

Examples of the diamine also include mono-substituted phenylenediamines represented by the general formula (8). (wherein R¹⁴ represents a divalent organic group selected from —O—, —COO—, —OCO—, —CONH—, and —CO—, and R¹⁵ represents a monovalent organic group having a steroid skeleton). These diamine compounds may be used either alone or in combination of two or more kinds.

When aromatic diamines are used, light absorption of the soluble imide in g line and i line areas will be smaller if diamines having two amino groups located on meta position (third) of aromatic rings, which leads to an advantage in designing photosensitive resins.

Further, a diamine selected from the following general formula (4) is favorably used because it can keep balance between heat resistance and solubility:

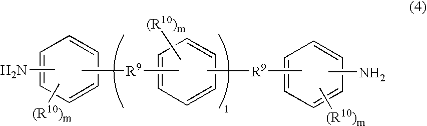

(wherein R⁹ represents —O—, —CH₂—, —CO—, a single bond, —C(CF₃)₂—, —C(CH₃)₂—, —COO— or —SO₂—, R¹⁰ represents hydrogen, halogen, methoxy groups, —OH, —COOH, or alkyl group having C1 to C5. l is 0, 1, 2, 3, or 4, m is 0, 1, 2, or 3).

The diamine obtained by the above-mentioned general formula (4) is preferably used in a proportion from 5 to 99 mole %, further preferably from 10 to 70 mole % based on the total amount of diamine from a point of high solubility of the polyimide obtained.

The acid dianhydride to be used as material for soluble polyimide in the present invention is not particularly limited, but examples thereof include: aliphatic or alicyclic tetracarboxylic dianhydrides such as 2,2′-hexafluoropropylidene diphthalic dianhydride, 2,2-bis(4-hydroxyphenyl) propanedibenzoate-3,3′,4,4′-tetracarboxylic dianhydride, butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 5-(2,5-dioxotetrahydrofuryl)-3-methyl-3-cyclohexene-1,2-dicarboxylic dianhydride and bicyclo[2,2,2]-octo-7-ene-2,3,5,6-tetracarboxylic dianhydride; aromatic tetracarboxylic dianhydrides such as pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′,4,4′-biphenylethertetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenyl sulfide dianhydride, 4,4′-bis(3,4-dicarboxyphenoxy)diphenyl sulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-biphenyltetracarboxylic dianhydride, bis(phthalic acid)phenylphosphine oxide dianhydride, p-phenylene-bis(triphenylphthalic acid)dianhydride, m-phenylene-bis(triphenylphthalic acid)dianhydride, bis(triphenylphthalic acid)-4,4′-diphenyl ether dianhydride, bis(triphenylphthalic acid)-4,4′-diphenylmethane dianhydride; aliphatic tetracarboxylic anhydrides having aromatic ring such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, 1,3,3a,4,5,9b-hexahydro-8-methyl-5-(tetrahydro-2,5-dioxo-3-furanyl)-naphtho[1,2-c]furan-1,3-dione, compounds represented by the following general formula (9):

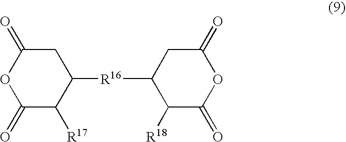

(wherein R¹⁶ represents a divalent organic group having an aromatic ring, and R¹⁷ and R¹⁸ each represent a hydrogen atom or an alkyl group), and compounds represented by the following general formula (10):

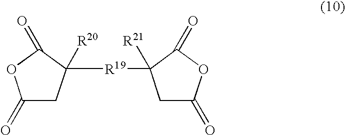

(wherein R¹⁹ represents a divalent organic group having an aromatic ring, and R²⁰ and R²¹ each represent a hydrogen atom or an alkyl group). In these tetracarboxylic dianhydrides, acid dianhydrides having one to six aromatic rings or alicyclic acid dianhydrides are preferably used from a point of heat resistance. These tetracarboxylic dianhydrides may be used alone or in combination of two or more kinds.

To materialize good balance between heat resistance and solubility, and excellent mechanical properties, the acid dianhydride represented by the following general formulae (5) and (6) is preferable:

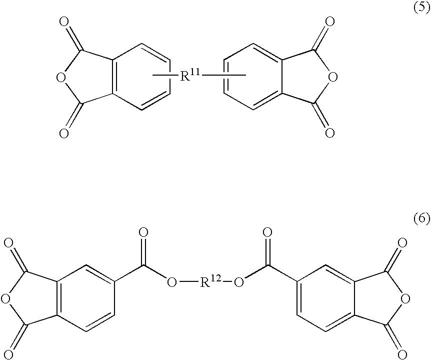

(R¹¹ represents a single bond, —CO—, —O—, —C(CF₃)₂—, —SO₂— or —C(CH₃)₂—, R¹² represents a divalent organic group).

Particularly, 2,2′-hexafluoropropylidenediphthalic dianhydride and 2,3,3′,4′-biphenyltetracarboxylic dianhydride are preferably used as a part of acid dianhydride to obtain solubility. The above-mentioned R¹² is preferably —CH₂C(CH₃)₂— and —CₙH₂ₙ— (n is an integer from 1 to 20), and R¹² is preferably a divalent organic group selected from the following group (II):

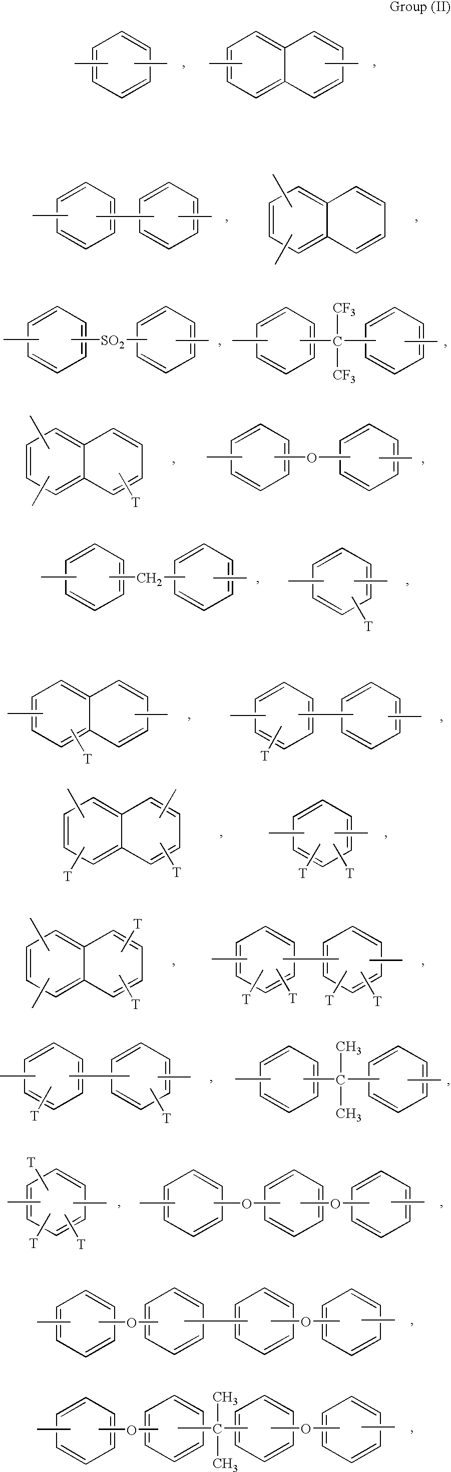

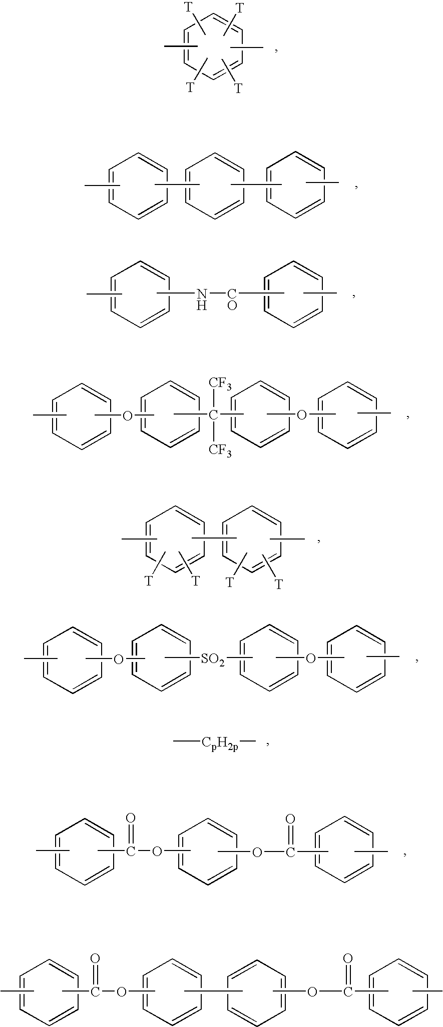

(T represents H, F, Cl, Br, l, MeO—, or an alkyl group having 1 to 20 carbons).

The compounds represented by the above-mentioned group (II) are preferably used in a proportion of 10 to 100 mole % based on the total amount of acid dianhydride to be used.

Particularly, part of an ester acid dianhydride having four aromatic rings as represented by the following general formula (7) is further preferably used to obtain polyimide having high solubility in organic solvent:

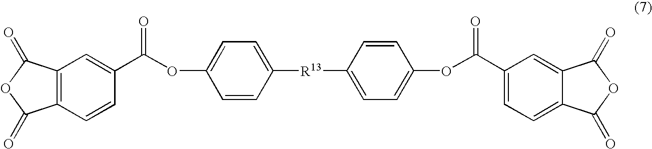

(wherein R¹³ represents —O—, —CO—, a single bond, —C(CF₃)₂—, —C(CH₃)₂—, —COO—, or —SO₂—).

The soluble polyimide to be contained in the photosensitive resin composition according to the present invention may be produced by imidization of polyamic acid which is a precursor of polyimide. Polyamic acid is obtained by reacting diamine with acid dianhydride in organic solvent. The reaction occurs by dissolving the diamine in organic solvent or diffusing the diamine in a slurry under the inert atmosphere such as argon and nitrogen to add acid dianhydride in a dissolution of organic solvent or in a slurry diffusion or adding diamine component to acid dianhydride in a solid.

In this case, one kind of acid component and one kind of diamine component may be used, if one the above-mentioned one kind of diamine and one kind of acid dianhydride are substantially equimolar. With the respective use of two or more kinds of acid dianhydride components and diamine components, any polyamic acid polymer can be obtained by substantially adjusting molar ratio between the total amount of diamine components and acid dianhydride components to equimolar.

For instance, a first diamine component and a second diamine component may previously be added in organic polar solvent and then acid dianhydride may be added to afford a polyamic acid polymer solution. Alternatively, the first diamine component may previously be added in organic polar solvent and acid dianhydride may be added and then the second diamine component may be added after stirring for a while to afford a polyamic acid polymerization solution. Alternatively, the acid dianhydride may previously be added in organic polar solvent and then the first diamine component may be added and the second diamine component may be added after stirring for a while, and further, the third diamine component may be added after stirring for a while to afford a polyamic acid polymer solution.

It is substantially the same as the above-described order, even if the order of addition is reversed, i.e. acid dianhydrides are previously added and then the diamine component is added.

The reaction temperature of polyamic acid at the time of synthesis is preferably from −20° C. to 90° C. The reaction duration is approximately from 30 minutes to 24 hours. The obtained polyamic acid preferably has an average molecular weight (weight-average molecular weight) of 5,000 to 1,000,000. If the average molecular weight is less than 5,000, the resulting soluble polyimide will have a smaller molecular weight. Accordingly, the photosensitive resin composition including such soluble polyimide, if used as it is, is not practical because of its brittleness. Conversely, if the polyamic acid has an average molecular weight of greater than 1,000,000, a varnish of the polyamic acid will have an excessively high viscosity, so that the handling thereof will be difficult.

The typical organic polar solvents which may be used for generation reaction of polyanic acid include: sulfoxide solvents such as dimethyl sulfoxide and diethyl sulfoxide, formamide solvents such as N,N-dimethylformamide and N,N-diethylformamide, acetamide solvents such as N,N-dimethylacetamide and N,N-diethylacetamide, pyrrolidone solvents such as N-methyl-2-pyrrolidone and N-vinyl-2-pyrrolidone, phenol solvents such as phenol, o-cresol, m-cresol or p-cresol, xylenol, halogenated phenols and catechol, ether solvents such as tetrahydrofuran and dioxane, alcohol solvents such as methanol, ethanol, and butanol, cellosolvic solvents such as butyl cellosolve, hexamethylphosphoramide, and γ-butyrolactone. These are preferably used either alone or in combination. Some aromatic hydrocarbons such as xylene and toluene may be used. The solvents are not particularly limited, as long as these dissolve polyamic acid. The selection of the solvents with possible low-boiling is advantageous in processes to synthesize polyamic acid by subsequently heating this polyamic acid solution under reduced pressure to be imidized as well as the removal of the solvents. An explanation will now be given to a process for imidizing polyamic acid.

The above mentioned polyamic acid obtained is converted to polyimide by dehydration reaction. The method for imidization is not particularly limited, but a method for heating a reaction mixture used for the above-mentioned synthesis of polyamic acid under reduced pressure is preferably adopted. With the use of this method, it is possible to control hydrolysis of polyimide caused by water because water can actively be removed out of the system, which enables a drop in molecular weight to be avoided. Generally, tetracarboxylic acid with its rings opened by hydrolysis or acid dianhydride with its one ring opened or the like may be included in acid dianhydride used as a material. In this case, polyimide with high-molecular weight is not obtained due to a stop of polymerization reaction of polyamic acid. If a method for heating under reduced pressure is applied, however, heating under reduced pressure at the time of imidization will re-close these opened ring sites to provide an acid dianhydride structure, which may react with amine remaing in the system during imidization. Then water is effectively removed out of the system under reduced pressure, which makes it possible to avoid hydrolysis caused by water. Accordingly, polyimide with higher-molecular weight can be obtained.

Any of general imidization methods may be applied except the above-mentioned method. For instance, these methods include: a method for adding azeotropic solvents, such as toluene and xylene to a reaction mixture used for synthesizing the above-mentioned polyamic acid to be heated and removing water by azeotropy simultaneously with imidization; and a method for adding an aliphatic acid dianhydride, such as acetic anhydride, and tertiary amines such as triethylamine, piridine, picoline, and isoquinoline to the reaction mixture used for synthesizing the above-mentioned polyamic acid.

The former method for removing water by azeotropy has a possibility of causing hydrolysis due to water because of the existence of water in the system. The latter method for chemical imidization is more advantageous than the former method in view of hydrolysis because the produced water is removed by converting of aliphatic acid dianhydride to aliphatic acid. A process for removing the residue, such as aliphatic acid dianhydride and tertiary amines is, however, required. Since these methods have the above-mentioned problems, the imidization method is selected according to its purpose. Particularly, the method for heating under reduced pressure is preferably employed.

When the imidization method for heating under reduced pressure is employed, the heating temperature is preferably from 80° C. to 400° C. Imidization is effectively performed in such temperature range. The heating temperature is preferably not lower than 100° C., more preferably not lower than 120° C. so that water may be effectively removed. The maximum heating temperature is preferably set at a temperature not higher than a thermal decomposition temperature of polyimide to be used. Since the temperature is usually from 200° C. to 350° C. to mostly complete imidization, the maximum heating temperature may be set at this temperature range.

Pressure of the reaction system is preferably as small as possible like the above-mentioned method, but the pressure under the above-mentioned heating conditions which enables the produced water at the time of imidization to effectively be removed. More specifically, the pressure in the system is from 100 to 9.2×10⁴ Pa, preferably from 100 to 8.2×10⁴ Pa, further preferably from 1,000 to 7.2×10⁴ Pa.

More specifically, the soluble polyimide to be used in the present invention is prepared with advantage by drying heating the polyamic acid solution under reduced pressure to be imidized directly. For instance, a vacuum oven may be used for a batch-type method or a biaxial or triaxial extruder with a decompression device may be used for a continuous method to achieve imidization reaction. These systems are selected as appropriate according to the output. The “biaxial or triaxial extruder with a decompression device” herein means a device made by adding an apparatus for removing solvent by reducing pressure to a general melting extruder for extruding thermoplastic resins by thermal melting. The polyamic acid solution is heated while being mixed by such an extruder to remove the solvent and water produced at the time of imidization. Soluble polyimides are formed in such a manner.

In the photosensitive resin composition according to the present invention, each kind of organic additives, organic or inorganic filler groups, each kind of reinforcement, each kind of organic solvents and the like as well as the above-mentioned components may be compounded.

The above-mentioned polyimide having a hydroxyl group and/or carboxy group can provide desired properties because of introduction of other functional groups. Polyimides (epoxy-modified polyimide) obtained by reacting polyimide having a hydroxyl group and/or carboxy group with a compound having an epoxy group are preferable because they can provide reactivity and curing properties with the obtained composition.

Next, epoxy-modified polyimide will be described in detail. Epoxy-modified polyimide is represented by the following general formula (1):

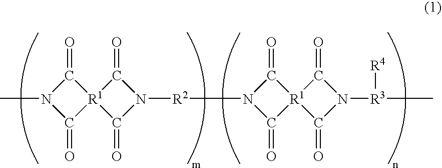

(wherein R¹ is a quadrivalent organic group, R² is a divalent organic group, R³ is a trivalent organic Group, and R⁴ is a carboxy group, a hydroxyl group or the following group (I):).

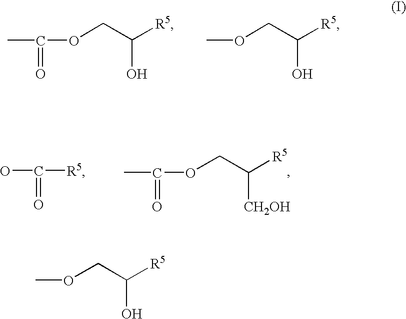

(wherein R⁵ is a monovalent organic group having at least one of the group consisted of an expoxy group, a carbon-carbon triple bond or a carbon-carbon double bond).

The epoxy-modified polyimide can be obtained by dissolving soluble polyimide having a hydroxyl group or carboxy group in organic solvent to be reacted with a compound having an epoxy group.

The compound having an epoxy group preferably comprises an epoxy resin having two or more epoxy groups and a double bond with epoxy groups or a triple bond with epoxy groups.

The epoxy resin having two or more epoxy groups is not particularly limited as long as it has two or more epoxy groups in molecule, but examples of the epoxy resin include: bisphenol resins such as Epicote 828 (produced by Shell International Chemicals Corporation), orthocrezol novolak resins such as 180S65 (produced by shell International Chemicals corporation), bisphenol A novolak resins such as 157S70 (produced by Shell International Chemicals Corporation), trishydroxyphenolmethanenovolak resins such as 1032H60 (produced by Shell International Chemicals Corporation), naphthalane aralkylnovolak resins such as ESN 375, glycidylamine resins such as tetraphenolethane 1031S (produced by Shell International Chemicals Corporation), YGD414S (produced by Toho Chemicals Company), trishydroxyphenylmethane EPPN502H (produced by Nippon Kayaku Co., Ltd.), special bisphenol VG3101L (produced by Mitsui Chemicals, Inc.), special naphthol NC7000 (produced by Nippon Kayaku Co., Ltd.), and TETRAD-X, and TETRAD-C (produced by Mitsubishi Gas Chemical Co., Inc.).

The compound having epoxy groups and a double bond is not particularly limited as long as it has epoxy groups and a double bond in molecule, but the typical examples are allylglycidyl ether glycidylacrilate glycidylmethacrylate glycidylvinyl ether or the like.

The compound having epoxy groups and a triple bond is not particularly limited as long as it has epoxy resins and a triple bond in molecule, the typical examples are propagylglycidyl ether glycidylpropiolate ethynylglycidyl ether, or the like.

The solvents to be used for reaction in the present invention are not particularly limited, if only the solvents are not reacted with epoxy groups and dissolve polyimide having a hydroxyl group or carboxy group, but examples thereof include:

sulfoxide solvents such as dimethyl sulfoxide and diethyl sulfoxide, formamide solvents such as N,N-dimethylformamide and N,N-diethylformamide, acetamide solvents such as N,N-dimethylacetamide and N,N-diethylacetamide, pyrrolidone solvents, such as N-methyl-2-pyrrolidone and N-vinyl-2-pyrrolidone, ether solvents such as tetrahydrofuran and dioxane, alcohol solvents such as methanol, ethanol, and butanol, cellosolvic solvent such as butyl cellosolve, hexamethylphosphoramide, and γ-butyrolactone, and some aromatic hydrocarbons such as xylene and toluene may be used. These are preferably used either alone or in combination.

The selection of the solvents with possible low-boiling which dissolve thermolplastic polyimide having a hydroxyl group or carboxylic group is advantageous in a process to remove the solvents subsequently.

The reaction temperature is preferably not lower than 40° C. and not higher than 130° C. at which epoxy groups and a hydroxyl group and a carboxy group are reacted. Particularly, the compound having epoxy groups and a double bond or epoxy groups and a triple bond is preferably reacted at such temperatures that no decomposition or bridge may occur on the double and triple bonds by heating. More specifically, the reaction temperature is preferably within the range of 40° C. to 100° C., further preferably within the range of 50° C. to 80° C. The reaction duration is from a few minutes to 15 hours.

The epoxy-modified polyimide solution can be obtained in this manner. To improve adhesion with the copper foil and developing properties, thermosetting resins such as epoxy resins and acrylic resins, and thermoplastic resins such as polyester, polyimide, polyurethane, and polycarbonate may be mixed to this epoxy-modified polyimide solution.

In addition, this solution may be mixed with thermosetting resins other than epoxy resins because of excellent physical properties. Examples of the thermosetting resin to be used herein include: bismaleimide, bisarylbadiimide, phenol resins, and cyanate resins.

This epoxy-modified polyimide solution may be used by the direct application onto the part to be joined and drying or by the application and drying to make it into a sheet.

The drying conditions are preferably carried our at possible low temperatures so that the remaining epoxy groups, double bond, and triple bond may not make its rings opened, decomposed, and bridges by heating.

The mixture of the epoxy-modified polyimide of the present invention and a conventional curing agent for epoxy resins is preferable to obtain a cured material with excellent phisical properties. If only the curing agent is for epoxy resins, either of amine-system, imidazole-system, acid anhydride-system, and acid-system may be used, or a variety of coupling agents may be mixed. Alternatively, soluble polyimide other than epoxy-modified polyimide may be used.

The glass transition temperature Tg of the thus-obtained soluble polyimide is preferably as high as possible, but the Tg is from 100° C. to 300° C., preferably from 120° C. to 300° C., more preferably 140° C. to 280° C.

The component (B) contained in the photosensitive resin composition is a copolymer monomer having carbon-carbon double bond, and further, is preferably a polyfunctional (meta) acrylic compound and/or polyfunctional (meta) acrylic compound consisted of its analog. “Polyfunctional (meta) acrylic compound” means at least one kind of a polyfunctional acrylic compound and/or polyfunctional metacrylic compound. The polyfunctional acrylic compound is a compound having at least two acryloyl groups (CH₂═CHO—), and the polyfunctional matacrylic compound is a compound with a structure having repeated units represented by —(CHR—CH₂—O)— (R is hydrogen or a methyl group or ethyl group) in one molecule not smaller than 4 and not greater than 40. Excellent resolution can be provided in a short time by the selection of such compound because monomer before curing is easily dissolved in alkali water solution and resins of the exposure part are cured, which leads to speedy dissolution and removal of the unexposed resins with an alkali water solution.

The diacrylate compound having a structure of being easily dissolved in alkali water solution is preferably a di (meta) acrylate compound having two aromatic rings represented by the following general formula (11):

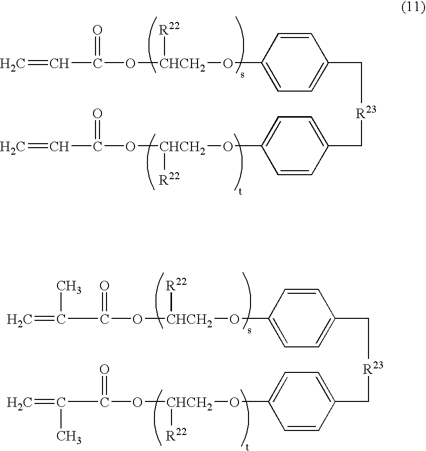

(wherein R²² is hydrogen, a methyl group, or an ethyl group, R²³ is a divalent organic group. s and t are respectively an integer from 2 to 40). If s and t are o or 1 in the general formula (11), the composition will have poor solubility in alkali water solution, which results in poor developing properties. The compound, wherein s and t are not smaller than 41, is not easily available.

It is preferable to mix a di(meta) acrylate compound, wherein s and t are 2 to 10 in the general formula (11) with a di(meta) acrylate compound, wherein s and t are 11 to 20 in the general formula (11), to be used as the component (B). It is further preferable to mix a di(meta) acrylate compound wherein s and t are 2 to 5 in the general formula (11) with a di(meta) acrylate compound wherein s and t are 11 to 16 in the general formula (11) to be used as the component (B).

Its mixture ratio is preferably from 0.1 to 100 parts by weight of the latter based on 1 part by weight of the former. If the di(meta) acrylate, wherein m and n are 2 to 10 in the general formula (11), is only used, the composition will have poor solubility in alkali water solution, which results in poor developing properties.

Further, one of the compound or two or more compounds represented by the above-mentioned general formula (11) may be used as the component (B), and two or more compounds may be mixed.

Examples of the above-mentioned polyfunctional (meta) acrylic compounds (B) include: Bisphenol F EO-modified diacrylate (n=2 to 50)(EO is thyleneoxide, n is the number of added moles of ethylene oxide; -ditto-), Bisphenol A EO-modified diacrylate (n=2 to 50), Bisphenol S EO-modified diacrylate (n=2 to 50), Bisphenol F EO-modified dimetaacrylate (n=2 to 50), Bisphenol S EO-modified dimetaacrylate (n=2 to 50), Bisphenol A EO-modified dimetaacrylate (n=2 to 50), 1,6-hexanediol dimethaacrylate, neopentyl glycol diacrylate, ethylene glycol diacrylate, pentaerythritol diacrylate, trimethylolpropane triacrylate, pentaerythritol triacrylate, dipentaerythritol hexaacrylate, tetramethylopropane tetraacrylate, tetraethyleneglycol diacrylate, 1,6-hexanedioldimethacrylate, neopentylglycol dimethaacrylate, ethyleneglycol dimethacrylate, pentaerythritol dimethacrylate, trimethylolpropane trimethacrylate, pentaerythritol trimethacrylate, dipentaerythritol hexamethacrylate, tetramethylolpropane tetramethacrylate, tetraethyleneglycol dimethacrylate, methoxydiethyleneglycol methoxypolyethyleneglycol methacrylate, β-metharyloyloxyethyl hydrogenphthalate, β-methacryloyloxyethyl hydrogensuccucinate, 3-chloro-2-hydroxypropylmethacrylate, stearylmethacrylate, phenoxyethyl acrylate, phenoxydiethyleneglycol acrylate, phenoxypolyethyleneglycol acrylate, β-acryloyloxyethyl hydrogensuccucinate, laurylacrylate, ethyleneglycol dimethacrylate, diethyleneglycol dimethacrylate, triethyleneglycol dimethacrylate, polyethyleneglycol dimethacrylate, 1,3-butyleneglycol dimethacrylate, 1,6-hexanediol dimethacrylate, neopentylglycol dimethacrylate, polypropyleneglycol dimethacrylate, 2-hydroxy 1,3-dimethacryloyloxypropane, polyethyleneglycol diacrylate, tripropyleneglycol diacrylate, polypropyleneglycol diacrylate, 2-hydroxy 1-acryloyloxy 3-methacryloyloxypropane, trimethylolpropane trimethacrylate, tetramethyloylmethane triacrylate, tetramethylolmethane tetraacrylate, methoxydipropyleneglycol methacrylate, methoxytriethyleneglycol acrylate, nonylphenoxypolyethyleneglycol acrylate, nonylphenoxypropyleneglycol acrylate, 1-acryloyloxypropyl-2-phthalate, isostearyl acrylate, polyoxyethylenealkyl ether acrylate, nonylphenoxyethyleneglycol acrylate, polypropyleneglycol dimethacrylate, 1,4-butanediol dimethacrylate, 3-methyl-1,5-pentanedioldimethacrylate, 1,6-hexanedioldimethacrylate, 1,9-nonanedioldimethacrylate, 2,4-diethyl-1,5-pentadiolmethacrylate, 1,4-cyclohexanedimethanol dimethacrylate, dipropyleneglycol diacrylate, tricylcodecanedimethanol diacrylate, 2,2-hydrogenated Bisphenol A EO-modified diacrylate (n=2 to 50), Bisphenol A PO-modified diacrylate (n=2 to 50)(PO is propylene oxide, n is the number of added moles of propylene oxide), 2,4-diethyl-1,5-pentadiol diacrylate, ethoxydized trimethylolpropane triacrylate, propoxidized trimethylolpropane triacrylate, isocyanuric acid EO-modified triacrylate, pentaerythritol tetraacrylate, ethoxidized pentathritol tetracrylate, propoxidized pentaerythritol tetraacrylate, ditrimethylolpropane tetraacrylate, dipentaerythritol polyacrylate, isocynuric acid triallyl, glycidyl methacrylate, glycidylallyl ether, 1,3,5-triacryloylhexahydro-s-triazine, triallyl 1,3,5-benzene carboxylate, triallylamine, triallylcitrate, triallylphosphate, allobarbital, diallylamine, diallyldimethylsilane, diallyl disulfide, diallyl ether, diallylcyanurate, diallylisophthalate, diallylterephthalate, 1,3-diallyloxy-2-propanol, diallylsulfide, diallylmaleate, 4,4′-isopropylidenediphenyl dimethacrylate, 4,4′-isopropilidenediphenoxy diacrylate or the like, but the polyfunctional (meta) acrylic compounds are not limited to these compounds. These polyfunctional (meta) acrylic compounds (B) may be one kind of compound or in combination of two or more kinds.

Bisphenol F EO-modified diacrylate, Bisphenol A EO-modified diacrylate, Bisphenol S EO-modified acrylate, Bisphenol F EO-modified dimethacrylate, Bisphenol A EO-modified dimethacrylate, Bisphenol S EO-modified dimethacrylate and the like are preferably used as the above-mentioned polyfunctional (meta) acrylic compounds (B) because of flexibility in the photosensitive film obtained from the photosensitive resin composition of the present invention. Particularly, the compounds having a repeated unit of EO within the range of 2 to 50, particularly within the range of 4 to 50 contained in one molecule of diacrylate or dimethacrylate are preferable. Since the repeated unit of EO improves the solubility of the compounds in alkali water solution, the resolution is improved by shortening the developing duration of the obtained resin composition after the exposure to light. If the repeated unit is more than 50, the resin composition to be obtained will have poor heat resistance.

The above-mentioned component (B) is preferably contained in a proportion of 1 to 200 parts by weight based on 100 parts by weight of the above-mentioned soluble polyimide (A). If the component (B) is contained in a proportion of less than 1 part by weight, it will have a higher compression bonding temperature and poor resolution. If the component (B) is contained in a proportion of more than 200 parts by weight, stickiness will be visible on the film in B-stage state and the resin will easily seep through at the time of thermal bonding, which leads to be vulnerable. The compound (B) is preferably within the range of 20 to 100 parts by weight, further preferably within the range of 50 to 80 parts by weigh, furthermore preferably within the range of 50 to 150 parts by weight.

It is particularly preferable to mix in such a manner that 30 to 90 parts by weight of the above-mentioned component (A) is contained based on 100 parts by weight of the total weight of (A) and (B), and 10 to 70 parts by weight of the above-mentioned component (B) is contained based on the total weight of (A) and (B).

The heat resistance and the compression bonding temperature of the photosensitive film can be controlled by the mixture ratio of these components.

The essential components of the photosensitive resin composition according to the present invention may be a photoreaction initiator and/or a sensitizer (C) in addition to the above-mentioned components (A) and (B).

The component (C) as a photoreaction initiator is not particularly limited. The compounds that generate radical by light with a wavelength of g line or so are preferably used. More particularly, the compounds having radical development potency at least either of g line and i line. Examples of such compounds include: 3,3′,4,4′-tetra(t-butylperoxycarbonyl)benzophenone, and acylphosphineoxide compounds represented by the following general formulae (12) and (13). Further, a generally used sensitizer, or a combination of this sensitizer and a photo-polymerization assistant may be used as the above-mentioned photoreaction initiator (C). A radical generated by the photoreaction initiator (C) is reacted with reaction groups having a double bond (vinyl group, acryloyl group, methacryloyl group, and ally group or the like). This accelerates cross-linkage by the development of polymerization reaction of polyfunctional (meta) acrylic compounds (B).

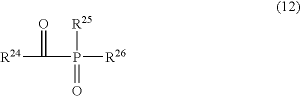

(wherein R²⁴ represents C₆H₅—, C₆H₄(CH₃)—, C₆H₂(CH₃)₃—, (CH₃)₃C—, or C₆H₃Cl₂—, R²⁵ and R²⁶ are each independently C₆H₅—, methoxy, ethoxy, C₆H₄(CH₃)—, or C₆H₂(CH₃)₃—).

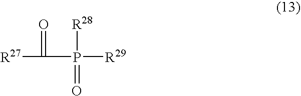

(wherein R²⁷ and R²⁸are each independently C₆H₅—, C₆H₄(CH₃)—, C₆H₂(CH₃)₃—, (CH₃)₃C—, or C₆H₃Cl₂—, R²⁹ represents C₆H₅—, methoxy, ethoxy, C₆H₄(CH₃)—, or C₆H₂(CH₃)₃—).

The acylphosphineoxide represented by the general formula (12) generates two radicals, and the acylphosphineoxide represented by the general formula (13) generates four radicals because of α cleavage. The acylphosphineoxide represented by the general formula (13) is particularly preferable.

In epoxy-modified polyimides, a photo-cation generator may be used to cure epoxy groups of side chain of polyimide resin instead of the above-mentioned radical generator. Examples of the photo-cation generator include: diphenyliodonium salts such as diphenyliodonium salts of dimethoxyanthraquinone sulfone acid, pyrylium salts, triphenylonium salts, and diazonium salts. In this case, the mixture of alicyclic epoxy and vinyl ether compounds with high cation curability is preferable.

Alternatively, a photo-base generator may be used to cure the epoxy group on the side chain. Examples of the photo-base generator include: urethane compounds obtained by reacting nitrobenzyl alcohol and/or dinitrobenzyl alcohol with isocyanate, or urethane compounds obtained by reacting nitro-1-phenylethyl alcohol and/or dinitro-1-phenylethyl alcohol with isocyanate, and urethane compounds obtained by reacting dimethoxy-2-phenyl-2-propanol with isocyanate.

A variety of peroxides may be used as radical initiators in combination with the following sensitizers. The combination of 3,3′,4,4′-tetra(t-butylperoxycarbonyl)benzophenone with the following sensitizers is particularly preferable. Examples of the sensitizer include the following compounds, but not limited to these compounds: Michler's ketone, bis-4,4′-diethylamino benzophenone, benzophenone, camphorquinone, benzyl, 4-4′-dimethylaminobenzyl, 3,5-bis(diethylaminobenzylidene)-N-methyl-4-piperidone, 3,5-bis(dimethylaminobenzylidene)-N-methyl-4-piperidone, 3,5-bis(diethylaminobenzylidene)-N-ethyl-4-piperidone, 3,3′-carbonyl-bis(7-diethylamino)cumarin, riboflavintetrabutylate, 2-methyl-1-[4-(methylthio)phenyl]-2-morpholinopropane-1-one, 2,4-dimethylthioxanthone, 2,4-dietylthioxanthone, 2,4-diisopropylthioxanthone, 3,5-dimethylthioxanthone, 3,5-diisopropylthioxanthone, 1-phenyl-2-(ethoxycarbonyl)oxyiminopropane-1-one, benzoin ether, benzoin isopropyl ether, benzanthrone, 5-nitroacenaphthene, 2-nitrofluorene, anthrone, 1,2-benzanthraquinone, 1-phenyl-5-mercapto-1H-tetrazole, thioxanthene-9-one, 10-thioxanthenone, 3-acetylindole, 2,6-di(p++-dimethylaminobenzozal)-4-carboxycyclohexanone, 2,6-di(p-dimethylaminobenzal)-4-hydoxycyclohexanone, 2,6-di(p-dimethylaminobenzal)-4-carboxycyclohexanone, 2,6-di(p-diethylaminobenzal)-4-hydroxycyclohexanone, 4,6-dimethyl-7-ethylamino cumarin, 7-diethylamino-4-methylcumarin, 7-diethylamino-3-(1-methylbenzoimidazolyl)cumarin, 3-(2-benzoimidazolyl)-7-diethylaminocumarin, 3-(2-benzothiazoryl)-7-diethylaminocumarin, 3-(2-benzothiazoryl)-7-diethylaminocumarin, 2-(p-dimethylaminostyryl)benzoxazole, 2-(p-dimethylaminostyryl)quinoline, 4-(p-dimethylaminostyryl)quinoline, 2-(p-dimethylaminostyryl)benzothiazole, 2-(p-dimethylaminostyryl)-3,3-dimethyl-3H-indole.

The photoreaction initiator and/or sensitizer (c) are preferably contained in a proportion of 0.1 to 50 parts, more preferably in a proportion of 0.3 to 20 parts by weight based on 100 parts by weight of the soluble polyimide resin (A). When the ratio exceeds the range of 0.1 to 50 parts by weight, sensitizing effects may not be obtained, and developing properties may be adversely affected. One kind of compound may be used as a sensitizer or some kinds of compounds may be used in combination.

The above-mentioned photopolymerization assistant is used to improve sensitivity of the photosensitive resin composition of the present invention. Examples of the photopolymerization assistant include the following compounds, but these are not limited: 4-diethylaminoethylbenzoate, 4-dimethylaminoethylbenzoate, 4-diethylaminopropylbenzoate, 4-dimethylaminopropylbenzoate, 4-dimethylaminoisoamylbenzoate, N-phenylglycine, N-methyl-N-phenylglycine, N-(4-cyanophenyl)glycine, 4-dimethylaminobenzonitrile, ethyleneglycoldithioglycolate, ethyleneglycoldi(3-mercaptopropionate), trimethylolpropanethioglycolate, trimethylolpropane tri(3-mercaptropionate), pentaerythrithritoltetrathioglycolate, pentaerythritoltetra(3-mercaptopropionate), trimethylolethane trithioglycolate, trimethylolpropane trithioglycolate, trimethylolethanetri(3-mercaptopropionate), dipentaerythritolhexa(3-mercaptopropionate), thioglycolic acid, α-mercaptopropionic acid, t-butylperoxybenzoate, t-butylperoxymethoxybenzoate, t-butylperoxynitrobenzoate, t-butylperoxyethylbenzoate, phenylisopropylperoxybenzoate, di-t-butyldiperoxyisophthalate, tri-t-butyltriperoxytrimellitate, tri-t-butyltriperoxytrimellitate, tetra-t-butyltetraperoxypyromellitate, 2,5-dimethyl-2,5-di(benzoylperoxy)hexane, 3,3′,4,4′-tetra(t-butylperoxycarbonyl)benzophenone, 3,3,4,4′-tetra(t-amylperoxycarbonyl)benzophenone, 3,3′,4,4′-tetra(t-hexylperoxycarbonyl)benzophenone, 2,6-di(p-azidobenzal)-4-hydroxycyclohexanone, 2,6-di(p-azidobenzal)-4-carboxycyclohexanone, 2,6-di(p-azidobenzal)-4-methoxycyclohexanone, 2,6-di(p-azidobenzal)-4-hydroxymethylcyclohexanone, 3,5-di(p-azidobenzal)-1-methyl-4-piperidone, 3,5-di(p-azidobenzal)-4-piperidone, 3,5-di(p-azizobenzal)-N-acetyl-4-piperidone, 3,5-di(p-azidobenzal)-N-methoxycarbonyl-4-piperidone, 2,6-di(p-azidobenzal)-4-hydroxycyclohexanone, 2,6-di(m-azidobenzal)-4-carboxycyclohexanone, 2,6-di(m-azidobenzal)-4-methoxycyclohexanone, 2,6-di(m-azidobenzal)-4-hydroxymethylcyclohexanone, 3,5-di(m-azidobenzal)-N-methyl-4-piperidone, 3,5-di(m-azidobenzal)-4-piperidone, 3,5-di(m-azidobenzal)-N-acetyl-4-piperidone, 3,5-di(m-azidobenzal)-N-methoxycarbonyl-4-piperidone, 2,6-di(p-azidcynnamilidene)-4-hydroxycyclohexanone, 2,6-di(p-azidocynnamilidene)-4-carboxycyclohexanone, 2,6-di(p-azidocynnamilidene)-4-cyclohexanone, 3,5-di(p-azidocynnamilidene)-N-methyl-4-piperidone, 4-4′-diazidocalcone, 3,3′-diazidocalcone, 3,4′-diazidocalcone, 4,3′-diazidocalcone, 1,3-diphenyl-1,2,3-propanetrion-2-(o-acetyle)oxime, 1,3-diphenyl-1,2,3-propanetrion-2-(o-n-propyl carbonyl)oxime, 1,3-diphenyl-1,2,3-propanetrion-2-(o-methoxycarbonyl)oxime, 1,3-diphenyl-1,2,3-propanetrion-2-(o-ethoxycarbonyl)oxime, 1,3-diphenyl-1,2,3-propanetrion-2-(o-benzoyl)oxime, 1,3-diphenyl-1,2,3-propanetrion-2-(o-phenyloxycarbonyl)oxime, 1,3-bis(p-methylphenyl)-1,2,3-propane-tri-one-2-(o-benzoyl)oxime, 1,3-bis(p-methoxyphenyl)-1, 2,3-propane-tri-one-2-(o-ethoxycarbonyl)oxime, 1-(p-methoxyphenyl)-3-(p-nitrophenyl)-1,2,3-propanetrione-2-(o-phenyloxycarbonyl)oxime. Trialkylamines such as triethylamine, tributylamine, and triethanole may be contained as an assistant other than the above-mentioned assistants. The photopolymerization may be used alone or in a combination of two or more kinds.

The photopolymerization assistant is preferably contained in a proportion of 0.1 to 50 parts by weight, more preferably in a proportion of 0.3 to 20 parts by weight based on 100 parts by weight of the soluble polyimide resin (A). When the ratio exceeds the range of 0.1 to 50 parts by weight, predetermined sensitizing effects may not be obtained, and developing properties may be adversely affected.

More particularly, the total weight of the photoreaction initiator and the sensitizer is preferably contained in a proportion of 0.01 to 10 parts by weight, further preferably in a proportion of 0.03 to 5 parts by weight based on the total weight of the components (A) and (B) of the present invention. When the ratio exceeds the range of 0.01 to 10 parts by weight, sensitizing effects may not be obtained, and developing properties may be adversely affected.

The photosensitive resin composition comprises the-above mentioned soluble polyimide (A), polyfunctional (meta) acrylic compounds (B), and photoreaction initiator (C), further comprises the above-mentioned sensitizer and phtopolymerization assistant, and a variety of other components. The sensitizer may be used alone or in combination.

Further, to achieve sensitivity to put it to practical use, copoymer monomers other than the component (B) may be contained in the composition of the present invention, in addition to the above-mentioned sensitizer and photopolymerization assistant. The copoymerization monomer is a compound having carbon-carbon double bond, which makes polymerization easy.

Examples of the copolymerization monomer include: divinyl benzene, 1,6-hexanediol diacrylate, neopentyl glycol diacrylate, ethylene glycol diacrylate, pentaerythritol diacrylate, trimethylolpropane triacrylate, pentaerythritol triacrylate, dipentaerythritol hexaacrylate, tetramethylopropane tetraacrylate, tetraethyleneglycol diacrylate, 1,6-hexanediol dimethacrylate, neopentyl glycol dimethacrylate, ethyleneglycol dimethacrylate, pentaerythritol dimethacrylate, trimethylolpropane trimethacrylate, pentaerythritol trimethacrylate, dipentaerythritol hexamethacrylate, tetramethylolpropane tetramethacrylate, tetraethleneglycol dimethacrylate, methoxydiethyleneglycol methacrylate, β-methacroyloxyethyl hydrogen phthalate, β-methacryloyloxyethyl hydrogensuccinate, 3-chloro-2-hydroxypropylmethacrylate, stearylmethacrylate, phenoxyethyl acrylate, phenoxydiethyleneglycol acrylate, phenoxypolyethyleneglycol acrylate, β-acryloyloxyethyl hydrogensuccinate, laurylacrylate, ethyleneglycol dimethacrylate, diethyleneglycol dimethacrylate, triethyleneglycol dimethacrylate, polyethyleneglycol dimethacrylate, 1,3-butyleneglycol dimethacrylate, 1,6-hexanediol dimethacrylate, neopentylglycol dimethacrylate, polypropyleneglycol dimethacrylate, 2-hydroxy-1,3′-dimethacryloyloxypropane, 2,2-bis[4-methacryloxyethoxy]phenyl]propane, 2-2-bis[4-(methacryloyloxy diethoxy)phenyl]propane, 2,2-bis[4-(methacryloyloxy polyethoxy)phenyl]propane, polyethyleneglycol diacrylate, tripropyleneglycol diacrylate, polypropyleneglycol diacrylate, 2,2-bis[4-(acryloxy diethoxy)phenyl]propane, 2,2-bis[4-(acryloxy polyethoxy)phenyl]propane, 2-hydroxy-acryloxy-3-methacryloxypropane, trimethylolpropane trimethacrylate, tetramethylolmethane triacrylate, tetramethylolmethane tetraacrylate, methoxydipropyleneglycol methacrylate, methoxytriethyleneglycol acrylate, nonylphenoxypolyethyleneglycol acrylate, nonylphenoxypolypropyleneglycol acrylate, 1-acryloyloxypropyl-2-phthalate, isostearyl acrylate, polyoxyethylenealkyl ether acrylate, nonylphenoxyethyleneglycol acrylate, polypropyleneglycol dimethacrylate, 1,4-butanediol dimethacrylate, 3-methyl-1,5-pentandiol dimethacrylate, 1,6-hexanediol dimethacrylate, 1-9-nonanediol methacrylate, 2,4-diethyl-1,5-pentadiolmethacrylate, 1,4-cyclohexanedimethanol dimethacrylate, dipropyleneglycol diacrylate, tricylcodecane dimethanol diacrylate, 2,2-hydogenated bis[4-acryloxy polyethoxy]phenyl]propane, 2,2-bis[4-(acryloxy polypropoxy)phenyl]propane, 2,4-diethyl-1,5-pentadiol diacrylate, ethoxydized trimethylolpropane triacrylate, propoxidized trimethylolpropane triacrylate, isocyanuric acid tri(ethaneacrylate), pentathritol tetraacrylate, ethoxidized pentathritol tetraacrylate, propoxidized pentaerythritol tetraacrylate, ditrimethylolpropane tetraacrylate, dipentaerythritol polyacrylate, isocynuric acid triallyl, glycidyl methacrylate, glycidylallyl ether, 1,3,5-triacryloylhexahydro-s-triazine, triallyl 1,3,5-benzene carboxylate, triallylamine, triallylcitrate, triallylphosphate, 5,5-diallylbarbituric acid, diallylamine, diallyldimethylsilane, diallyl disulfide, diallyl ether, diallylcyanurate, diallylisophthalate, diallylterephthalate, 1,3-diallyloxy-2-propanol, diallylsulfidediallylmaleate, 4,4′-isopropylidenediphenyl dimethacrylate, 4,4′-isopropilidenediphenoxy diacrylate or the like, but the compounds are not limited to these compounds. Particularly, two or more multifunction-monomers are preferably used to improve cross-linkage viscosity.

Furthermore, at least one diacrylate selected from the copolymerization monomers, Bisphenol F EO-modified diacrylate, Bisphenol A EO-modified diacrylate, Bisphenol S EO-modified diacrylate from a viewpoint of reducing the warp produced when laminating a cover lay obtained from the photosensitive cover lay composition on the flexible printed circuit board.

This copoymerization monomer is preferably contained in a proportion of 1 to 200 parts by weight, further preferably 3 to 150 parts by weight based on 100 parts by weight of the polyimide of the present invention. When the ratio exceeds the range of 1 to 200 parts by weight, effects to be a purpose may not be obtained, and developing properties may be adversely affected. The copoymerization monomer may be used alone or in combination of two or more kinds.

Examples of another component include: the above-mentioned soluble polyimide (A), and resins other than polyfunctional (meta) acrylic compounds (B), organic or inorganic fillers, reinforcement, coupling agents, each kind of additives, and organic solvents.

Examples of resins other than the above-mentioned soluble polyimide (A) and polyfunctional (meta) acrylic compounds (B) include thermosetting resins and thermoplastic resins. Examples of the thermosetting resin include epoxy resin and thermosetting acrylic resin or the like and examples of the thermoplastic resin include polyester, polyamide, polyurethane, and polycarbonate, or the like.

The above-mentioned epoxy resin is contained to improve adhesion of the photosensitive resin composition. The kind of epoxy resin is not particularly limited, but examples of thereof include: bisphenol resins such as Epicote 828 (produced by Shell International Chemicals Corporation), orthocrezol novolak resins such as 180S65 (produced by shell International Chemicals corporation), bisphenol A novolak resins such as 157S70 (produced by Shell International Chemicals Corporation), trishydroxyphenolmethanenovolak resins such as 1032H60 (produced by Shell International Chemicals Corporation), naphthalane aralkylnovolak resins such as ESN 375, glycidylamine resins such as tetraphenolethane 1031S (produced by Shell International Chemicals Corporation), YGD414S (produced by Toho Chemicals Company), trishydroxyphenylmethane EPPN502H (produced by Nippon Kayaku Co., Ltd.), special bisphenol VG3101L (produced by Mitsui Chemicals, Inc.), special naphthol NC7000 (produced by Nippon Kayaku Co., Ltd.), and TETRAD-X, and TETRAD-C (produced by Mitsubishi Gas Chemical Co., Inc.).

The epoxy resin preferably used in a mixture with a compound having epoxy groups and a double or a triple bond in molecule, or other thermosetting resin. Examples of therof include: allylglycidyl ether, glycidylacrylate, glycidylmethacrylate, glycidylvinyl ether, propagylglycidyl ether, glycidylpropiolate, ethynylglycidyl ether, or the like. Examples of other thermosetting resin include: bismaleimide, Bisarylnadimide, phenol resin, and cyanate resin or the like.

When epoxy resin is contained in the photosensitive resin composition of the present invention, a cutting substance having good physical properties is obtained with further addition of a curing agent for epoxy resin. Such curing agent is not particularly limited, but example of thereof include: amine-type, imidazole-type, acid anhydride-type, and acid-type curing agents.

The photosensitive resin composition according to the present invention may contain an organic solvent. The photosensitive resin composition can be used as solution thereof (varnish), which is convenient when applying and drying, if only the resin composition is dissolved in suitable organic solvent. A non-proton polar solvent is preferably used as solvent because of its solubility. More particularly, examples of the solvent to be used include: N-methyl-2-pyrolidone, N-acetyl-2-pyrolidone, N-benzyl-2-pyrolidone, N,N-dimethylformamide, N,N-dimethylacetamide, dimethylsulfoxide, hexamethylphosphortriamide, N-acetyl-ε-caprolactam, dimethylimidazolinone, diethyleneglycoldimethyl ether, triethylenglycoldimethyl ether, γ-butyrolactone, dioxane, dioxolane, tetrahydrofuran, chloroform, methylene chloride. These are preferably used either alone or in combination.

This organic solvent may be obtained either by allowing the solvent used in a synthesis reaction of the soluble polyimide (A) to remain or by adding it to the soluble polyimide after isolation. To improve application properties of the resin composition solution, the solvents other than the above, such as toluene, xylene, diethyl ketone, methoxybenzene, and cyclopenthanone may be mixed within the range that the solubility of polymer is not adversely affected. Additionally, certain degree of the solvents in the film after drying may allow to remain and both of the solvents having a low boiling and a high boiling points may be mixed so that the compression bonding temperature may be lowered.

The soluble polyimide to be contained in the composition of the present invention can be dissolved in solvent having a boiling point of not higher than 120° C. including ether solvents such as dioxane, dioxolane, and tetrahydrofuran, and halide solvents such as chloroform and methylene chloride because of excellent solubility in organic solvents. More particularly, the soluble polyimide (A) has extremely high solubility, which is obtained by using 2,2′-hexafluoropropylidenediphthalic dianhydrides, 2,3,3′,4′-biphenyltetracarboxylic dianhydrides, and ester acid dianhydrides represented by the above-mentioned formula (6) as essential components of acid dianhydrides and aromatic diamines having an amino group in the meta position, diamines having a sulfone group, and cyloxanediamines or the like represented by the general formula (3) as diamines in addition to diamines having two or more carboxy groups in one molecule. The photosensitive resin composition can be dissolved in a solvent because of its boiling point of not higher than 120° C., so that it is possible to prevent the contained (meta)acrylic compound (B) from being thermally polymerized because of no need for drying at high temperatures when applying and drying the photosensitive resin composition as a solution obtained by dissolving the photosensitive resin composition in such solvent.

The photosensitive resin composition according to the present invention has a high decomposition starting temperature after curing, and it is usually not lower than 300° C., and the temperature of not lower than 320° C., further not lower than 340° C., is also possible. Further, its curing temperature can be lowered below 200° C. Copper is mainly used for a conductive layer of the FPC. When copper is exposed to the temperature over 200° C., the strength of copper is deteriorated by gradual change of the crystal structure of copper. The photosensitive resin composition of the present invention is, therefore, preferably used for the FPC as a cover lay film.

Further, the photosensitive resin composition of the present invention may have an elastic coefficient of 10 to 3,000 MPa after curing. The generation of stress caused by mismatching of the elastic coefficient and thermal expansion ratio of the cover lay film and the base film can be reduced because of this range of elastic coefficient when using the resin composition for a cover lay film. The elastic coefficient is preferably 10 to 2,500 MPa, further preferably 10 to 2,000 MPa.

Furthermore, the photosensitive resin composition of the present invention may have soldering heat resistance (300° C.) of not shorter than 3 minutes. No foaming or delamination can be seen in the photosensitive resin after being laminated to copper and cured, further no deterioration can be seen even after the resin is soaked in a solder of 300° C. because the resin has heat resistance. Furthermore, no deterioration can be seen in the photosensitive resin even after soaking in a solder of 200° C. for 5 minutes or more.

Moreover, the photosensitive resin composition of the present invention may have a thermal expansion coefficient of 20 ppm to 500 ppm after curing. Accordinly, when laminating the photosensitive resin composition onto copper, the warp of a substrate can be prevented because the photosensitive resin composition used as a cover lay has a little less thermal expansion coefficient than the copper foil. The thermal expansion coefficient after curing is preferably from 20 to 500 ppm, further preferably from 20 to 400 ppm, the most preferably from 20 to 300 ppm.

As mentioned above, the photosensitive resin composition according to the present invention can be used as a photosensitive solder resist because the soluble polyimide (A) contained in the resin composition is soluble in organic solvent. For instance, the photosensitive resin composition solution can be also directly used as a liquid resist. In addition, the resin composition can easily be molded into a film to be a photosensitive film, which is useful as a photosensitive dry film resist.

Dry film resists are broadly divided into 2 kinds: a film-like photoresist finally peeled off after performing a function of etching resist to form a copper circuit; and a photosensitive cover lay film for performing two functions of an insulation protective film and a film-like photoresist of the circuit, such as a printed circuit board. A cover lay film in the present invention plays two roles of film-like photoresist and insulation protective film.

First of all, a component (A): soluble polyimide, a component (B): a compound having one or more aromatic rings and two or more carbon-carbon double bonds in one molecule, and a component (C): a photosensitive resin composition having a photoreaction initiator and/or a sensitizer, and other component are uniformly dissolved in organic solvent to manufacture a photosensitive film. The organic solvent to be used here may be a solvent to dissolve the photosensitive resin composition, and examples thereof include: ether-type solvents such as dioxolane, dioxane, and tetrahydrofuran, ketone-type solvents such as acetone and methylethyl ketone, and alcohol-type solvents such as methyl alcohol and ethyl alcohol. These solvents may be used alone or in combination of two or more kinds. It is advantageous to select the one which dissolves the components (A), (B), and (C) and has the lowest boiling point as possible in the process of removing the solvent.

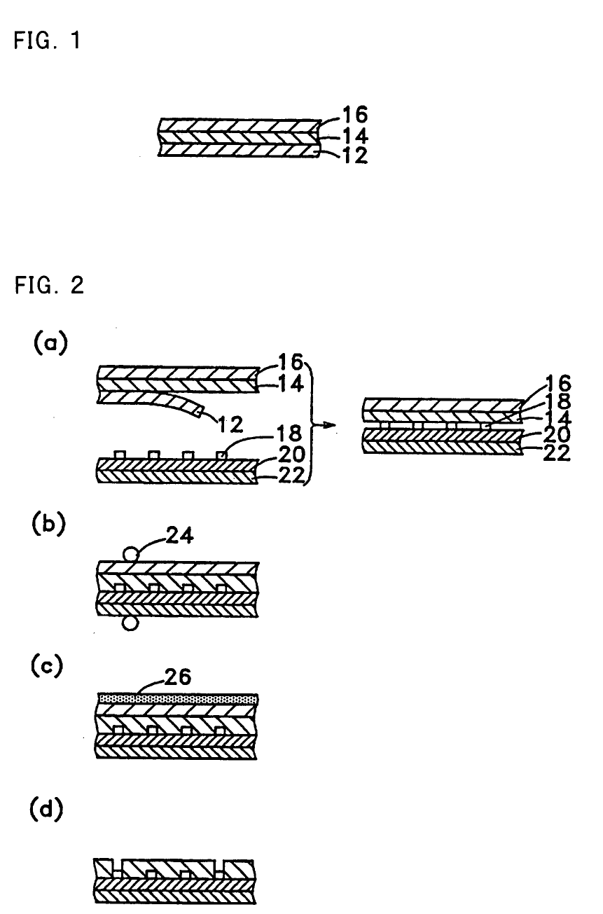

The obtained solution of the photosensitive resin composition is uniformly applied onto a support film to be dried so that a film-like photosensitive film is obtained. This film can be used as a cover lay film. At this time, a film or the like, such as metal and PET, is applied onto a support, and the photosensitive resin composition is peeled off from the support after drying to be used as a single film. As shown in FIG. 1, the resin composition may be used in a form of being laminated on a film 16, such as PET. The protective film 16 may be laminated on the surface of a photosensitive polyimide 14. The drying temperature of this photosensitive polyimide composition is preferably in such temperature range that a double bond of the polyfunctional (meta) acrylic compound (B) or a double bond of the other compound contained in the composition, a triple bond, and an epoxy group may not be deactivated by reaction caused by heating, more particularly the drying temperature is not higher than 180° C., preferably not higher than 150° C., further preferably not higher than 100° C. Further, the drying temperature may be gradually increased from a low temperature. The drying duration may be the duration sufficient to vaporize a large part of the solvent contained and mold the applied varnish into a film, more specifically, the duration is preferably from some minutes to 30 minutes, more preferably some minutes to 15 minutes.

Now, the cover lay film according to the present invention will be described in detail.

Usually, in the process of FPC comprises applying an adhesion onto a continuous film, drying, and continuously laminating to a copper foil, which leads to high productivity. On the other hand, as described in “prior art” the process of FPC has had such problems as poor processability, poor positioning accuracy and also high cost, because the manual works should be performed in the steps of opening a hole or a window to correspond with the terminal area and the joint with the components of the circuit on the cover lay film before bonding, positioning the hole of the cover lay film to the the terminal areas and the joint with the components of the FPC, and bonding in a small work size in batchwise operation.

The cover lay film according to the present invention can easily be laminated as a film to the conductor side of a printed circuit board by heat seal. Particularly, the cover lay film may be laminated at not higher than 150° C. and be directly laminated without using an adhesive. The photosensitive resin composition according to the present invention is easily insoluble in developer by exposure to light and the unexposed part has high solubility in developer. This results in the pattern formation with high precision. Thus, it is possible to obtain a cover lay film laminate with excellent processability and accuracy of position.

FIGS. 2(a) to 2(d) respectively show a process of producing a flexible printed circuit board using a cover lay film of the present invention. FIGS. 2(a) and (b) respectively show a process of laminating a copper-clad laminate (CCL) to a photosensitive cover lay film having a laminate of a PET film and a protective film of the present invention. In this process, the conductor side of the CCL, in which the circuit has previously been formed by a conductor, such as a copper foil, is protected by a photosensitive dry film (cover lay film). More particularly, the CCL and the photosensitive dry film (cover lay film) are laminated to each other by thermal laminating and thermal pressing or vacuum laminating.

The laminating temperature is preferably as low as possible, and is not higher than 150° C., preferably not higher than 130° C., further preferably not higher than 110° C.

The temperature conditions of bonding conventional acrylic resin photosensitive films by compression are from 80 to 150° C.

In the case of non-photosensitive films, the temperature conditions are usually from 180 to 200° C. And the temperature conditions of conventionally used polyimide films are from 150 to 300° C. Compared to these temperature conditions, the cover lay film of the present invention in a B-stage state can be bonded by compression at temperatures below the above-mentioned temperatures; in the temperature range of 20 to 150° C. This enables to obtain patterns with excellent resolution.

The temperature at that time is preferably in such range that an epoxy group or a double bond and a triple bond may not be cleaved by heat, more specifically, not higher than 150° C., preferably not higher than 120° C., further preferably not higher than 100° C.

Moreover, a di(meta) acrylic acid-type compound can be laminated without cured at not higher than 150° C., preferably not higher than 120° C., further preferably not higher than 100° C. The cover lay film which has free-flowing surfaces at room temperature and flow properties and stickiness at the time of laminating by heating is preferably used.

Furthermore, the cover lay film according to the present invention leads to improvement in accuracy of position and processability because the holes to be connected to FPC terminal areas can be opened by exposure and development after laminating a FPC and the cover lay film.

More specifically, it is possible to bore a hole onto a desired area to connect with a substrate terminal area by exposing the cover lay film to light and developing. FIG. 2(c) shows a process of irradiating light at this laminate through photo-mask patterns with predetermined patterns and FIG. 2(d) shows a process of obtaining the desired patterns by development of dissolving and removing the unexposed part of the cover lay film with a basic solution. A conventional positive photoresist development device may be used for this development.

Before exposure, photo-masks, which have patterns such as drawing fine parallel line and a curve having line width/space width of not greater than 100/100 μm and fine holes or the like having bore diameter×space width of not greater than 100 μm×100 μm, are placed on the cover lay film. After exposing to light, patterns are formed by development. Subsequently, the patterns are cleansed with rinse solution to remove the developer.

As mentioned above, a substrate where the cover lay film with excellent processability and accuracy of position is laminated can be obtained.

Usually, the substrate is bonded to other parts by soldering under exposure of high temperature at least 200° C. for some seconds. The heat resistance temperature of the photosensitive resin composition of the present invention after curing is high, usually, at least 300° C., preferably at least 320° C., further preferably at least 340° C. Accordingly, it is possible to bond a cover lay film laminated printed circuit board to the desired parts without deterioration of the cover film after curing.

The elastic coefficient of the cover lay film only after curing is preferably as small as possible. This is to reduce stress caused by mismatching of elastic coefficient and thermal expansion ratio of the cover lay film and the base film. The elastic coefficient after curing is preferably from 10 MPa to 3,000 MPa, and the photosensitive resin composition according to the present invention has such properties.

If the elastic coefficient of the cover lay film after curing is too high, the sample may be curled or warped by the shrinkage of polyimide on curing when the cover lay film is bonded to a copper-clad laminate (CCL) where a circuit is formed to be cured by heating. Such curling has drawbacks, such as easy peeling off and disconnection of the fine copper circuit when using the cover lay film for a flexible printed circuit board (FPC). The elastic coefficient of the cover lay film after curing, therefore, preferably from 100 MPa to 2,500 MPa, further preferably from 100 MPa to 2,000 Mpa, furthermore preferably from 100 MPa to 1,500 MPa.

The desired patterns can be obtained by using a basic solution as a developer to dissolve and remove the unexposed part after exposing the cover lay film laminated on the substrate to light through photo-masks with predetermined patterns. A conventional positive photoresist development device may be used in this developing process.

A basic water solution or an organic solvent can be used as a developer. The photosensitive resin composition according to the present invention is soluble in organic solvent and basic water solution.

The developer may be a solution of one kind of base compound or a solution of two or more kinds of base compounds if only it is either a basic water solution or an organic solvent which is soluble in water or in alcohol such as methanol. The basic solution is usually a solution obtained by dissolving a basic compound in water or alcohol such as methanol.

The base contained in the basic solution to be used as the above-mentioned developer is not particularly limited as long as a compound (basic compound) which is soluble in water or alcohol and has basic property when in solution. Examples of such compound include: hydroxide, carbonate salt, and amine salt of alkali metal, alkali-earth metal or ammonium ion. More specifically, examples thereof include: 2-dimethylaminoethanol, 3-dimethylamino-1-propanol, 4-dimethylamino-1-buthanol, 5-dimethylamino-1-pentanol, 4-dimethylamino-1-butanol, 5-dimethylamino-1-pentanol, 6-dimethylamino-1-hexanol, 2-dimethylamino-2-methyl-1-propanol, 3-dimethylamino-2,2-dimethyl-1-propanol, 2-diethylaminoethanol, 3-diethylamino-1-propanol, 2-diisopropylaminoethanol, 2-di-n-butylaminoethanol, N,N-dibenzil-2-aminoethanol, 2-(2-dimethylaminoethoxy)ethanol, 2-(2-diethylaminoethoxy)ethanol, 1-dimethylamino-2-propanol, 1-diethylamino-2-propanol, N-methyldiethanolamine, N-ethyldiethanolamine, N-n-buthyldiethanolamine, N-t-butyldiethanolamine, N-lauryl diethanolamine, 3-diethylamino-1, 2-propanediol, triethanolamine, triisopropanolamine, N-methylethanolamine, N-ethylethanolamine, N-n-butylethanolamine, N-t-butylethanolamine, diethanolamine, diisopropanolamine, 2-aminoethanol, 3-amino-1-propanol, 4-amino-1-buthanol, 6-amino-1-hexanol, 1-amino-2-propanol, 2-amino-2,2-dimethyl-1-propanol, 1-aminobuthanol, 2-amino-1-buthanol, N-(2-aminoethyl)ethanolamine, 2-amino-2-methyl-1,3-propanediol, 2-amino-2-ethyl-1,3-propanediol, 3-amino-1,2-propanediol, 2-amino-2-hydroxymethyl-1,3-propanediol, sodiumhydroxide, potassium hydroxide, ammonium hydroxide, sodium hydrocarbonate, potassium carbonate, ammonium carbonate, sodiumcarbonate, potassium hydrocarbonate, ammonium hydrocarbonate, tetramethylammonium hydroxide, tetraethylammonium hydroxide, tetrapropylammonium hydroxide, tetraisopropylammonium hydroxide, aminomethanol, 2-aminoethanol, 3-aminopropanol, 2-aminopropanol, methylamine, ethylamine, propylamine, isopropylamine, dimethylamine, diethylamine, dipropylamine, diisopropylamine, trimethylamine, triethylamine, tripropylamine, and triisopropylamine.

These compounds may be used alone or in combination of two or more kinds.

Organic solvents as well as basic solutions may be used in developer. In this case, organic solvents may be used alone or in combination of good solvents which dissolve the photosensitive polyimide of the present invention well and poor solvents which do not dissolve the photosensitive polyimide well. More specifically, the developer may partially contain water soluble organic solvents, such as methanol, ethanol, propanol, isopropyl alcohol, isobutanol, N-methyl-2-pyrolidone, N,N-dimethylforamide, and N,N-dimethylacetamide or may be a mixture of two or more kinds of these solvents to improve solubility of polyimide. The concentration of the above-mentioned basic compound may be usually from 0.1 to 50% by weight, but preferably from 0.1 to 30% by weight from a viewpoint of effects on the support and the like. The concentration is preferably from 0.1 to 10% by weight, further preferably from 0.1 to 5% by weight.

Patterns formed by developing are subsequently cleansed with rinse solution to remove the developer. Preferable examples of the rinse solution include: methanol, ethanol, isopropyl alcohol, and water which have good compatibility with the developer.

Unreacted groups (double bond or the like) are reacted by heating the substrate having a resist film where patterns obtained by the above-mentioned treatment are formed at an appropriate temperature from 20° C. to 200° C., which results in sufficient curing of this resist. If the heating temperature at this time exceeds 200° C., the crystal structure of copper mainly used for a conductive layer of the substrate will be changed, which leads to a degradation in strength, so that caution should be paid. In this manner, the substrate having a polyimide film as a cover lay film on which the desired patterns with high resolution are formed is obtained. This film is excellent in heat resistance and mechanical properties.

It is possible to easily prepare a substrate having a cover lay film with the desired patterns using the photosensitive dry film resist by the solubility contained in the photosensitive resin composition of the present invention.

The patterns obtained by the above-mentioned treatment are heated at temperatures selected within the range from 100° C. to 200° C. to obtain a CCL where resin patterns are formed without a process for application and drying.

The CCL on which a cover lay film using the photosensitive resin composition according to the present invention is flat without any warps and curls because of the properties of the photosensitive resin composition. Further, the resin patterns obtained from the cover lay film of the present invention are excellent in heat resistance and mechanical properties, especially excellent in resolution.

More specifically, the CCL has an elastic coefficient of 100 MPa to 3,000 MPa after curing, and is excellent in mechanical properties. The resolution shows a high value of line width/space width=100/100 μm or lower. Furthermore, the CCL has soldering heat resistance (300° C.) for not shorter than 3 minutes after curing.

In addition, the resin after laminated to copper and cured has heat resistance for solder bath of 300° C. and does not show any foaming and delamination even after being immersed in a solder of 300° C., which results in no deterioration.

The cover lay film according to the present invention may be a three-layer structure composed of a base film, a photosensitive film made using the photosensitive resin composition of the present invention, and a protective film. The protective film has suitable adhesion and releasability in relative to the photosensitive film.

More specifically, the cover lay film is a piece of sheet with a three-layer structure obtained by laminating a base film (1); a photosensitive film (2) consisted of the photosensitive resin composition of the present invention; and a protective film (3) in order. Further, the protective film is a film which is a laminated film of a copolymer film consisted of polyethylene and ethylenevinyl alcohol resin, and a stretched polyethylene film, or a film obtained by a simultaneous extrusion of a copolymer consisted of polyethylene and ethylenevinyl alcohol resin, and a stretched polyethylene, and in addition, the protective film forms a bonded surface with the above-mentioned photosensitive adhesive sheet.

A variety of films usually available in the market, such as polyethylene terephthalate films (hereinafter abbreviated as PET), polyphenylene sulfide films, and polyimide films may be used as a base film in three-layer structure sheet of the present invention, but polyimide films are preferably used in the use which the heat resistance is particularly required. Moreover, the bonded surface of the base film with the photosensitive film is preferably surface-treated to be easily peeled off.

In the photosensitive film according to the present invention, a resin composition having photo-curability and thermosetting properties is kept in a semi-cured state (B-stage). The photosensitive film has fluidity at the time of thermal pressing or laminating, and is adhered to irregularities in circuit of the flexible printed circuit board, furthermore, is designed to be completed in curing by thermal curing after the photo-cross linking reaction when exposed to light, heating, press working, and pressing. More specifically, resins, such as polyimides are preferably used as base polymers because of heat resistance and folding resistance of the film after curing, polyimide oligomer may be used, but soluble polyimides to be used in the present invention are preferable. Further, the above-mentioned epoxy polyimides are preferable because these epoxy polyimides improve adhesion to the flexible printed circuit board. Typical examples of the photo-curing resin other than the above include: acrylic resins, methacrylic resins, and vinyl resins having a double bond or a triple bond. Typical examples of the thermosetting resin include acrylic resins and epoxy resins. The photo-curing resin and the thermosetting resin may be identical, and the distinction between these resins is not particularly needed. The protective film according to the present invention typically comprises a laminate between “a copolymer film of polyethylene and vinyl alcohol” (hereinafter abbreviated as (PE+EVA) copolymer film) and “a stretched polyethylene film” (hereinafter abbreviated as OPE film), or a film (with PE film surface and surface of (PE+EVA) copolymer film) manufactured by a method for simultaneously extruding “a copolymer of polyethylene and ethylenevinyl alcohol resin” and “polyethylene”, and is characterized in that the film surface of the (PE+EVA) copolymer forms a bonded surface with the above-mentioned photosensitive sheet.

The protective film has mainly two manufacturing methods: a method for laminating two kinds of films; and a method for simultaneously extruding two kinds of resins.

A film is prepared by laminating a (PE+EVA) copolymer film and an OPE film in the laminating method. Alternatively, a film may be prepared by laminating an ethylenevinyl alcohol resin film and an OPE film. It is a general method that an adhesive is thinly coated with the surface where these films are laminated. In this case, the (PE+EVA) copolymer film surface to be laminated to the OPE film is preferably promotion-treated in adhesion, such as corona treatment.

A film is prepared by simultaneously extruding a polyethylene resin and a resin comprises a copolymer of polyethylene and an ethylenevinyl alcohol resin in the method for simultaneously extruding two kinds of resins. In this method, a film, in which one side is the PE film surface and the other side is the (PE+EVA) copolymer film surface, can be obtained.

This (PE+EVA) copolymer film preferably includes no additives such as lubricants and antistatic agents. When these additives are used, they bred out from the protective film and transferred to the photosensitive film, so that the adherence and adhesion between the photosensitive and the CCL may be lowered because the the photosensitive film are directly contacted to the (PE+EVA) copolymer film. Accordingly, sufficient consideration should be given on such points when using an additive on the protective film and performing surface treatment.

The (PE+EVA) copolymer film has preferably a thickness as thin as possible, but the thickness is preferably from 2 to 50 μfrom a viewpoint of its handling. The (PE+EVA) copolymer film has excellent adherence with the photosensitive film and is capable to prevent the photosensitive film from being dried, which leads to be characterized in easy delamination when simultaneously using the photosensitive film.

The OPE film to be used for a protective film in the laminating method is laminated as a reinforcement material for a (PE+EVA) copolymer film, but its thickness is preferably from 10 to 50 μm. If the thickness is too thin, the film will have wrinkles. Particularly, the thickness is preferably in the range of 10 to 30 μm. The OPE film has one of preferable reasons in having properties of excellent sliding when the sheet is made into a roll.

Examples of the method for laminating the (PE+EVA) copolymer film and the OPE film include a variety of methods, but the common method is coating the adhesive thinly on OPE film, drying, and after laminating this adhesive surface and the corona treated surface of the (PE+EVA) copolymer film with a thermal roll. The above-mentioned adhesive to be used in lamination is not particularly limited. Conventional adhesives available in the market may be used, but particularly, urethane adhesives are effectively used.

In the case of the protective film obtained by simultaneous extrusion method, the amount of a resin comprises a copolymer of polyethylene and an ethylenevinyl alcohol resin, and the amount of polyethylene resin is adjusted at the time of step of simultaneous extrusion. This adjustment enables to control respective thickness of the (PE+EVA) copolymer film of the sheet to be prepared and the PE film. The respective thickness of the (PE+EVA) copolymer film and the PE film in this case is preferably from 2 to 50 μm and from 10 to 50 μm because of the same reason as that of the above-mentioned.

It is also possible to provide the protective film with a light blocking effect. There are a variety of methods for providing the protective film with a light blocking effect, but a method for coloring the OPE film is preferable in the case of the present invention. Particularly, it is the most preferable to color so that the color can absorb light with a wavelength within the range that a photoreaction initiator contained in the photosensitive film absorbs.

The photosensitive film according to the present invention preferably includes a photoreaction initiator to draw the desired patterns by being developed by exposure to light. The photoreaction initiator of the present invention is not particularly limited if only the substance accelerates cross-linking and polymerization by producing radical and a base at the time of absorbing light with a particular wavelength, and reacting with a reaction group (vinyl, acryl, methacryl, and allyl groups) having a double bond and/or a triple bond, but the mixing ratio of the entire resin including a base polymer, photo-curing resins and/or thermosetting resins, and the photoreaction initiator is preferably from 0.1 to 5 parts by weight, further preferably from 0.5 to 5 parts by weight based on 100 parts by weight of the total amount of resins.

The photosensitive film according to the present invention preferably has a thickness of 5 to 75 μm, further preferably from 10 to 75 μm, the most preferably from 15 to 65 m. If the thickness of the photosensitive film is too small, it will be not preferable because it is impossible to embed unevenness between the copper circuit and the polyimide film used as the base film provided on the flexible printed circuit board and to keep flatness on the surface after laminating. If the thickness is too great, it will be not preferable, either because it is easy to produce the warp of samples as well as being difficult to develop fine patterns.

Usually, in the photosensitive film, the adhesive composition having the above-mentioned photo-setting and thermosetting properties is maintained in a semi-cured (B-stage) state. The photosensitive film has flow properties when thermally pressing or laminating and is adhered along unevenness of the circuit of the flexible printed circuit board to be so designed that curing may be completed by thermal curing after the photo-cross linking reaction when exposing to light and heating and pressing after press working.

The photosensitive film to be used in the present invention contains polyimide. More particularly, polyimides having an aromatic ring in molecule or alicyclic polyimides have excellent heat resistance and mechanical strength such as flexibility, which are preferably used. A film composed of the above-mentioned photosensitive resin composition is preferably used.

A method for manufacturing a cover lay film with a three-layer structure will now be described in detail.

A photosensitive resin composition in a solution state is uniformly applied onto a base film such as a PET film and then the solvent is removed by heating and/or hot air spraying to make a photosensitive dry film resist.

A variety of films available in the market such as polyethylene terephthalate (hereinafter abbreviated as PET) films, polyphenylene sulfide films, and polyimide films may be used as the base film in the present invention. Further, the bonded surface of the base film with the photosensitive film is preferably surface-treated so that the photosensitive film side may easily be peeled off. PET films are particularly preferable as a base film because of having heat resistance to a certain degree and its relatively low price and easy availability.

The photosensitive film according to the present invention preferably has a thickness of 5 to 75 μm, further preferably 10 to 70 μm, and the most preferably 15 to 40 μm. If the thickness of the photosensitive film is too small, it will be impossible to embed unevenness between the copper circuit and the polyimide film used as base provided on the flexible printed circuit board, which may result in being unable to maintain flatness of the surface after laminating. On the contrary, if the thickness is too great, it will be difficult to develop fine patterns, so that the sample will easily have warps.

Usually, in the photosensitive film, the resin composition having the above-mentioned photo-setting and thermosetting properties are maintained in a semi-cured (B-stage) state. The photosensitive film has flow properties when thermally pressing or laminating and is adhered along unevenness of the circuit of the flexible printed circuit board to be so designed that curing may be completed by thermal curing after the photo-cross linking reaction when exposing to light and heating and pressing after press working.

The three-layer structure sheet according to the present invention is obtained by laminating the above-mentioned based film, photosensitive film, and protective film in order, where it is important that the surface of the (PE+EVA) copolymer film of the protective film forms a bonded surface (molder releasing surface) with the adhesive film. A method can be used to coat a photosensitive resin component on the base film, laminating the photosensitive adhesive film surface and the (PE+EVA) copolymer film surface of the protective film after drying is preferable as a laminating method, and taking up in the roll state.

The photosensitive cover lay film composed of the three-layer structure sheet can be stored in the roll state, so that it is possible to proceed with the manufacturing process of a flexible printed circuit board smoothly by continuous laminating instead of laminating in the conventional batch-type method when laminating to the CCL where the circuit is formed.

In order to manufacture the cover lay film for a flexible printed circuit board using the three-layer structure sheet according to the present invention, a flexible printed circuit board where the circuit is formed and a photosensitive film are laminated by heating. The temperature at the time of laminating is preferably as low as possible because the film becomes cured by the cross-linking of the photosensitive reacted portion when the temperature is too high, which results in loss of functions as a photosensitive cover lay. More specifically, the temperature at the time of laminating is preferably from 60 to 150° C., further preferably from 60 to 120° C. When the temperature is too low, the flow properties in the photosensitive film becomes deteriorated, which makes it difficult to coat the fine circuit on the flexible printed circuit board and its adherence becomes deteriorated.

When the photosensitive film composed of a three-layer structure sheet according to the present invention is used, the substrate may be also preheated to improve recessed properties of the fine circuit, but it will not be needed to preheat the substrate if the photosensitive film is heated in the above-mentioned manner.

As mentioned above, the flexible printed circuit board/photosensitive film/base film are laminated in order in the three-layer structure sheet. The base film maybe released when the lamination is completed or after the exposure to light is completed. The base film may be preferably peeled off after placing photo-mask patterns and exposing to light to protect the photosensitive film.

Additionally, this photosensitive film is cured to be a cover lay film to insulate and protect the circuit by thermal curing after being laminated onto the circuit of the flexible printed circuit board and irradiating light, such as ultraviolet rays. The photosensitive film of the present invention is also preferably used as a cover lay film for the substrate circuit of the head part for the hard disk device of a personal computer.

The photosensitive film may also be used for a suspension of the hard disk and the circuit of the conductive layer to be protected. More specifically, patterns for required wiring can easily be formed by placing masks to be exposed to light and developing after laminating the cover lay film of the present invention onto the substrate for suspension where the circuit is provided. The photosensitive film is, therefore, useful from a viewpoint of the process and reduction of costs.

It is possible to bore a hole at a desired position by placing photo-mask patterns to be exposed to light and developing after bonding onto the circuit when using the photosensitive film as a photosensitive cover lay for a flexible printed circuit board and the head part of the hard disk device for a personal computer. Since the photoreaction initiator usually absorbs light in the area of ultraviolet rays, a light source to effectively radiate ultraviolet rays may be used as a light for irradiation.

The above-mentioned basic water solution or organic solvent may be used as a developer in this case. Water or an organic solvent may be used as a solvent for dissolving basic compounds. The water solution may be preferably used to prevent the film from being damaged and pay attention to the environment. More particularly, to improve solubility in polyimide, the solvent may further contain water-soluble organic solvents, such as methanol, ethanol, propanol, isopropyl alcohol, isobuthanol, N-metyl-2-pirrolydone, N,N-dimethylformamide, and N,N-dimethylacetamide or in combination of two or more kinds of solvents. The basic compound may be used alone or in combination of two or more kinds. The concentration of the basic compound is generally from 0.1 to 10% by weight, but preferably from 0.1 to 5% by weight to control effects on the film. Examples of the above-mentioned basic compound include: alkali metal, alkali-earth metal or ammonium ion, such as hydroxide, carbonate salt, and amine compound.

After development, the flexible printed circuit board with the coverlay film is cleansed with distilled water or the like and is dried to be cured by heating after drying to obtain a cover lay having excellent heat resistance and chemical resistance. This thermal curing is performed at temperatures in the range of 100° C. to 200° C. for about 15 minutes to 90 minutes. A cover lay is thus prepared on the printed circuit board to package electronics part, such as IC chips.

### EXAMPLES

The present invention will hereafter be described more particularly by showing examples thereof, but the present invention is not limited to these examples.

ESDA used in examples expresses 2,2-bis(4-hydroxyphenyl)propanedibenzoate-3,3′,4,4′-tetracarboxylic dianhydride, BAPS-M expresses bis[4-(3-aminophenoxy phenyl)sulfone, DMAc expresses N,N-dimethylacetamide, and DMF expresses N,N′-dimethylformamide.

A thermal decomposition starting temperature was measured within the temperature range from room temperature to 500° C. at the rate of rise in temperature of 10° C./minute using a TG/DTA220 produced by Seiko Instruments Inc. and the temperature in which weight decrease was 5% was assumed to be the thermal decomposition starting temperature.

The thermal expansion coefficient was measured under a nitrogen current at a rate of temperature rise of 10° C./min within the temperature range from room temperature to 350° C. using a TMA device manufactured by Seiko Instruments Inc. (Model No.120C).

The elastic coefficient, tensile strength, and elongation were measured in accordance with the Japanese Industrial Standard C 2318.

The elastic coefficient, tensile strength, and elongation after cured were measured using a tensile tester manufactured by Shimadzu Corporation Autograph S-100-C) as follows: First, a solution of a photosensitive composition (varnish) was uniformly applied onto a copper foil to prepare a cover film of 25 am×25 cm by drying. The cover film was entirely exposed to light (Exposure conditions: Exposing to parallel right with a wavelength of 400 nm for 300 mJ/cm²) and then the copper foil was removed by etching after curing at 180° C. for 2 hours. The film thus obtained was put on a pin frame to be dried at 100° C. for 30 minutes and then some pieces of tapes having a width of 0.015 m and a length of 0.20 m were cut out. The force required for extending the length of the tape by 5% was measured by picking up the part of the tape with the length of 0.10 m with an autograph and pulling at a constant speed. This force(N) was divided by 0.05 and is further divided by the average thickness (m) and the width of the tape (0.015 m) to calculate the elastic coefficient (MPa). The value obtained by keeping the tape pulled and dividing the force exerted when breaking the tape (Pa·m²) by the average thickness (m) and the width (0.015 m) of the tape was the tensile strength (MPa), and the elongation (%) was the value obtained by dividing the maximum length extended by the original length of the tape and multiplying by 100.

(Elastic coefficient (MPa)=(Force (Pa·m) required to extend

the length by 5%)/0.05×[(Average thickness of the film (m))×[Width of the tape (0.015 m)](Tensile strength (MPa))=(Force at the time of breaking the tape (Pa·m))/[(Average thickness of the film (m))×(Width of the tape (0.015 m))](Elongation (%))=100×(Length of the tape when extended to the maximum (m))/(Original length of the tape (M))(Glass transition temperature Tg and 5% of weight loss temperature)

A glass transition temperature (Tg) was measured within the temperature range from room temperature to 400° C. at the rate of rise in temperature of 10° C./minute under a nitrogen atmosphere using a DSC CELL SCC-41 (a differential scanning calorimeter produced by Shimadzu Corporation). The temperature of 5% weight loss was measured within the temperature range from 20° C. to 600° C. at the rate of temperature rise of 20° C./minute under air using a TG/DTA (a differential thermal analyzer). The temperature when the weight of the sample decreased by 5% was assumed to be the temperature of 5% weight loss. The temperature of 5% weight loss is also an indicator for showing heat resistance.

### Measurement of Weight-Average Molecular Weight

The weight-average molecular weight (Mw) was measured with a GPC produced by Waters Corporation under the following conditions:

Column: 2 pieces of KD-806M (produced by Shodex)

Temperature: 60° C.

Detector: RI (Refractive Index)

Flow rate: 1 ml/minute

Developer: Dimethylformamide (DMF: lithium bromide 0.03M, phosphoric acid 0.03M)

Concentration of sample solution : 0.2 wt %

Injection amount: 20 μl

Reference material: polyethylene oxide

### Measurement of Imidization Ratio

(1) A polyamic acid solution (DMF solution) was cast on a poly(ethylene terephthalate) film (PET film), peeled off from the PET film after drying by heating at 100° C. for 10 minutes and 130° C. for 10 minutes under atmospheric pressure, and fixed to a pin frame. The DMF solution was further heated at 150° C. for 60 minutes, 200° C. for 60 minutes, and 250° C. for 60 minutes in order to obtain a polyimide film with a thickness of 5 μmm.

(2)Polyimide prepared in the examples or the comparative examples was dissolved in DMF and cast on a PET film, peeled off from the PET film after drying by heating at 100° C. for 30 minutes. The polyimide was dried by heating at 80° C. for 12 hours under the condition of 660 Pa in a vacuum oven to obtain a polyimide film with a thickness of 5 μm. Infrared radiation (IR) of respective films was measured to determine the absorbance of imide/benzene. Imidization ratio was obtained by determining the percentage of the absorbance in (2)(imide/benzene ring) when the absorbance (imide/benzene ring) obtained in (1) was 100% imidization ratio.

### Measuring Method of Carboxylic Acid (COOH) Equivalent Amount

About 0.1N KOH of ethanol solution was titrated with a−0.1N oxalic acid water solution to accurately determine the concentration. The weight of soluble polyimide was accurately measured to be so dissolved in dioxolane that the concentration may be about 2%. Titration was performed with the above-mentioned KOH ethanol solution. The end point of titration was all determined by variation in color development of a phenolphthalein solution. The carboxylic acid equivalent amount was calculated by the following equation:

COOH equivalent amount=1,000×(weight of soluble imide)/{(concentration of KOH ethanol solution/(titer)}

The titer is the amount required (ml) to titrate soluble imide with a KOH ethanol solution.

### Adhesion Strength

Adhesion strength was measured in accordance with the measuring method of peeling strength (90 degrees) in JISC6481. The width was measured by a width of 3 mm and converted into 1 cm.

### Characteristic Test of Solder Bath Heat Resistance

A laminate of a polyimide film and a copper foil was cured to be soaked into a solder at 300° C. for 3 minutes and then the degree of deterioration, such as foaming and delamination was visually observed. A three-layer structure sheet and a protective film were prepared in examples and the three-layer structure sheet and a photosensitive film were evaluated as follows:

(1) Preparation of Photosensitive Resin Composition

After the dissolution of soluble polyimide resin in organic solvent to a degree that the solid content of the polyimide resin could be 30% by weight and then a diacrylate compound as a component (B) and a photoreaction initiator and/or a sensitizer as a component (C) were mixed to prepare a uniform photosensitive resin composition.

(2) Preparation of Three-Layer Structure Sheet

The organic solvent of the photosensitive resin composition prepared in (1) was applied onto a PET film (with a thickness of 25 μm) so that the thickness of the film might be 50 μm after drying and the organic solvent was removed by drying at 45° C. for 5 minutes and then at 65° C. for 5 minutes to bring the photosensitive film to the B-stage state.

Subsequently, a photosensitive cover lay composed of a three-layer structure sheet was prepared by laminating the following protective film in a status that the surface of a (PE+EVA)copolymer film might contact with the photosensitive film surface. The laminating conditions were that roll temperature at 40° C. and the nip pressure under 1,500 Pa·m.

(3) Preparation of Protective Film

A film with a thickness of 38 μm was used as an OPE film. An urethane-type adhesive was applied onto the film so that the thickness of the film might be 0.5 μm after drying to be dried by heating at 120° C. for 5 minutes. The OPE film and the (PE+EVA) copolymer film were so laminated that the surface of the OPE film where the adhesive was applied might contact with the corona-treated surface of the copolymer film surface (manufactured by Sekisui Chemical Co., Ltd., with a thickness of 10 μm, with one side corona-treated) at the roll temperature of 120° C. under a nip pressure of 2,000 pa·m.

A protect film (No. 6221F, with a thickness of 50 μm) manufactured by Sekisui Chemical Co., Ltd. was used as a protective film according to a method for simultaneously extruding a polyethylene resin and a resin composed of a copolymer consisting of polyethylene and ethylene vinyl alcohol resin.

(4) Evaluation of Three-Layer Structure Sheet

The obtained three-layer structure sheet and photosensitive film were evaluated in some properties by the following methods:

<Releasability of Protective Film>

Releasability of the protective film was measured by pulling the protective film at 90 degrees with a Tensilon after laminating the tape like three-layer structure sheet with a width of 30 mm to an aluminum board (with a thickness of 3 mm) using a both sided tape. The releasability was preferably from 3.3 to 13.3 Pa·m in actual use, and the range was regarded as passing. The releasability over 33.3 Pa·m was regarded as unacceptable due to too heavy delamination.

<Developing Properties of Photosensitive Film>

After the protective sheet of the three-layer structure sheet was peeled off, the surface of a photosensitive film was laminated onto a shiny side with a 35 μm-electrolytic copper foil by heating at 100° C. under the pressure of 20,000 Pa·m. Mask patterns were overlaid on the support film of this laminate to be exposed to light with a wavelength of 400 nm for 300 mJ/cm² to be heated at 100° C. for 2 minutes and be developed under either of the following conditions: The exposed amount was described for each example and comparative example.

1. Developing for 2 minutes with a water solution of 1% potassium hydroxide (at liquid temperature of 40° C.)

2. Developing for 5 minutes with an isopropanol solution of 1% tetramethylammonium (at liquid temperature of 40° C.)

Further, photo-mask patterns disposed on the cover film when exposed to light were fine holes of 200 μm×200 μm square and 100 μm×100 μm square. The patterns formed by the development were cleansed with water to remove the developer and then dried by heating at 90° C. for about 15 minutes. The evaluation was regarded as passing as long as at least a hole of 200 μm×200 μm square was developed.

<Soldering Heat Resistance of Photosensitive Film>

After the peeling off the protective film of the three-layer structure sheet, the surface of the photosensitive film was laminated onto the shiny side with a thickness of 35 μm-electrolytic copper foil by heating at 100° C. under the pressure of 20,000 pa·m. The photosensitive film of the laminate was exposed to light with a wavelength of 400 nm for 300 mJ/cm² through the base film to be heated at 180° C. for 2 hours after peeling off the base film. This laminate sample was cut into the size of 25 mm square to be humidified for 24 hours at 20° C. under the humidity of 65% and then to be soaked into a melting solder at 300° C. for 1 minute. Observation was made as to whether or not there was abnormality, such as swelling or delamination on the samples. The evaluation was regarded as passing when no abnormality was seen.

<Folding Endurance of Photosensitive Film>

A photosensitive film in which a protective film had been peeled off was laminated onto patterns provided on a copper-clad laminate (CCL) having a return pattern of line/space=100/100 μm by heating at 100° C. under the pressure of 20,000 Pa·m. This photosensitive film was exposed to light with a wavelength of 400 nm for 300 mJ/cm² and then the laminate sample was heated at 180° C. for 2 hours after peeling off the base film. The sample was placed on a MIT tester to perform a bending test with a bending diameter of 1 m, at the bending angle of 270 degrees under the pulling load of 4.9 N and then measurements were made as to the frequency in continuity of the patterns. The evaluation was regarded as passing when the frequency of continuity was at least 500 cycles.

The measurement of folding endurance is one of indicators to evaluate mechanical strength of the film. Flexible films can maintain a continuity for a large number of bending test, but hard and fragile films maintain in continuity only for a small number of bending test.

<Insulation Resistance Between Lines of Photosensitive Film>

A photosensitive film from which a protective film had been released was laminated onto comb-like patterns of a copper-clad laminate (CCL) where comb-like patterns of line/space=100/100 μm by heating at 100° C. under the pressure of 20,000 Pa·m. This photosensitive film was exposed to light with a wavelength of 400 nm for 300 mJ/cm² and then the laminate sample was heated at 180° C. for 2 hours after peeling off the base film. Insulation resistance between lines was measured in accordance with the IPC-4.8.10.2.1. The resistivity is preferably as high as possible. And the evaluation was, however, regarded as passing when the resistivity was at least 1.0×10¹³Ω.

The insulation resistance between lines is an indicator to evaluate electrical insulation of the film. Greater the resistivity is, better the electrical insulation is.

### Example 1

43.05 g (0.10 mole) of BAPS-M, 300 g of DMF, and 57.65 g (0.10 mole) of ESDA were placed in a 2,000 ml-separable flask equipped with a stirrer to be vigorously stirred and the stirring was continued for 30 minutes to obtain a polyamic acid solution. The weight-average molecular weight (hereinafter referred to as Mw) of this polyamic acid was 62,000.

This polyamic acid solution was placed in a butt coated with Teflon and successively heated with a vacuum oven at 200° C. for 2 hours under reduced pressure of 660 Pa. The polyimide was taken out of the vacuum oven and 96 g of thermoplastic polyimide was obtained. The Mw of the polyimide was 68,000, the Tg was 200° C., and the imidization ratio was 100%.

30 g of soluble polyimide was dissolved in 70 g of dioxolane to obtain a varnish of Sc=30%. 4.5 g of isocyanic acid EO-modified triacrylate (hereinafter referred to as A-9300) manufactured by Shin-Nakamura Chemical Co., Ltd., 0.1 g of Irugacure 819 to be used as a photoreaction initiator, and 0.01 g of 4-methoxyphenol (hereinafter referred to as MEHQ) to be used as a polymerization inhibitor were added to 18.3 g of this varnish to be applied onto a PET film after defoamed. A photosensitive polyimide film with a thickness of 50 μm was obtained by drying at 45° C. for 5 minutes and 65° C. for 5 minutes, and 80° C. for 5 minutes.

A copper foil, a polyimide film, and a PET film (releasing paper) were overlaid in order to be laminated by heating at 120° C. under the pressure of 10,000 Pa·m. After laminating, photo-mask patterns were placed on this laminate to be exposed to light for 300 mJ/cm² (Exposure conditions: parallel light at 400 nm) and post-baked at 100° C. for 3 minutes after the peeling off of the PET film to be cured by heating at 100° C. for 2 hours, 120° C. for 2 hours, 140° C. for 2 hours, and 160° C. for 3 hours after having been developed with an isopropanol solution (at liquid temperature of 40° C.) of 1% tetramethyl ammonium hydroxide. The Tg after curing was 290° C. and the thermal expansion coefficient after curing was 55 ppm from room temperature to 100° C.

The elastic coefficient of the residual photosensitive polyimide film after curing obtained by removing the copper foil of the flexible copper-clad plate by etching was 400 MPa, the elongation was 2.8%, and the tensile strength was 120 MPa.

### Example 2

68.88 g (0.16 mole) of BAPS-M, 320 g of DMF, and 138.4 g (0.24 mole) of ESDA were placed in a 2,000 ml-separable flask equipped with a stirrer to be vigorously stirred and the stirring was continued for 30 minutes. And then cooling was achieved with iced water to afford reaction. Subsequently, 12.1 g (0.08 mole) of diamino benzoic acid was dissolved in 120 g of DMF to be stirred for 30 minutes to obtain a polyamic acid solution. The weight-average molecular weight (hereinafter referred to as Mw) of this polyamic acid was 58,000. This polyamic acid solution was placed in a butt coated with Teflon and successively heated with a vacuum oven at 200° C. for 2 hours under reduced pressure of 660 Pa.

The polyimide was taken out of the vacuum oven and 98 g of thermoplastic polyimide having carboxylic acid was obtained. The Mw of the polyimide was 65,000, the Tg was 190° C., and the imidization ratio was 100%.

### Synthesis of Epoxy-Modified Polyimide

48.4 g (56 milli mole) of soluble polyimide synthesized was dissolved in 110 g of dioxolane, 0.1 g of MEHQ was added to be dissolved while heating at 50° C. to 60° C. with an oil bath. 1.42 g (10 milli mole) of glycidyl methacrylate was added to this solution to be dissolved in 5 g of dioxolane, and stirring was conducted by heating at 60° C. for 6 hours. Further, 3.80 g (10 milli mole) of Epoxy 828 manufactured by Shell International Chemicals Corporation was dissolved in 14 g of dioxolane to be added to this solution and the stirring was conducted by heating at 60° C. for 6 hours to synthesize an epoxy-modified polyimide.

2.0 g of polyfunctional acryl A-9300, 2.5 g of Bisphenol F EO-modified (n≠2) diacrylate (hereinafter referred to as M208) manufactured by Toa Gosei Aronix, 0.1 g of Irugacure 819, 0.1 g of 4,4′-diaminodiphenylmethane (hereinafter referred to as DDM), and 0.01 g of MEHQ were added to 18.3 g of this epoxy-modified polyimide solution and mixed to be defoamed. This solution was applied onto the PET film and dried at 45° C. for 5 minutes, 65° C. for 5 minutes, and 80° C. for 5 minutes to obtain a photosensitive polyimide film with a thickness of 50 μm.

A copper foil, a polyimide film, and a PET film (releasing paper) were overlaid in order to be laminated by heating at 120° C. under the pressure of 10,000 Pa·m. After laminating, photo-mask patterns were placed on this laminate to be exposed to light for 300 mJ/cm² (Exposure conditions: parallel light at 400 nm) and post-baked at 100° C. for 3 minutes to be cured by heating at 100° C. for 2 hours, 120° C. for 2 hours, 140° C. for 2 hours, and 160° C. for 3 hours after having been developed with an isopropanol solution (at liquid temperature of 40° C.) of 1% tetramethyl ammonium hydroxide. The Tg after curing was 120° C. and the thermal expansion coefficient after curing was 65 ppm from room temperature to 100° C.

The elastic coefficient of the residual photosensitive polyimide film after curing obtained by removing the copper foil of the flexible copper-clad plate by etching was 2,800 MPa, the elongation was 5.0%, and the tensile strength was 103 MPa.

### Example 3

1.3 g of A-9300, 2.7 g of M-208, 0.1 g of Irugacure 819, 0.1 g of DDM, and 0.01 g of MEHQ were added to 20.0 g of epoxy-modified polyimide solution synthesized in Example 2 and mixed to be defoamed. This solution was applied on the PET film to be dried by heating at 45° C. for 5 minutes to obtain a photosensitive polyimide film with a thickness of 50 μm.

A copper foil, a polyimide film, and a PET film were overlaid in order to be laminated by heating at 120° C. under the pressure of 10,000 Pa·m. After laminating, photo-mask patterns were placed on this laminate to be exposed to light for 300 mJ/cm² (Exposure conditions: parallel light at 400 nm) and post-baked at 100° C. for 3 minutes to be cured by heating at 100° C. for 2 hours, 120° C. for 2 hours, 140° C. for 2 hours, and 160° C. for 3 hours after having been developed with an isopropanol solution (at liquid temperature of 40° C.) of 1% tetramethyl ammonium hydroxide. The Tg after curing was 187° C. and the thermal expansion coefficient after curing was 350 ppm from room temperature to 100° C. after curing. The elastic coefficient of the residual photosensitive polyimide film after curing obtained by removing the copper foil of the flexible copper-clad plate by etching was 400 MPa, the elongation was 5.0%, and the tensile strength was 83 MPa.

### Example 4

68.88 g (0.16 mole) of BAPS-M, 320 g of DMF, and 184.5 g (0.32 mole) of ESDA were placed in a 2,000 ml-separable flask equipped with a stirrer to be vigorously stirred and the stirring was continued for 30 minutes. And then cooling was achieved with iced water to afford reaction. Subsequently, 24.34 g (0.16 mole) of diamino benzoic acid was dissolved in 120 g of DMF to be stirred for 30 minutes to obtain a polyamic acid solution. The weight-average molecular weight (hereinafter referred to as Mw) of this polyanic acid was 58,000. This polyamic acid solution was placed in a butt coated with Teflon and successively heated with a vacuum oven at 200° C. for 2 hours under reduced pressure of 660 Pa. The polyimide was taken out of the vacuum oven and 260 g of thermoplastic polyimide having carboxylic acid was obtained. The Mw of the polyimide was 65,000, the Tg was 190° C., and the imidization ratio was 100%.

### Synthesis of Epoxy-Modified Polyimide

100 g (120 milli mole) of soluble polyimide synthesized was dissolved in 300 g of dioxolane, 0.2 g of MEHQ was added to be dissolved while heating at 60° C. with an oil bath. 4.26 g (30 milli mole) of glycidyl methacrylate was added to this solution to be dissolved in 21 g of dioxolane, and stirring was conducted by heating at 60° C. for 6 hours. Further, 12.92 g (34 milli mole) of Epoxy 828 manufactured by Shell International Chemicals Corporation was dissolved in 30 g of dioxolane to be added to this solution and the stirring was conducted by heating at 60° C. for 6 hours to synthesize an epoxy-modified polyimide.

1.0 g of polyfunctional acryl A-9300, 2.5 g of M208, 0.1 g of Irugacure 819, 0.1 g of DDM, and 0.01 g of MEHQ were added to 26.0 g of this epoxy-modified polyimide solution and mixed to be defoamed. This solution was applied onto the PET film and dried by heating at 45° C. for 5 minutes to obtain a photosensitive polyimide film with a thickness of 50 μm.

A copper foil, a polyimide film, and a PET film were overlaid in order to be laminated by heating at 100° C. under the pressure of 10,000 Pa·m. After laminating, photo-mask patterns were placed on this laminate to be exposed to light for 300 mJ/cm² (Exposure conditions: parallel light at 400 nm) and post-baked at 100° C. for 3 minutes to be cured by heating at 100° C. for 2 hours, 120° C. for 2hours, 140° C. for 2 hours, and 160° C. for 3 hours after having been developed with an isopropanol solution (at liquid temperature of 40° C.) of 1% tetramethyl ammonium hydroxide. The Tg after curing was 170° C. and the thermal expansion coefficient after curing was 135 ppm from room temperature to 100° C.

The elastic coefficient of the residual photosensitive polyimide film after curing obtained by removing the copper foil of the flexible copper-clad plate by etching was 3,100 MPa, the elongation was 1.0%, and the tensile strength was 26 MPa.

### Example 5

64.57 g (0.15 mole) of BAPS-M, 335 g of DMF, and 115.3 g (0.20 mole) of ESDA were placed in a 2,000 ml-separable flask equipped with a stirrer to be vigorously stirred and the stirring was continued for 30 minutes. And then cooling was achieved with iced water to afford reaction. Subsequently, 7.61 g (0.050 mole) of diamino benzoic acid was dissolved in 70 g of DMF to be stirred for 30 minutes to obtain a polyamic acid solution. The weight-average molecular weight (hereinafter referred to as Mw) of this polyamic acid was 58,000. This polyamic acid solution was placed in a butt coated with Teflon and successively heated with a vacuum oven at 200° C. for 2 hours under reduced pressure of 660 Pa. The polyimide was taken out of the vacuum oven and 260 g of thermoplastic polyimide containing carboxylic acid was obtained. The Mw of the polyimide was 65,000, the Tg was 190° C., and the imidization ratio was 100%.

### Synthesis of Epoxy-Modified Polyimide

50 g (55.5 milli mole) of soluble polyimide synthesized was dissolved in 130 g of dioxolane, and 0.1 g of MEHQ was added to be dissolved while heating at 60° C. with an oil bath. 5.7 g (15 milli mole) of Epoxy 828 manufactured by Shell International Chemicals Corporation was dissolved in 10 g of dioxolane to be added to this solution and the stirring was conducted by heating at 60° C. for 8 hours to synthesize an epoxy-modified polyimide.

1.0 g of tri-functional acryl A-9300, 2.5 g of M208, 0.1 g of Irugacure 819, 0.1 g of DDM, and 0.01 g of MEHQ were added to this 26 g of epoxy-modified polyimide solution and mixed to be defoamed. This solution was applied onto the PET film and dried by heating at 45° C. for 5 minutes to obtain a photosensitive polyimide film with a thickness of 50 μm.

A copper foil, a polyimide film, and a PET film were overlaid in order to be laminated by heating at 100° C. under the pressure of 10,000 Pa·m. After laminating, photo-mask patterns were placed on this laminate to be exposed to light for 300 mJ/cm² (Exposure conditions: parallel light at 400 nm) and post-baked at 100° C. for 3 minutes to be cured by heating at 100° C. for 2 hours, 120° C. for 2 hours, 140° C. for 2 hours, and 160° C. for 3 hours after having been developed with an isopropanol solution (at liquid temperature of 40° C.) of 1% tetramethyl ammonium hydroxide. The Tg after curing was 180° C. and the thermal expansion coefficient after curing was 260 ppm from room temperature to 100° C.

The elastic coefficient of the residual photosensitive polyimide film after curing obtained by removing the copper foil of the flexible copper-clad plate by etching was 2,790 MPa, the elongation was 3.6%, and the tensile strength was 92 MPa.

### Comparative Example 1

0.1 g of Irugacure 819, 0.1 g of DDM, and 0.01 g of MEHQ were added to 36.6 g of epoxy-modified polyimide solution synthesized in Example 2 instead of adding a di(meta) acrylic acid-type compound to be used as component (B) and mixed to be defoamed. And then a photosensitive polyimide film with a thickness of 50 μm was obtained in the same manner as in the Example.

A copper foil, a polyimide film, and a PET film were overlaid in order to be laminated under the pressure of 10,000 Pa·m. The lamination was achieved by heating not lower than 190° C. After laminating, photo-mask patterns were placed on this laminate to be exposed to light for 300 mJ/cm² (Exposure conditions: parallel light at 400 nm) and post-baked at 100° C. for 3 minutes to be developed with an isopropanol solution (at liquid temperature of 40° C.) of 1% tetramethyl ammonium hydroxide, but few patterns were drawn. And then curing was performed by heating at 100° C. for 2 hours, 120° C. for 2 hours, 140° C. for 2 hours, and 160° C. for 3 hours. The Tg after curing was 280° C. and the thermal expansion coefficient after curing was 30 ppm from room temperature to 100° C.

As mentioned above, a cover lay film obtained by mixing a photoreaction initiator, an epoxy curing agent, and a polymerization inhibitor instead of adding the component (B) to epoxy-modified polyimide had high heat resistance, but had difficulty in lamination at lower temperatures, which resulted in poor resolution.

### Example 6

8.60 g (0.02 mole) of BAPS-M, 33.2 g (0.04 mole) of KF8010; a product of Shin-Etsu Chemical Co., Ltd. used as siloxane diamine (in the above-mentioned general formula (3),×=3, y=10, R=CH₃), 200 g of DMF, and 57.65 g (0.10 mole) of ESDA were placed in a 2,000 ml-separable flask equipped with a stirrer to be vigorously stirred and the stirring was continued for 30 minutes. And then to obtain a polyamic acid solution, 6.1 g (0.04 mole) of diamino benzoic acid was dissolved in 75 g of DMF and added to the above-mentioned solution to be stirred for 30 minutes. The weight-average molecular weight (hereinafter referred to as Mw) of this polyamic acid was 60,000.

This polyamic acid solution was placed in a butt coated with Teflon and successively heated with a vacuum oven at 150° C. for 10 minutes, 160° C. for 10 minutes, 170° C. for 10 minutes, 180° C. for 10 minutes, 190° C. for 10 minutes, and 210° C. for 30 minutes under reduced pressure of 660 Pa.

The polyimide was taken out of the vacuum oven and 100 g of thermoplastic polyimide containing carboxylic acid was obtained. The Mw of the polyimide was 65,000 and the imidization ratio was 100%.

### Synthesis of Epoxy-Modified Polyimide

The above-synthesized 33 g-thermoplastic polyimide was dissolved in 63 g of dioxolane, and 0.85 g (6 milli mole) of glycidyl methacrylate was added after adding 0.1 g of triethylamine and 50 mg of methoxyphenol. Stirring was conducted by heating at 70° C. for 10 hours and 3.0 g (8 milli mole) of Epoxy 828 manufactured by Shell International Chemicals Corporation to be stirred by heating for 5 hours to synthesize an epoxy-modified polyimide.

0.5 g of 4,4-diaminodiphenyl sulfone (hereinafter referred to as DDS), 0.5 g (1.2 milli mole) of bis(2,4,6-trimethyl-benzoil)-phenylphosphine oxide to be used as a photoreaction initiator, and 25 g of Aronix M-208(Bisphenol F EO-modified (n≠2) diacrylate) manufactured by Toa Gosei Co., Ltd. were added to the above-mentioned 100 g of epoxy-modified polyimide solution to be applied onto a PET film with a thickness of 25 μm. A double-layer photosensitive polyimide film with a thickness of 60 μm/25 μm was obtained by drying at 45° C. for 5 minutes and peeling off the PET film, fixing into a pin frame, and drying at 65° C. for 5 minutes.

A copper foil, a photosensitive polyimide film with a thickness of 60 μm, and a PET film with a thickness of 25 μm were overlaid in order to be laminated by heating at 100° C. under the pressure of 10,000 Pa·m. After the lamination, this laminate was exposed to light for 300 mJ/cm² (Exposure conditions: light at 400 nm) and post-baked at 100° C. for 3 minutes after the peeling off of the PET film to be cured by heating at 180° C. for 2 hours.

The peel adhesion strength of this flexible copper-clad plate was 9,800 Pa·m, which enabled to form patterns with line/space of 100 μm. In addition, no defects such as swelling were found even after this flexible plate was soaked in a solder bath at 260° C. for 1 minute. The elastic coefficient of the residual cover lay film after curing obtained by removing the copper foil of the flexible copper-clad plate by etching was 1,000 Pa, the elongation was 25%, and the thermal decomposition starting temperature was 370° C.

A copper foil, a photosensitive polyimide film with a thickness of 60 μm, and a PET film with a thickness of 25 μm were overlaid in order to be laminated by heating at 100° C. under the pressure of 10,000 Pa·m. After laminating, photo-masks of line/space=100/100 μm were placed on this laminate to be exposed to light for 300 mJ/cm² (Exposure conditions: parallel light at 400 nm) and post-baked at 100° C. for 3 minutes after peeling off of the PET film and then developed with a solution (at liquid temperature of 40° C.) of isopropyl alcohol/water at the weight ratio of 50/50 of 0.5% tetramethyl ammonium hydroxide to be cured by heating at 180° C. for 2 hours. Patterns of line/space=100/100 μm were drawn when observing the patterns on this photosensitive cover lay film using a microscope.

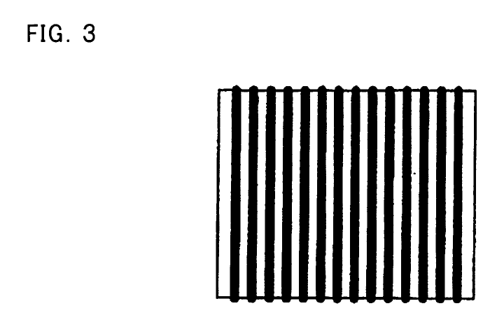

Next, the warp of the cover lay film of the present invention used as a cover lay for a flexible printed circuit board was measured. The adhesive surface of a film-like adhesive Piralux (LF100) manufactured by Dupont Co., Ltd. was overlaid onto a polyimide film Apical NPI (with a thickness of 25 μm) manufactured by Kaneka Corporation to be laminated by heating at 180° C. Peeling off a releasing paper, laminating was conducted with electrolytic copper foil 3EC-VLP (1 once) at 180° C. and cured at 180° C. to obtain a three-layer structure consisting of a base film (polyimide)/an adhesive/a copper foil. A flexible printed circuit board (FIG. 3) entirely having a line of line/space=200 μm/200 μm was prepared by etching. The above-mentioned two-layer film consisting of a photosensitive polyimide with a thickness of 60 μm and a PET film with a thickness of 25 μm was laminated to a copper foil on its photosensitive polyimide layer by heating at 100° C. to be exposed to light for 300 mJ/cm² (Exposure Conditions: parallel light at 400 nm) and cured by heating at 180° C. for 2 hours after peeling off of the PET film to prepare a flexible printed board (FPC) with a cover lay disposed. This FPC was cut into the size of 10 cm square and no warp was found.

### Example 7

33 g of thermoplastic polyimide containing carboxylic acid synthesized in Example 6, 66 g of dioxolane, 0.5 g of 4,4′-diaminodiphenyl sulfone (hereinafter abbreviated as DDS), 0.5 g (1.2 milli mole) of bis(2,4,6-trimethyl-benzoil)-phenylphosphine oxide, and 25 g of Aronix M-208 produced by Toagosei Co., Ltd. (Bisphenol F EO-modified (n≠2) diacrylate) were added to be applied onto a PET film with a thickness of 25 μm. A double-layer film consisting of a photosensitive polyimide film with a thickness of 60 μm and a PET film with a thickness of 25 μm was obtained by drying at 45° C. for 5 minutes, peeling off the PET film, fixed to a pin frame by drying at 65° C. for 5 minutes.

As well as Example 6, the adhesion strength of this flexible copper-clad plate was 1,080 Pa·m, which enabled to form patterns with line/space of 100 μm. In addition, no defects such as swelling were found even after this flexible plate was soaked into a solder bath at 260° C. for 1 minute. The elastic coefficient of the residual photosensitive polyimide after curing obtained by removing the copper foil of the flexible copper-clad plate through etching was 1,500 MPa, the elongation was 20%, and the thermal decomposition starting temperature was 375° C.

No warp was found when measuring the warp of the photosensitive cover lay of the present invention used as a cover lay for the flexible printed circuit board.

### Example 8

### Synthesis of Polyimide Having Hydroxy Group

12.91 g (0.03 mole) of BAPS-M, 260 g of DMF, and 57.65 g (0.1 mole) of ESDA were placed in a 2,000 ml-separable flask equipped with a stirrer to be vigorously stirred and the stirring was continued for 30 minutes. 14.65 g (0.04 mole) of 2,2′-bis(3-amino-4-hyroxyphenyl)hexafuluoropane was added to be stirred for 30 minutes and then 24.9 g (0.03 mole) of KF8010 manufactured by Shin-Etsu Chemicals Co., Ltd. and a polyamic acid solution was obtained by stirring for 30 minutes. The Mw of the polyamic acid was 55,000. And then cooling was achieved with iced water to afford reaction. This polyamic acid solution was placed in a butt coated with Teflon and successively heated with a vacuum oven at 150° C. for 10 minutes, 160° C. for 10 minutes, 170° C. for 10 minutes, 180° C. for 10 minutes, 190° C. for 10 minutes, and 210° C. for 30 minutes under reduced pressure of 660 Pa. The polyimide was taken out of the vacuum oven and 105 g of thermoplastic polyimide having hydroxy group was obtained. The Mw of the polyimide was 60,000 and the imidization ratio was 100%.

### Synthesis of Epoxy-Modified Polyimide

33 g of polyimide with hydroxy group synthesized in the above-mentioned was dissolved in 66 g of dioxolane, and 0.1 g of triethylamine and 1.42 g (10 milli mole) of glycidyl methacrylate were added to this solution to be dissolved in 25 g of dioxolane, and stirring was conducted by heating at 60° C. for 5 hours. Further, 24.08 g (epoxy equivalent amount: 136) of HP 403 manufactured by Shell International Chemicals Corporation was added to this solution and the reaction was achieved by heating at 60° C. for 5 hours to synthesize an epoxy-modified polyimide.

0.5 g of DDS, 0.3 g of 3,3′-carbonyl bis[7-(dimethylamino)cumarine, 1 g of benzophenone, 0.5 g of tributylamine, 25 g of Aronix M-208 (Bisphenol F EO-modified (n≠2) diacrylate) manufactured by Toa Gosei Co., Ltd., 3 g of isocyanic acid tri(ethaneacrylate) were added to the above-mentioned 100 g of polyimide solution to prepare a photosensitive resin composition. A double-layer consisting of a photosensitive polyimide film with a thickness of 60 μm and a PET film with a thickness of 25 μm was obtained by applying this solution onto the PET film with a thickness of 25 μm and drying at 45° C. for 5 minutes and peeling off the PET film, fixing into a pin frame, and drying at 65° C. for 5 minutes. As well as Example 6, the adhesion strength of this flexible copper-clad plate was 1,000 Pa·m, which enabled to form patterns with line/space of 100 μm. In addition, no defects such as swelling were found even after this flexible plate was soaked into a solder bath at 260° C. for 1 minute. The elastic coefficient of the residual photosensitive polyimide after curing obtained by removing the copper foil of the flexible copper-clad plate through etching was 1,250 MPa, the elongation was 25%, and the thermal decomposition starting temperature was 380° C.

No warp was found when measuring the warp of the photosensitive cover lay of the present invention used as a cover lay for the flexible printed circuit board in the same manner as in Example 6.

### Comparative Example 2

43.05 g (0.1 mole) of BAPS-M, 200 g of DMF, and 57.65 g (0.10 mole) of ESDA were placed in a 2,000 ml-separable flask equipped with a stirrer to be vigorously stirred and the stirring was continued for 30 minutes to obtain a polyamic acid solution. The Mw of the polyamic acid was 62,000.

This polyamic acid solution was placed in a butt coated with Teflon and successively heated with a vacuum oven at 150° C. for 10 minutes, 160° C. for 10 minutes, 170° C. for 10 minutes, 180° C. for 10 minutes, 190° C. for 10 minutes, and 210° C. for 30 minutes under reduced pressure of 660 Pa. The polyimide was taken out of the vacuum oven and 95 g of soluble polyimide was obtained. The Mw of the polyimide was 64,000 and the imidization ratio was 100%.

The above-mentioned 30-g soluble polyimide and 3 g of Epoxy 828 manufactured by Shell International Chemicals Corporation were dissolved in 67 g of dioxolane to be applied onto a PET film with a thickness of 25 μm. A soluble polyimide film with a thickness of 60 μm was obtained by drying at 45° C. for 5 minutes and peeling off the PET film, fixing into a pin frame, and then drying at 65° C. for 5 minutes, peeling off the PET film, and further drying by heating at 100° C. for 5 minutes. The elastic coefficient of this film was 3,200 MPa.

The soluble polyimide film with a thickness of 60 μm and the FPC, where the line having line/space of 200 μm/200 μm prepared in Example 6 was drawn on its one side, were laminated to be sandwiched by Teflon sheets on the top and bottom as releasing paper, pressing by heating at 250° C. under the pressure of 3 MPa to obtain an FPC with cover lay on its surface. The FPC was cut into the size of 10 an square in the same manner as in Example 6, and the FPC was found to be in a tube shape with a diameter of 10 an when its warp was measured.

### Example 9

57.7 g (0.10 mole) of ESDA and 100 g of DMF were placed in a 2,000 ml-separable flask equipped with a stirrer to be dissolved by stirring and then 31.5 g (0.035 mole) of siloxane diamine KF-8010 (manufactured by Shin-Etsu Silicone Co., Ltd.) was added together with 10 g of DMF to be stirred for 30 minutes. Subsequently, 3.80 g (0.025 mole) of diamino benzoic acid was dissolved in 10 g of DMF to be stirred for 30 minutes. And 17.22 g (0.040 mole) of BAPS-M was added by vigorously stirring while cooling the reaction container with iced water to obtain a polyamic acid solution by adding 24 g of DMF and continuing the stirring for 1 hour. The weight-average molecular weight (hereinafter referred to as Mw) of this polyamic acid was 62,000.

This polyamic acid solution was placed in a butt coated with Teflon and successively heated with a vacuum oven at 200° C. for 2 hours under reduced pressure of 660 Pa. The polyimide was taken out of the vacuum oven and 85 g of thermoplastic polyimide was obtained. The Mw of the polyimide was 68,000, the Tg was 54° C., and the imidization ratio was 100%.

### Synthesis of Epoxy-Modified Polyimide

44.1 g of soluble polyimide was dissolved in 110 g of dioxolane, and 0.10 g of 4-methoxyphenol (hereinafter abbreviated as MEHQ) was added to be dissolved by stirring at 60° C. After the dissolution, 4.50 g of Epoxy 828 resin (manufactured by Shell International chemicals Corporation) was dissolved in 13 g of oxolan and 0.05 g of triethylamine was added to this solution and the stirring was conducted by heating at 60° C. for 8 hours. A varnish of expoxy-modified polyimide with Sc=30% was obtained in this manner.

### Preparation of Cover Lay Film

To this 16.7 g of varnish, 0.5 g of isocyanic acid EO-modified triacrylate (A-9300 manufactured by Shin-Nakamura Chemical Co., Ltd.), 4.5 g of Bisphenol F EO-modified (n≠2) diacrylate (Aronix M-208 manufactured by Toa Gosei Co., Ltd.), 0.1 g of Irugacure 819 manufactured by Ciba Specialty Chemicals as a photoreaction initiator, 0.1 g of 4,4′-diaminodiphenylmethane (hereinafter referred to as DDM), and 0.01 g of MEHQ were added and defoamed. This solution was applied onto a PET film and dried at 45° C. for 5 minutes and 65° C. for 5 minutes to obtain a photosensitive polyimide cover lay film with a thickness of 50 μm.

A copper foil, a polyimide film (cover lay film), and a PET film (releasing paper) were overlaid in order to be laminated by heating at 80° C. under the pressure of 9,200 Pa·m. After the lamination, photo-mask patterns were placed on this laminate to be exposed to light for 300 mJ/cm² (Exposure conditions: parallel light at 400 nm) and post-baked at 100° C. for 2 minutes after the peeling off of the PET film to be cured by heating at 100° C. for 2 hours, 120° C. for 2 hours, 140° C. for 2 hours, and 180° C. for 2 hours after having been developed for 5 minutes with an isopropanol solution (at liquid temperature of 45° C.) of 1% tetramethyl ammonium hydroxide (hereinafter referred to as TMAH).

The adhesion strength of this flexible copper-clad plate to the dull surface of the copper foil was 1,300 Pa·m, which enabled to form patterns with a straight line having line/space of 100/100 μm and a hole of 100 μm×100 μm.

Both of the samples obtained by laminating a cover lay film and a copper foil, the cover lay film and other polyimide film (elastic coefficient: 4,000 MPa, thickness: 25 μm) and exposing to light and thermal curing were flat without any warps and curls.

No deterioration such as foaming and delamination was found even after the samples in which a laminate of the copper foil and the cover lay film were soaked into a solder at 300° C. for 3 minutes.

A laminate of the copper foil and the cover lay film was obtained by heating at 180° C. for 2 hours to be cured and removing the copper foil of the samples by etching. The temperature at the time of losing 5% in weight of the photosensitive polyimide film after curing was 363° C. Regarding mechanical properties, the elastic coefficient was 1,600 MPa, the elongation was 34.0%, and the tensile strength was 22 MPa.

### Example 10

57.6 g (0.10 mole) of ESDA and 200 g of DMF were placed in a 2,000 ml-separable flask equipped with a stirrer to be dissolved by stirring and then 25.0 g (0.030 mole) of siloxane diamine KF-8010 (manufactured by Shin-Etsu Silicone Co., Ltd.) was added together with 10 g of DMF to be stirred for 30 minutes. Subsequently, 5.33 g (0.035 mole) of diamino benzoic acid was dissolved in 10 g of DMF to be stirred for 30 minutes. And 15.1 g (0.35 mole) of BAPS-M was added by vigorously stirring while cooling the reaction container with iced water to obtain a polyamic acid solution by continuing the stirring for 1 hour. The Mw of this polyamic acid was 58,000. This polyamic acid solution was placed in a butt coated with Teflon and successively heated with a vacuum oven at 200° C. for 2 hours under reduced pressure of 660 Pa.

The polyimide was taken out of the vacuum oven and 94 g of thermoplastic polyimide having carboxy group was obtained. The Mw of the polyimide was 65,000, the Tg was 60° C., and the imidization ratio was 100%.

### Synthesis of Epoxy-Modified Polyimide

84.0 g (0.08 mole) of synthesized polyimide was dissolved in 200 g of dioxolane, and 0.1 g of MEHQ was added to be dissolved by heating at 50° C. to 60° C. 1.42 g (0.01 mole) of glycidyl metacrylate was added to this solution to be dissolved in 4 g of dioxolane and the stirring was conducted by heating at 60° C. for 2 hours. 3.80 g (0.01 mole) of Epoxy 828 resin (manufactured by Shell International chemicals Corporation) was dissolved in 15 g of dioxolane to be added to this solution and the stirring was conducted by heating at 60° C. for 6 hours. An epoxy-modified polyimide with Sc=30% was synthesized in this manner.

### Preparation of Cover Lay Film

4.0 g of di-functional acryl M-208, 0.1 g of Irugacure 819, 0.1 g of DDM, and 0.01 g of MEHQ were added and mixed in this 19.8 g of epoxy-modified polyimide solution (varnish) and defoamed. This solution was applied onto a PET film and dried at 45° C. for 5 minutes and 65° C. for 5 minutes to obtain a photosensitive polyimide film with a thickness of about 50 μm.

A copper foil, a polyimide film, and a PET film (releasing paper) were overlaid in order to be laminated by heating at 100° C. under the pressure of 9,200 Pa·m. After the lamination, photo-mask patterns were placed on this laminate to be exposed to light for 300 mJ/cm² (Exposure conditions: parallel light at 400 nm) and post-baked at 100° C. for 3 minutes to be cured by heating at 100° C. for 2 hours, 120° C. for 2 hours, 140° C. for 2 hours, and 180° C. for 2 hours after having been developed for 5 minutes with an isopropanol solution (at liquid temperature of 40° C.) of 1% tetramethyl ammonium hydroxide.

The adhesion strength of this flexible copper-clad plate to the dull surface of the copper foil was 1,100 Pa·m, which enabled to form patterns with a straight line having line/space of 100/100 μm and a hole of 100 μm×100 μm.

Both of the samples obtained by laminating a cover lay film and a copper foil, the cover lay film and other polyimide film (elastic coefficient: 4,000 MPa, thickness: 25 μm) and exposing to light and thermal curing were flat without any warps and curls.

No deterioration such as foaming and delamination was found even after the samples obtained by curing a laminate of the copper foil and the cover lay film were soaked into a solder at 300° C. for 3 minutes.

A laminate of the copper foil and the cover lay film was obtained by heating at 180° C. for 2 hours to be cured and removing the copper foil of the samples by etching. The temperature at the time of losing 5% in weight of the photosensitive polyimide film after curing was 356° C. Regarding mechanical properties, the elastic coefficient was 900 MPa, the elongation was 25.6%, and the tensile strength was 21 MPa.

### Example 11

0.3 g of A-9300, 4.7 g of M-208, 0.1 g of Irugacure 819, 0.1 g of DDM, and 0.01 g of MEHQ were added and mixed in 16.7 g of epoxy-modified polyimide solution synthesized in Example 9 and defoamed. This solution was applied onto a PET film and dried at 45° C. for 5 minutes and 65° C. for 5 minutes to obtain a photosensitive polyimide film with a thickness of about 50 μm.

A copper foil, a polyimide film, and a PET film were overlaid in order to be laminated by heating at 120° C. under the pressure of 9,200 Pa·m. After the lamination, this laminate was exposed to light for 300 mJ/cm² (Exposure conditions: parallel light at 400 nm) and post-baked at 100° C. for 3 minutes to be cured by heating at 100° C for 2 hours, 120° C. for 2 hours, 140° C. for 2 hours, and 180° C. for 2 hours after having been developed with an isopropanol solution (at liquid temperature of 40° C.) of 1% tetramethyl ammonium hydroxide.

The adhesion strength of this flexible copper-clad plate to the dull surface of the copper foil was 1,000 Pa·m, which enabled to form patterns with a straight line having line/space of 70/70 μm and a hole of 70 μm×70 μm.

Both of the samples obtained by laminating a cover lay film and a copper foil, the cover lay film and other polyimide film (elastic coefficient: 4,000 MPa, thickness: 25 μm) and exposing to light and thermal curing were flat without any warps and curls.

No deterioration such as foaming and delamination was found even after the samples obtained by curing a laminate of the copper foil and the cover lay film were soaked into a solder at 300° C. for 3 minutes.

A laminate of the copper foil and the cover lay film was obtained by heating at 180° C. for 2 hours to be cured and removing the copper foil of the samples by etching. The elastic coefficient of the photosensitive polyimide film after curing was 630 MPa, and the elongation was 32.0%, and the tensile strength was 12 MPa, and the temperature at the time of losing 5% in weight of the photosensitive polyimide film after curing was 370° C.

### Example 12

0.3 g of A-9300, 3.7 g of M-208, 0.1 g of Irugacure 819, 0.1 g of DDM, and 0.01 g of MEHQ were added and mixed in 16.7 g of epoxy-modified polyimide solution synthesized in Example 9 and defoamed. This solution was applied onto a PET film and dried at 45° C. for 5 minutes and 65° C. for 5 minutes to obtain a photosensitive polyimide film with a thickness of about 50 μm.

A copper foil, a polyimide film, and a PET film were overlaid in order to be laminated by heating at 120° C. under the pressure of 9,200 Pa·m. After the lamination, this laminate was exposed to light for 300 mJ/cm² (Exposure conditions: parallel light at 400 nm) and post-baked at 100° C. for 3 minutes to be cured by heating at 100° C. for 2 hours, 120° C. for 2 hours, 140° C. for 2 hours, and 180° C. for 2 hours after having been developed for 5 minutes with an isopropanol solution (at liquid temperature of 40° C.) of 1% tetramethyl ammonium hydroxide.

The adhesion strength of this flexible copper-clad plate to the dull surface of the copper foil was 1,000 Pa·m, which enabled to form patterns with a straight line having line/space of 50/50 μm and a hole of 50 μm×50 μm.

Both of the samples obtained by laminating a cover lay film and a copper foil, the cover lay film and other polyimide film (elastic coefficient: 4,000 MPa, thickness: 25 μm) and exposing to light and thermal curing were flat without any warps and curls.

No deterioration such as foaming and delamination was found even after the samples obtained by curing a laminate of the copper foil and the cover lay film were soaked into a solder at 300° C. for 3 minutes.

A laminate of the copper foil and the cover lay film was obtained by heating at 180° C. for 2 hours to be cured and removing the copper foil of the samples by etching. The elastic coefficient of the photosensitive polyimide film after curing was 630 MPa, and the elongation was 32.0%, and the tensile strength was 12 MPa, and the temperature at the time of losing 5% in weight of the photosensitive polyimide film after curing was 370° C.

### Example 13

26.4 g of soluble polyimide synthesized in Example 9 was dissolved in 60 g of dioxolane, and 0.5 g of MEHQ was added to be dissolved by heating at 60° C. with an oil bath. 1.75 g (0.07 mole) of Epoxy HP-4032 (manufactured by Dai-Nippon Ink Ltd.) was added to this solution to be dissolved in 6 g of dioxolane and 0.03 g of triethylamine was added and the stirring was conducted by heating at 60° C. for 6 hours. An epoxy-modified polyimide with Sc=28% was synthesized in this manner.

5.0 g of M-208, 0.1 g of Irugacure 819, 0.1 g of DDM, and 0.01 g of MEHQ were added in this 17.9 g of epoxy-modified polyimide solution (varnish) and mixed, and defoamed. This solution was applied onto a PET film and dried at 45° C. for 5 minutes and 65° C. for 5 minutes to obtain a photosensitive polyimide film with a thickness of about 50 μm.

A copper foil, a polyimide film, and a PET film were overlaid in order to be laminated by heating at 60° C. under the pressure of 9,200 Pa·m. After the lamination, photo-mask patterns were placed on this laminate to be exposed to light for 300 mJ/cm² (Exposure conditions: irradiated parallel light at 400 nm) and post-baked at 100° C. for 3 minutes to be cured by heating at 100° C. for 2 hours, 120° C. for 2hours, 140° C. for 2 hours, and 180° C. for 2 hours after having been developed for 10 minutes with an isopropanol solution (at liquid temperature of 40° C.) of 0.5% tetramethyl ammonium hydroxide.

The adhesion strength of this flexible copper-clad plate to the dull surface of the copper foil was 1,000 Pa·m, which enabled to form patterns with a straight line having line/space of 100/100 μm and a hole of 100 μm×100 μm.

Both of the samples obtained by laminating a cover lay film and a copper foil, the cover lay film and other polyimide film (elastic coefficient: 4,000 MPa, thickness: 25 μm) and exposing to light and thermal curing were flat without any warps and curls.

No deterioration such as foaming and delamination was found even after the samples obtained by curing a laminate of the copper foil and the cover lay film were soaked into a solder at 300° C. for 3 minutes.

A laminate of the copper foil and the cover lay film was obtained by heating at 180° C. for 2 hours to be cured and removing the copper foil of the samples by etching. The elastic coefficient of the photosensitive polyimide film after curing was 520 MPa, the elongation was 15.0%, and the tensile strength was 6.0 MPa.

### Example 14

23.1 g (0.04 mole) of ESDA and 50 g of DMF were placed in a 2,000 ml-separable flask equipped with a stirrer to be dissolved by stirring and then 16.6 g (0.020 mole) of siloxane diamine KF-8010 (manufactured by Shin-Etsu Silicone Co., Ltd.) was added together with 5 g of DMF to be stirred for 30 minutes. Subsequently, 1.52 g (0.010 mole) of diamino benzoic acid was dissolved in 10 g of DMF to be stirred for 30 minutes. And 8.61 g (0.020 mole) of BAPS-M was added by vigorously stirring while cooling the reaction container with iced water and 10 g of DMF was added to be stirred for 30 minutes. 3.84 g (0.020 mole) of trimellitic anhydride was finally added to be dissolved in 5 g of DMF and the stirring was continued for 1 hour to obtain a polyamic acid solution. The Mw of this polyamic acid was 5,500.

This polyamic acid solution was placed in a butt coated with Teflon and successively heated with a vacuum oven at 200° C. for 1 hour under reduced pressure of 660 Pa. The polyimide was taken out of the vacuum oven and 45 g of thermoplastic polyimide was obtained. The Mw of the polyimide was 6,000, the Tg was 80° C., and the imidization ratio was 100%.

### Synthesis of Epoxy-Modified Polyimide

36 g of synthesized soluble polyimide was dissolved in 36 g of dioxolane, and 0.1 g of MEHQ was added to be dissolved by heating at 60° C. with an oil bath. 7.6 g of Epoxy 828 resin manufactured by Shell International chemicals Corporation was dissolved in 8 g of dioxolane to be added to this solution and the stirring was conducted by heating at 60° C. for 8 hours. An epoxy-modified polyimide with Sc=50% was synthesized in this manner.

2.0 g of di-functional acryl M-208, 0.1 g of Irugacure 819, 0.1 g of DDM, and 0.01 g of MEHQ were added and mixed in this 12.0 g of epoxy-modified polyimide solution to be defoamed. This solution was applied onto a PET film and dried at 45° C. for 5 minutes, 65° C. for 5 minutes, and 80° C. for 5 minutes to obtain a photosensitive polyimide film with a thickness of about 50 μm.

A copper foil, a polyimide film, and a PET film were overlaid in order to be laminated by heating at 100° C. under the pressure of 9,200 Pa·m. After the lamination, this laminate was exposed to light for 300 mJ/cm² (Exposure conditions: irradiated parallel light at 400 nm) and post-baked at 100° C. for 3 minutes to be cured by heating at 100° C. for 2 hours, 120° C. for 2 hours, 140° C. for 2 hours, and 160° C. for 3 hours after having been developed for 5 minutes with an isopropanol solution (at liquid temperature of 40° C.) of 1% tetramethyl ammonium hydroxide.

The adhesion strength of this flexible copper-clad plate to the dull surface of the copper foil was 1,000 Pa·m, which enabled to form patterns with a straight line having line/space of 100/100 μm and a hole of 100 μm×100 μm.

Both of the samples obtained by laminating a cover lay film and a copper foil, the cover lay film and other polyimide film (elastic coefficient: 4,000 MPa, thickness: 25 μm) and exposing to light and thermal curing were flat without any warps and curls.

No deterioration such as foaming and delamination was found even after the samples obtained by curing a laminate of the copper foil and the cover lay film were soaked into a solder at 300° C. for 3 minutes.

The elastic coefficient of the residual photosensitive polyimide film after curing obtained by etching was 1,120 MPa, the elongation was 3.5%, and the tensile strength was 20 MPa.

### Comparative Example 3

68.88 g (0.16 mole) of BAPS-M and 320 g of DMF were placed in a 2,000 ml-separable flask equipped with a stirrer and 138.4 g (0.24 mole) of ESDA was added while vigorously stirring and the stirring was continued for 30 minutes. Then the reaction was achieved by cooling with iced water. Subsequently, 12.18 g (0.08 mole) of diamino benzoic acid was dissolved in 120 g of DMF to be stirred for 30 minutes to obtain a polyamic acid solution. This polyamic acid solution was placed in a butt coated with Teflon and successively heated with a vacuum oven at 200° C. for 2 hours under reduced pressure of 660 Pa to obtain 98 g of thermoplastic polyimide having carboxy group. The Mw of the polyimide was 65,000, the Tg was 190° C., and the imidization ratio was 100%.

48.4 g (56 milli mole) of synthesized soluble polyimide was dissolved in 110 g of dioxolane, and 0.1 g of MEHQ was added to be dissolved by heating at 50° C. to 60° C. with an oil bath. 1.42 g (10 milli mole) of glycidyl methacrylate was added to be dissolved in 5 g of dioxolane to this solution and the stirring was conducted by heating at 60° C. for 1 hour. Additionally, 3.80 g of Epoxy 828 resin manufactured by Shell International chemicals Corporation was dissolved in 14 g of dioxolane to be added to this solution and the stirring was conducted by heating at 60° C. for 1 hour to synthesize an epoxy-modified polyimide.

A cover lay was prepared using this polyimide varnish under the same conditions as in Example 14, and a copper foil, a polyimide film, and a PET film (releasing paper) were overlaid in order to be laminated by heating at 120° C. under the pressure of 9,200 Pa·m. After the lamination, photo-mask patterns were placed on this laminate to be exposed to light for 300 mJ/cm² (Exposure conditions: irradiated parallel light at 400 nm) and post-baked at 100° C. for 3 minutes to be cured by heating at 100° C. for 2 hours, 120° C. for 2 hours, 140° C. for 2 hours, and 160° C. for 3 hours after having been developed with an isopropanol solution (at liquid temperature of 40° C.) of 1% tetramethyl ammonium hydroxide.

In the patterns after developing, it was possible to draw a straight line with line width/space width of 200 μm/200 μm, but it was impossible to form finer patterns.

Further, the samples obtained by laminating a cover lay film and a copper foil and exposing to light and thermal curing had curls on the polyimide side due to shrinkage of polyimide. The adhesion strength of this flexible copper-clad plate to the dull surface of the copper foil was 100 Pa·m, which was weak.

A laminate of the copper foil and the cover lay film was obtained by heating at 180° C. for 2 hours to be cured and removing the copper foil of the samples by etching. The elastic coefficient of the photosensitive polyimide film after curing was 5,000 MPa, the elongation was 2.0%, and the tensile strength was 16 MPa. The Tg of the polyimide after curing was 290° C. and the thermal expansion coefficient was 200 ppm from room temperature to 100° C.

As mentioned above, the film prepared with polyimide in which siloxanediamine was not contained turned out to be inferior in mechanical strength. If this polyimide is laminated to other film because of high elastic coefficient after curing to be thermally cured, the samples will be curled due to difference in elastic coefficient between the base film and the cover film. This resulted in poor functions as FPC, such as easy peeling off of the fine copper circuit and short-circuit.

### Example 15

8.60 g (0.02 mole) of BAPS-M, 16.6 g (0.02 mole) of siloxanediamine (KF8010 manufactured by Shinetsu Chemical Co., Ltd.; x=3, y=10, R¹=CH₃ in siloxanediamine represented by the general formula (3)), and 200 g of DMF, and 57.65 g (0.10 mole) of ESDA were placed in a 2,000 ml-separable flask equipped with a stirrer to be vigorously stirred and the stirring was continued for 30 minutes. 17.2 g of bis(4-amino-3-carboxyphenyl)methane was dissolved in 75 g of DMF to be added to the above-mentioned solution and a polyamic acid solution was obtained by stirring for 30 minutes. The weight-average molecular weight (hereinafter referred to as Mw) of this polyamic acid was 60,000.

This polyamic acid solution was placed in a butt coated with Teflon and successively heated with a vacuum oven at 150° C. for 2 for 10 minutes, 160° C. for 10 minutes, 170° C. for 10 minutes, 180° C. for 10 minutes, 190° C. for 10 minutes, and 210° C. for 30 minutes under reduced pressure of 660 Pa. The polyimide was taken out of the vacuum oven and 96 g of soluble polyimide having carboxy group was obtained. The Mw of the polyinide was 62,000 and the imidization ratio was 100% (COOH equivalent amount: 804).

This soluble polyimide was dissolved in dioxolane to obtain a solution of 30 % by weight. 0.5 g (1.2 milli mole) of bis(2,4,6-trimethyl benzoil)-phenylphosphine oxide and 25 g of Bisphenol A EO-modified (n≈30) diacrylate (ABE-30 manufactured by Shin-Nakamura Chemical Co., Ltd.) as a photoreaction initiator, and 10 mg of methoxyphenol as a polymerization inhibitor were added to 100 g of the obtained 30 weight % soluble polyimide solution. The obtained solution was applied onto a PET film with a thickness of 25 μmm. A double-layer film consisting of a photosensitive polyimide film with a thickness of 38 μm and a PET film with a thickness of 25 μm was obtained by drying at 45° C. for 5 minutes and 65° C. for 5 minutes.

A copper foil, a photosensitive polyimide film (38 μm), and a PET film (25 μm) were overlaid in order on this double-layer film to be laminated by heating at 100° C. under the pressure of 10,000 Pa·m. After the lamination, the surface of the PET film side was exposed to light for 300 mJ/cm² (Exposure conditions: parallel light at 400 nm). This laminate was post-baked at 100° C. for 3 minutes after the peeling off of the PET film to be cured by heating at 180° C. for 2 hours.

The peeling adhesion strength of the obtained laminate consisting of a polyimide film and a copper foil (flexible copper-clad plate) was 1,180 Pa·m. No defects such as swelling were observed even after the samples were soaked into a solder bath at 260° C. for 1 minute.

The elastic coefficient of the residual cover lay film after curing obtained by removing the copper foil of the flexible copper-clad plate by etching was 1,000 MPa, the elongation was 25%, and the thermal decomposition starting temperature was 370° C.

In addition to that, a copper foil was overlaid on the above-mentioned double-layer film consisting of a photosensitive polyimide film (38 μm) and a PET film (25 μm) to be laminated in order by heating at 100° C. under the pressure of 10,000 Pa·m. After the lamination, masks with line/space of 100/100 μm were placed and this laminate was exposed to light for 300 mJ/cm² from the PET film side (Exposure conditions: light at 400 nm). After peeling off the PET film, this laminate was post-baked at 100° C. for 3 minutes to be cured by heating at 180° C. for 2 hours after having been developed with a water solution (liquid temperature: 40° C. ) of 1% KOH. Patterns with line/space of 100/100 μm were found when observing using a microscope.

### Example 16

0.5 g (1.2 milli mole) of bis(2,4,6-trimethyl benzoil)-phenylphosphine oxide, 5 g of Bisphenol F EO-modified (n≠2) diacrylate (Aronix M-208 manufactured by Toagosei Co., Ltd.), 20 g of Bisphenol A EO-modified (n≠30) diacrylate (ABE-30 manufactured by Shin-Nakamura Chemical Co., Ltd.), and 10 mg of methoxyphenol as a polymerization inhibitor were added to 100 g of 30% by weight soluble polyimide solution obtained in Example 15. The obtained solution was applied onto a PET film with a thickness of 25 μm. A double-layer film consisting of a photosensitive polyimide film with a thickness of 38 μm and a PET film with a thickness of 25 μm was obtained by drying at 45° C. for 5 minutes and 65° C. for 5 minutes.

A copper foil was laminated onto this double-layer film in the same manner as in Example 15 to obtain a flexible copper-clad plate. The peeling adhesion strength of this flexible copper-clad laminate was 1,080 Pa·m. No defects such as swelling were observed even after the samples were soaked into a solder bath at 260° C. for 1 minute. The elastic coefficient of the residual cover lay film after curing obtained by removing the copper foil of the flexible copper-clad plate by etching was 1,500 MPa, the elongation was 20%, and the thermal decomposition starting temperature was 375° C.

In addition to that, a copper foil was overlaid on the above-mentioned double-layer film consisting of a photosensitive polyimide film (38 μm) and a PET film (25 μm) to be laminated in order by heating at 100° C. under the pressure of 10,000 Pa·m. After the lamination, masks with line/space of 100/100 μm were placed and this laminate was exposed to light for 300 mJ/cm² from the PET film side surface (Exposure conditions: light at 400 nm). After peeling off the PET film, this laminate was post-baked at 100° C. for 3 minutes to be cured by heating at 180° C. for 2 hours after having been developed with a water solution (liquid temperature: 40° C.) of 1% KOH. Patterns with line/space of 100/100 μm were found when observing using a microscope.

### Example 17

8.61 g (0.02 mole) of BAPS-M, 260 g of DMF, and 57.65 g (0.1 mole) of ESDA were placed in a 2,000 ml-separable flask equipped with a stirrer to be vigorously stirred and the stirring was continued for 30 minutes. 24.9 g (0.03 mole) of siloxane diamine (KF8010 manufactured by Shin-etsu Chemicals Co., Ltd.) was added to be stired for 30 minutes and then 9.81 g (0.05 mole) of 2,5-diamino terephthalic acid was added to be stirred while cooling with iced water to obtain a polyamic acid solution. The Mw of the polyamic acid was 53,000. This polyamic acid solution was placed in a butt coated with Teflon and successively heated with a vacuum oven at 150° C. for 10 minutes, 160° C. for 10 minutes, 170° C. for 10 minutes, 180° C. for 10 minutes, 190° C. for 10 minutes, and 210° C. for 30 minutes under reduced pressure of 660 Pa. The polyimide was taken out of the vacuum oven and a soluble polyimide having carboxy group was obtained. The Mw of the polyimide was 60,000 and the imidization ratio was 100% (COOH equivalent amount: 974).

This soluble polyimide was dissolved in dioxolane to obtain a solution of 30% by weight. 0.3 g of 4,4′-bis(diethylamino) benzophenone, 1.0 g of BTTB manufactured by Nihon Yushi Co., Ltd. (25% toluene solution), 20 g of Bisphenol A EO-modified (n≠30) diacrylate (ABE-30 manufactured by Shin-Nakamura Chemicals Co., Ltd.), 5 g of Bisphenol A EO-modified (n≠10) diacrylate (ABE-10 manufactured by Shin-Nakamura Chemicals Co., Ltd.), and 10 mg of methoxyphenol as a polymerization inhibitor were added to the obtained 100 g of soluble imide solution to obtain a photosensitive resin composition solution. A double-layer film consisting of a photosensitive polyimide film with a thickness of 38 μm and a PET film with a thickness of 25 μm was obtained by applying this solution onto the PET film with a thickness of 25 μm and drying at 45° C. for 5 minutes and 65° C. for 5 minutes.

A copper foil was laminated onto this double-layer film in the same manner as in Example 15 to obtain a flexible copper-clad plate. The adhesion strength of this flexible copper-clad plate was 1,000 Pa·m. In addition, no defects such as swelling were found even after this flexible copper-clad plate was soaked into a solder bath at 260° C. for 1 minute. The elastic coefficient of the residual cover lay film after curing obtained by removing the copper foil of the flexible copper-clad plate through etching was 1,250 MPa, the elongation was 25%, and the thermal decomposition starting temperature was 380° C.

In addition to that, a copper foil was overlaid on the above-mentioned double-layer film consisting of a photosensitive polyimide film (38 μm) and a PET film (25 μm) to be laminated in order by heating at 100° C. under the pressure of 10,000 Pa·m. After the lamination, masks with line/space of 100/100 μm were placed and this laminate was exposed to light for 300 mJ/cm² from the PET film side (Exposure conditions: light at 400 nm). After peeling off the PET film, this laminate was post-baked at 100° C. for 3 minutes to be cured by heating at 180° C. for 2 hours after having been developed with a water solution (liquid temperature: 40° C.) of 1% KOH. Patterns with line/space of 100/100 μm by curing were found when observing using a microscope.

### Example 18

Operation was performed in the same manner as in Example 15 except for the following material ratio of soluble polyimide. 17.20 g (0.04 mole) of BAPS-M, 24.9 g (0.03 mole) of siloxanediamine (KF8010 manufactured by Shinetsu Chemicals Co., Ltd.; siloxanediamine represented by the formula (3); x=3, y=10, R¹=CH₃), 57.65 g (0.10 mole) of EDSA, and 8.6 g (0.03 mole) of bis(4-amino-3-carboxy-phenyl)methane. The molecular weight of the obtained amido acid was 59,000. Imidization was performed in the same manner as in Example 1 to obtain 104 g of soluble polyimide (COOH equivalent amount: 1746)

A double-layer film consisting of a photosensitive polyimide and a PET film was prepared in the same manner as in Example 15 and then a copper foil was laminated onto this double-layer film in the same manner as in Example 15 to obtain a flexible copper-clad plate. The peeling adhesion strength of this flexible copper-clad plate was 1,200 Pa·m and no defects such as swelling were found even after this flexible copper-clad plate was soaked in a solder bath at 260° C. for 1 minute. The elastic coefficient of the residual cover lay film after curing obtained by removing the copper foil of the flexible copper-clad plate through etching was 1,000 MPa, the elongation was 25%, and the thermal decomposition starting temperature was 370° C.

In addition to that, a copper foil was overlaid on the above-mentioned double-layer film consisting of a photosensitive polyimide film (38 μm) and a PET film (25 μm) to be laminated in order by heating at 100° C. under the pressure of 10,000 Pa·m. After the lamination, masks with line/space of 100/100 μm were placed and this laminate was exposed to light for 300 mJ/cm² from the PET film side surface (Exposure conditions: light at 400 nm). After peeling off the PET film, this laminate was post-baked at 100° C. for 3 minutes to be cured by heating at 180° C. for 2 hours after having been developed with a water solution (liquid temperature: 40° C.) with weight ration of isopropyl alcohol and water=50/50 of 0.5% tetramethyl ammonium hydroxide. Patterns with line/space of 100/100 μm were found when observing with a microscope.

### Comparative Example 4

Operation was performed in the same manner as in Example 15 except for the following material ratio of soluble polyimide: 17.22 g (0.04 mole) of BAPS-M, 24.9 g (0.03 mole) of siloxanediamine (KF8010 manufactured by Shinetsu Chemicals Co., Ltd.; siloxanediamine represented by the general formula (3); x=3, y=10, R¹ =CH₃), 57.65 g (0.10 mole) of EDSA, and 4.56 g (0.03 mole) of 3,5-diamino benzoic acid. The molecular weight of the obtained amido acid was 59,000. Imidization was performed in the same manner as in Example 15 to obtain 99 g of soluble polyimide (COOH equivalent amount: 3358)

A double-layer film consisting of a photosensitive polyimide and a PET film was prepared in the same manner as in Example 15 and then a copper foil was laminated onto this double-layer film in the same manner as in Example 15 to obtain a flexible copper-clad plate. The peeling adhesion strength of this flexible copper-clad plate was 1,200 Pa·m and no defects such as swelling were found even after this flexible copper-clad plate was soaked in a solder bath at 260° C. for 1 minute. The elastic coefficient of the residual cover lay film after curing obtained by removing the copper foil of the flexible copper-clad plate through etching was 1,000 MPa, the elongation was 25%, and the thermal decomposition starting temperature was 370° C.

In addition to that, a copper foil was overlaid on the above-mentioned double-layer film consisting of a photosensitive polyimide film (38 μm) and a PET film (25 μm) to be laminated in order by heating at 100° C. under the pressure of 10,000 Pa·m. After the lamination, masks with line/space of 100/100 μm were placed and this laminate was exposed to light for 300 mJ/cm² from the PET film side (Exposure conditions: light at 400 nm). After peeling off the PET film, this laminate was post-baked at 100° C. for 3 minutes and the development with a water solution (liquid temperature: 40° C.) of 1% KOH was tried. No Patterns were, however, found because of unexposed parts were not dissolved.

### Example 19

Bis[4-(3-aminophenoxy)phenyl]sulfone (hereinafter referred to as BAPS-M), (2,2′-bis(4-hydroxyphenyl)propane diobenzoate)-3,3′,4,4′-tetracarboxylic anhydride (hereinafter referred to as EDSA), and diamino benzoic acid were used as materials of polyimide.

### Synthesis of Polyimide

68.8 g (0.16 mole) of BAPS-M, 320 g of DMF, and 138.4 g (0.24 mole) of ESDA were placed in a 2,000 ml-separable flask equipped with a stirrer to be vigorously stirred and the stirring was continued for 30 minutes. And then reaction was achieved by cooling with iced water. 12.18 g (0.08 mole) of diamino benzoic acid was dissolved in 120 g of DMF to be added and a polyamic acid solution was obtained by stirring for 30 minutes. This polyamic acid solution was placed in a butt coated with fluorocarbon resin and successively heated with a vacuum oven at 200° C. for 2 hours under reduced pressure of 660 Pa and 96 g of polyimide was obtained.

### Synthesis of −Modified Polyimide

48.4 g (56 milli mole) of polyimide synthesized as mentioned above was dissolved in 110 g of dioxolane, and 0.1 g of 4-methoxyphenol was added to be dissolved by heating with an oil bath at 50° C. to 60° C. 1.42 g (10 milli mole) of glycidyl metacrylate was added to this solution to be dissolved in 5 g of dioxolane and the stirring was conducted by heating at 60° C. for 6 hours. 3.80 g (0.01 mole) of Epoxy 828 resin manufactured by Shell International chemicals Corporation was dissolved in 14 g of dioxolane was added to this solution and the stirring was conducted by heating at 60° C. for 6 hours to synthesize an GMA−modified polyimide.

### Preparation of Photosensitive Film

A photosensitive resin composition was prepared by mixing the following components (a) to (d) to prepare a photosensitive film in B-stage status on a PET film using (2) method:

(a) modified polyimide synthesized by the above-mentioned method

65 parts by weight

(b) Isocyanuic acid EO-modified triacrylate (A-9300 manufactured by Shin-Nakamura Chemicals Co., Ltd.)

5 parts by weight

(c) Bisphenol F EO-modified (n=2) diacrylate (Aronix M-208 manufactured by Toa Gosei Co., Ltd.)

30 parts by weight

(d) Bis(2,4,6-trimethylbenzoyl)phenylphosphine oxide (Irgacure 819 manufactured by Ciba Specialty Chemicals K.K.)

1 part by weight

A three-layer structure sheet was prepared by laminating a protective film consisting of a laminate of a (PE+EVA) copolymer film and an OPE film using (3) method onto this photosensitive film surface with PET film.

The protective film releasability of this three-layer structure sheet was 3.3 Pa·m. The photosensitive film was tested in its developing properties under the exposure conditions: light with a wavelength of 400 nm at energy of 1,800 mJ/cm², a developer: a water solution of 1% potassium hydroxide. A hole of 200 μm×200 μm square and a fine hole of 100 μm×100 μm square were developed as a developer. In the soldering heat resistance test after moisture conditioning, no delamination of the film from the copper foil and swelling was found even after soaking into a melting solder at 300° C. for 1 minute. The folding endurance test was 1,800 cycles in continuity. Further, the insulation resistivity between ines was 5.0×10¹⁵Ω.

### Example 20

### Synthesis of Polyimide Resin

17.3 g (0.030 mole) of ESDA and 30 g of DMF were placed in a 500 ml-separable flask equipped with a stirrer to be dissolved by stirring. And 5.15 g (0.018 mole) of diamine MBAA manufactured by Wakayama Seika Kogyo, Ltd. was added to be dissolved in 9 g of DMF and stirring was vigorously conducted for 1 hour. 7.47 g (0.009 mole) of siloxanediamine KF-8010 manufactured by Shin-Etsu Silicone Co., Ltd. was added to be stirred for about 1 hour. The polyamide solution thus obtained was placed in a butt coated with fluorocarbon resin and successively heated with a vacuum oven at 200° C. for 2 hours under reduced pressure of 660 Pa and 26.40 g of soluble polyimide was obtained.

### Synthesis of Modified Polyimide

20.8 g (0.020 mole) of polyimide synthesized as mentioned above was dissolved in 80 g of dioxolane, and 0.030 g of 4-methoxyphenol was added to be dissolved by heating at 60° C. with an oil bath. 3.75 g (0.0264 mole) of glycidyl metacrylate was added to this solution to be dissolved in 5 g of dioxolane and 0.01 g od triethylamine was added as a catalyst to be stirred by heating at 60° C. for 6 hours. A modified polyimide was synthesized in this manner.

### Preparation of Photosensitive Film

A photosensitive resin composition was prepared by mixing the following components (e) to (g) and (d) to prepare a photosensitive dry film resist in B-stage status on a PET film using (2) method:

(e) Polyimide resin synthesized by the above-mentioned method

60 parts by weight

(f) Bisphenol A EO-modified (m+n≈30) diacrylate (NK Ester A-BPE-30 manufactured by Shin-Nakamura Chemicals Co., Ltd.)

20 parts by weight

(g) Bisphenole A EO-modified (m+n≈30) diacrylate (NK Ester A-BPE-10 manufactured by Shin-Nakamura Chemicals Co., Ltd.)

20 parts by weight

(d) Irgacure 819 manufactured by Ciba Specialty Chemicals K.K.

1 part by weight

A three-layer structure sheet was prepared by laminating a protect (No. 6221F) film (thickness: 50 μm) manufactured by Sekisui Chemical Co., Ltd. as a protective film onto this photosensitive dry film resist with PET film.

The protective film releasability of this three-layer structure sheet was 3.3 Pa·m. The photosensitive film was tested in its developing properties under the exposure conditions: light with a wavelength of 400 nm at energy of 1,800 mJ/cm² using a water solution of 1% potassium hydroxide as a developer. A hole of 200 μm×200 μm square and a fine hole of 100 μm×100 μm square were developed. In the soldering heat resistance test after moisture conditioning, no delamination of the film from the copper foil and swelling was found even after soaking into a melting solder at 300° C. for 1 minute.

Further, the folding endurance was 1,200 cycles in continuity. The insulation resistivity between lines was 7.0×10¹⁵Ω.

### Example 21

A photosensitive film was prepared using different photosensitive coloring matter in the preparation of a photosensitive film in Example 20.

A photosensitive resin composition was prepared by mixing the following components (e) to (i) to prepare a photosensitive dry film resist in B-stage status on a PET film using (2) method:

(e) Polyimide resin synthesized by the above-mentioned method

60 parts by weight

(f) Bisphenol A EO-modified (m+n≈30) diacrylate (NK Ester A-BPE-30 manufactured by Shin-Nakamura Chemicals Co., Ltd.)

20 parts by weight

(g) Bisphenol A EO-modified (m+n≈10) diacrylate (NK Ester A-BPE-10 manufactured by Shin-Nakamura Chemicals Co., Ltd.)

20 parts by weight

(h) 4,4′-bis (diethylamino)benzophenone (S-112 manufactured by Sinko Giken Ltd.)

1 part by weight

(i) 3,3′,4,4′-tetra(t-butyl peroxycarbonyl)benzophenone (BTTB-25 manufactured by Nippon Yushi Co., Ltd.)

1 part by weight

A three-layer structure sheet was prepared by laminating a protect (No. 6221F) film (thickness: 50 μm) manufactured by Sekisui Chemical Co., Ltd. as a protective film onto this photosensitive dry film resist with PET film.

The protective film releasability of this three-layer structure sheet was 3.5 Pa·m. The photosensitive film was tested in its developing properties under the exposure conditions: light with a wavelength of 400 nm at energy of 1,800 mJ/cm² using a water solution of 1% potassium hydroxide as a developer. A hole of 200 μm×200 μm square and a fine hole of 100 μm×100 μm square were developed. In the soldering heat resistance test after moisture conditioning, no delamination of the film from the copper foil and swelling was found even after soaking into a melting solder at 300° C. for 1 minute.

Further, the folding endurance test was 800 cycles in continuity. The insulation resistivity between lines was 1.6×10¹⁴Ω.

### Example 22

A photosensitive resin composition was prepared by mixing the following components to prepare a photosensitive film in B-stage status on a PET film using (2) method:

(e) Polyimide resin synthesized in Example 20

50 parts by weight

(c) Bisphenol F EO-modified (n=2) diacrylate (Aronix M-208 manufactured by Toa Gosei Co., Ltd.)

40 parts by weight

(f) Bisphenol A EO-modified (m+n≈30) diacrylate (NK Ester A-BPE-30 manufactured by Shin-Nakamura Chemicals Co., Ltd.)

10 parts by weight

(h) 4,4′-bis(diethylamino)benzophenone (S-112 manufactured by Sinko Giken Ltd.)

0.5 part by weight

(i) 3,3′,4,4′-tetra(t-butyl peroxycarbonyl)benzophenone (BTTB-25 manufactured by Nippon Yushi Co., Ltd.)

2 parts by weight

A three-layer structure sheet was prepared by laminating a protective film consisting of a laminate of a (PE+EVA) copolymer film and an OPE film onto this photosensitive dry film resist with PET film.

The protective film releasability of this three-layer structure sheet was 3.5 Pa·m. The photosensitive film was tested in its developing properties under the exposure conditions: light with a wavelength of 400 nm at energy of 600 mJ/cm² using a water solution of 1% potassium hydroxide as a developer. A hole of 200 μm×200 μm square and a fine hole of 100 μm×100 μm square were developed. In the soldering heat resistance test after moisture conditioning, no delamination of the film from the copper foil and swelling was found even after soaking into a melting solder at 300° C. for 1 minute.

Further, the folding endurance test was 750 cycles in continuity. The insulation resistivity between lines was 5.5×10¹³Ω.

### Example 23

A photosensitive resin composition was prepared by mixing the following components to prepare a photosensitive film in B-stage status on a PET film using (2) method:

(e) Polyimide resin synthesized in Example 20

50 parts by weight

(c) Bisphenol F EO-modified (n=2) diacrylate (Aronix M-208 manufactured by Toa Gosei Co., Ltd.)

20 parts by weight

(f) Bisphenol A EO-modified (m+n≈30) diacrylate (NK Ester A-BPE-30 manufactured by Shin-Nakamura Chemicals Co., Ltd.)

20 parts by weight

(g) Bisphenol A EO-modified (m+n≈10) diacrylate (NK Ester A-BPE-10 manufactured by Shin-Nakamura Chemicals Co., Ltd.)

20 parts by weight

(i) 3,3′,4,4′-tetra(t-butyl peroxycarbonyl)benzophenone (BTTB-25 manufactured by Nippon Yushi Co., Ltd.)

2 parts by weight

(j) 3,3′-carbonyl-bis[7-(diethylamino)cumarin](NKX-653)

1 part by weight

A three-layer structure sheet was prepared by laminating a protective film consisting of a laminate of a (PE+EVA) copolymer film and an OPE film prepared in (3) onto this photosensitive dry film resist with PET film.

The protective film releasability of this three-layer structure sheet was 3.5 Pa·m. The photosensitive film was tested in its developing properties under the exposure conditions: light with a wavelength of 400 nm at energy of 600 mJ/c2 using a water solution of 1% potassium hydroxide as a developer. A hole of 200 μm×200 μm square and a fine hole of 100 μm×100 μm square were developed. In the soldering heat resistance test after moisture conditioning, no delamination of the film from the copper foil and swelling was found even after soaking into a melting solder at 300° C. for 1 minute.

Further, the folding endurance was 750 cycles in continuity. The insulation resistivity between lines was 8.0×10¹³Ω.

### Comparative Example 5

A photosensitive resin composition was prepared by mixing the following components without imide to prepare a photosensitive film in B-stage status on a PET film using (2) method:

(c) Bisphenol F EO-modified (n=2) diacrylate (Aronix M-208 manufactured by Toa Gosei Co., Ltd.)

50 parts by weight

(f) Bisphenol A EO-modified (m+n≈30) diacrylate (NK Ester A-BPE-30 manufactured by Shin-Nakamura Chemicals Co., Ltd.)

50 parts by weight

(d) bis(2,4,6-trimethylbenzoyl)phenylphosphine oxide (Irgacure 819 manufactured by Ciba Specialty Chemicals K.K.)

1 part by weight

A three-layer structure sheet was prepared by using an OPE film (thickness: 30 μm) as a protective film on the surface of this photosensitive film with PET film. The protective film was not closely adhered to the photosensitive film and the releasability of the protective film was not greater than 1.6 Pa·m. Whether or not the protective film was peeled off, the protective film and the photosensitive film were easily slipped, so that they were not closely adhered to each other.

Thus, the protective film without surface of a (PE+EVA) copolymer film was poor in adhesion to the photosensitive film.

### Comparative Example 6

A three-layer structure sheet was prepared by laminating a protective film consisting of a laminate of a (PE+EVA) copolymer film and an OPE film prepared in (3) onto the surface of this photosensitive film with PET film prepared in Comparative Example 6.

The protective film releasability of this three-layer structure sheet was 4.0 Pa·m. The photosensitive film was tested in its developing properties under the exposure conditions: light with a wavelength of 400 nm at energy of 1,800 mJ/cm² using a water solution of 1% potassium hydroxide as a developer. A hole of 200 μm×200 μm square and a fine hole of 100 μm×100 μm square were developed. In the soldering heat resistance test after moisture conditioning, swelling of the film was found after soaking into a melting solder at 300° C. for 1 minute. The folding endurance test was only 35 cycles in continuity. The insulation resistivity between lines was 1.3×10¹²Ω.

Thus, when a photosensitive film is prepared using only acrylic resin instead of imide, there are no problems with the releasability of the protective film and developing properties, but the film becomes hard and brittle, which results in either poor in flexibility and electrical properties.

### Comparative Example 7

With the use of acrylic resin without aromatic ring, a photosensitive resin composition was prepared by mixing the following components to prepare a photosensitive film in B-stage status on a PET film using (2) method:

(e) Polyimide resin synthesized in Example 20

60 parts by weight

(k) Polyethyleneglycol diacrylate (n≈4) (Aronix M-240 manufactured by Toa Gosei Co., Ltd.)

40 parts by weight

(i) 3,3′,4,4′-tetra(t-butyl peroxycarbonyl)benzophenone (BTTB-25 manufactured by Nippon Yushi Co., Ltd.)

2 parts by weight

(j) 3,3′-carbonyl-bis[7-(diethylamino)cumarin](NKX-653 manufactured by Nippon Kanko Shikiso Research Center)

1 part by weight

A three-layer structure sheet was prepared by laminating (a protect (No.6221F) film (thickness: 50 μm) manufactured by Sekisui Chemical Co., Ltd. as a protective film onto the surface of this photosensitive film with PET film.

The protective film releasability of this three-layer structure sheet was 3.0 Pa·m. Either of the exposed part and unexposed part in the cover lay part were melted, which resulted in no fine holes when the photosensitive film was tested in its developing properties under the exposure conditions: light with a wavelength of 400 nm at energy of 600 mJ/cm²using a water solution of 1% potassium hydroxide as a developer. In the soldering heat resistance test after moisture conditioning, the film was peeled off from the copper foil after soaking into a melting solder at 300° C. for 1 minute. The folding endurance test was only 60 cycles in continuity. The insulation resistivity between lines was 2.7×10¹³Ω.

Thus, the photosensitive film is poor in developing properties and is deteriorated in soldering heat resistance and folding endurance when preparing a photosensitive film using only acrylic resin without aromatic ring.

### Comparative Example 8

A photosensitive resin composition containing polyimide was prepared by mixing the following components to prepare a photosensitive dry film resist in B-stage status on a PET film using (2) method:

(e) Polyimide resin synthesized by the above-mentioned method

60 parts by weight

(c) Bisphenol F EO-modified (n=2) diacrylate (Aronix M-208 manufactured by Toa Gosei Co., Ltd.)

20 parts by weight

(f) Bisphenol A EO-modified (m+n≈30) diacrylate (NK Ester A BPE-30 manufactured by Shin-Nakamura Chemicals Co., Ltd.)

20 parts by weight

(d) Irgacure 819 manufactured by Ciba Specialty Chemicals K.K.

1 part by weight

A three-layer structure sheet was prepared by using an OPE film (thickness: 30 μm) as a protective film on the surface of this photosensitive dry film resist with PET film. The protective film was not closely adhered to the photosensitive film and the releasability of the protective film was not greater than 1.6 Pa·m. Whether or not the protective film was peeled off, the protective film and the photosensitive film were easily slipped, so that they were not closely adhered to each other.

Thus, the protective film without the surface of a (PE+EVA) copolymer film was poor in adhesion to the photosensitive film.

### INDUSTRIAL AVAILABILITY

The photosensitive resin composition of the present invention is soluble and is capable of being laminated at temperatures not higher than 150° C., so that it can provide a solder resist capable of being directly laminated onto FPC without any adhesives. Further, the photosensitive resin composition provides a cover lay having excellent properties, such as heat resistance and few warps at the time of laminating onto the FPC. Furthermore, the cover lay film of the present invention is easy to handle because of a dry film type. More particularly, desired patterns are formed by exposing the desired patterns to light after the lamination of a photosensitive cover lay onto the substrate on which a circuit has been formed and removing unexposed part by developing after the formation of a cured layer by curing the exposed part to perform heat treatment at such temperatures that the cured layer may not be decomposed and the organic solvent may not be vaporized.

Accordingly, a dry process required for a conventional method for manufacturing a photosensitive cover lay using a liquids resin is not needed in the present invention because a cover lay is formed by laminating. In addition, a cover lay having excellent heat resistance and mechanical properties can be formed free from any damage on the substrate. The cover lay using the photosensitive resin composition of the present invention is suitable for a protective film of an electronic circuit, such as a flexible printed circuit board.

As mentioned above, in the cover lay film of the present invention, fine patterns can be formed because of having an elastic coefficient of 100 MPa to 2,500 MPa and it is possible to provide a photosensitive cover lay film suitable for the use of film-like photoresist and insulating protective film lasting resist because of excellent heat resistance and mechanical properties.

Moreover, the cover lay film using the photosensitive resin composition is easy to handle because of a dry film type, so that it can save time for drying in a manufacturing process of FPC. More particularly, desired patterns are exposed to light after laminating a photosensitive cover lay film onto the substrate on which a circuit has been formed to form a cured layer by curing an exposed part. And then the unexposed part was removed by development to form desired patterns by heat treatment at such temperatures that the cured layer may not be decomposed and the organic solvent may be vaporized.

The manufacturing method of the cover lay according to the present invention, therefore, does not need a dry process required for a conventional method for manufacturing a photosensitive cover lay consisting of liquid resin because a cover lay can be formed by only laminating. According to the present invention, it is also possible to form a cover lay film having excellent heat resistance and mechanical properties without any damage on the substrate because the cover lay film has a relatively low laminating temperature. The cover lay film using a photosensitive resin composition of the present invention is suitable to be used as a protective layer for electronic circuit, such as a flexible printed circuit board.

Additionally, the solder resist and the cover lay film composed of the photosensitive resin composition of the present invention can easily be developed with an alkali solution after exposure to light. For instance, a cover lay film laminate having desired patters with high precision can be effectively obtained by simple operation. If a composition of the present invention is used as a photosensitive cover lay film, operation, such as positioning on the substrate, which has been required in conventional methods will not be required. The composition after curing according to the present invention has sufficient mechanical strength and excellent hear resistance, so that the composition and the dry film resist according to the present invention are effectively used particularly for protecting a printed circuit board used in electronic parts field or for a suspension for a hard disk. The solder resist according to the present invention may be a three-layer structure sheet, in which the protective film is less changed with the laps of time due to no releasing agents in comparison with properties for storage in the case of other cover lays as well as having appropriate adhesion and easy releasability to a photosensitive adhesive sheet used as a cover lay for flexible printed circuit board. If the protective film has blocking effects, the protective film will have an advantage to prevent the photosensitive adhesive sheet from being deteriorated because of its clear distinction between the face and reverse when laminating the photosensitive adhesive sheet onto a flexible copper-clad laminate where the circuit has been formed.

There have thus been shown and described a novel photosensitive composition, a novel solder resist, a novel cover lay film, and a novel printed circuit board which comprise the photosensitive resin composition which fulfill all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and application which do not depart from the spirit and scope of the invention are deemed to be covered by the invention, which is to be limited only by the claims which follow.

What is claimed is:

1. A photosensitive resin composition of the present invention comprising as essential components:
(A) a soluble polyimide dissolved in solvent at the boiling point of not higher than 120° C.; and
(B) a compound having at least one aromatic ring and at least two carbon-carbon double bonds in one molecule,
wherein the soluble polyimide is obtained by using an acid dianhydride having one to six aromatic rings or an alicyclic acid dianhydride, and/or a diamine having one to six aromatic rings.

2. A photosensitive resin composition comprising:
(A) a soluble polyimide dissolved in solvent at the boiling point of not higher than 120° C.;
(B) a compound having at least one aromatic ring in one molecule and at least two carbon-carbon double bonds; and
(C) a photoreaction initiator and/or a sensitizer,
wherein the soluble polyimide is obtained by using an acid dianhydride having one to six aromatic rings or an alicylic acid dianhydride, and/or a diamine having one to six aromatic rings.

3. The photosensitive resin composition according to claim 1 or 2, wherein said component (A) includes a polyimide represented by the following general formula (1): 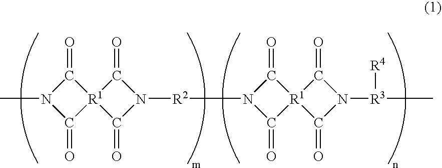
(wherein R¹ is a quadrivalent organic group, R² is a divalent organic group, R³ is a trivalent organic group, and R⁴ is a carboxy group or a hydroxyl group).

4. The photosensitive resin composition according to claim 3, wherein said polyimide includes a soluble polyimide having 200 to 3,000 COOH equivalent amount represented by the following general formula (1);

5. The photosensitive resin composition according to claim 1 or 2, wherein said soluble polyimide is represented by the following general formula (1): 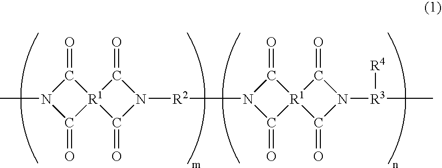
(wherein R¹ is a quadrivalent organic group, R² is a divalent organic group, R³ is a trivalent organic group, and R⁴ is a carboxy group, a hydroxyl group, or the following group (I): 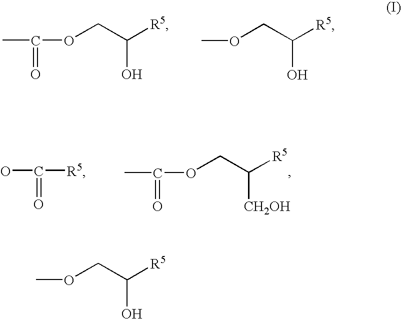
(wherein R⁵ is a monovalent organic group having at least one group selected from the groups consisting of an epoxy group, a carbon-carbon triple bond and a carbon-carbon double bond).

6. The photosensitive resin composition according to any one of claims 3 to 5, wherein said polyimide represented by the general formula (1) is obtained by using a diamine having at least two carboxy groups or two hydroxy groups in a molecule.

7. The photosensitive resin composition according to any one of claims 3 to 5, wherein said component (A) is a polyimide obtained by using another diamine having a siloxane bond.

8. The photosensitive resin composition according to claim 7, wherein said soluble polyimide includes the following general formula (2): 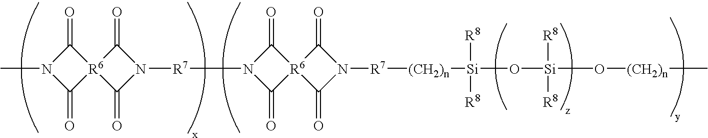
(wherein R⁶ is a quadrivalent organic group, R⁷ is a divalent organic group, and R⁸ is a monovalent organic group. x is an integer at least 1, y is an integer at least 1, z is an integer from 1 to 40, and n is an integer from 1 to 5).

9. The photosensitive resin composition according to claim 8, wherein said soluble polyimide is a polyimide obtained by using 5 to 95 mole % of siloxane diamine in total diamines selected from the following general formula (3): 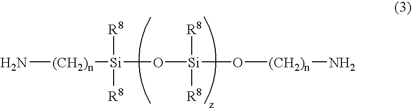
(wherein R⁸ represents alkyl having 1 to 12 carbons, phenyl, or methoxy groups, z is an integer from 1 to 40, n independently represents an integer from 1 to 20).

10. The photosensitive resin composition according to any one of claims 3 to 5, wherein said soluble polyimide is a polyimide obtained by using 5 to 99 mole % of diamine in total diamines selected from the following general formula (4): 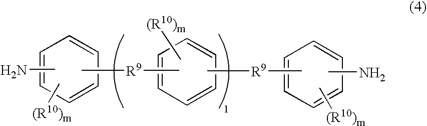
(wherein R⁹ represents —O—, —CH₂—, —CO—, a single bond, —C(CF₃)₂—, —C(CH₃)₂—, —COO—, or —SO₂—, R¹⁰ represents hydrogen, halogen, methoxy groups, —OH, —COOH or alkyl group having C1 to C5, l is 0, 1, 2, 3, or 4. m is 0, 1, 2, or 3).

11. The photosensitive resin composition according to any one of claims 3 to 5, wherein said soluble polyimide is a polyimide obtained by using 10 to 100 mole % of acid dianhydride in total acid dianhydrides selected from the general formulae (5) and 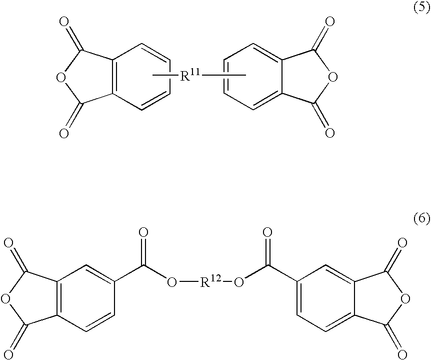
(wherein R¹¹ represents a single bond, —CO—, —O—, —C(CF₃)₂—, —SO₂—, or —C(CH₃)₂—, R¹² is a divalent organic group).

12. The photosensitive resin composition according to claim 11, wherein said soluble polyimide is a polyimide obtained by using 5 to 95 mole % of acid dianhydride in total acid dianhydrides represented by the general formula (6) wherein R¹² is selected from the group (II) in: 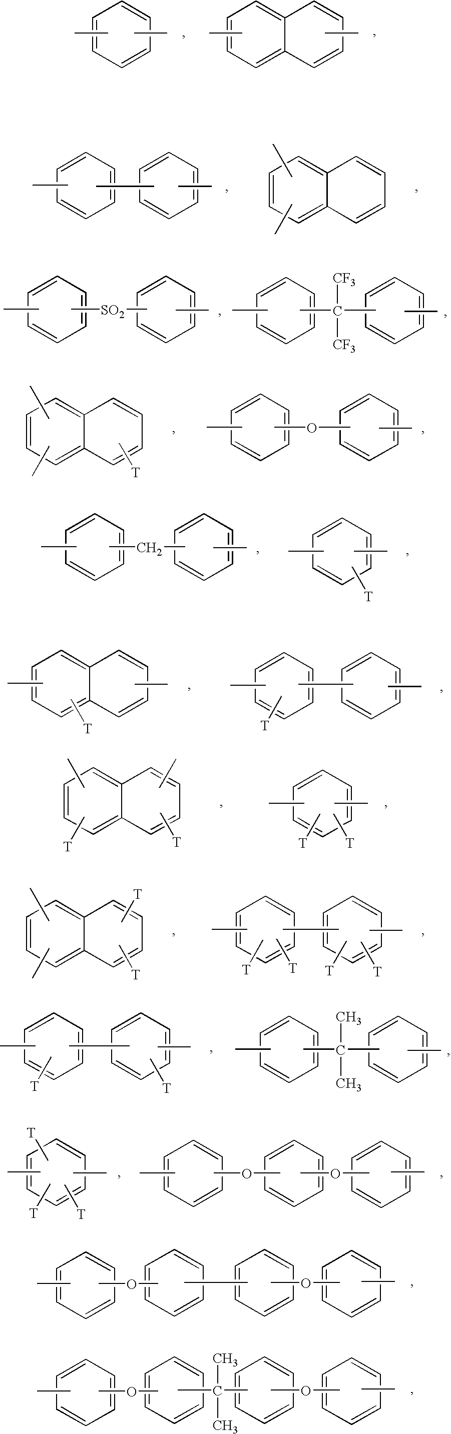 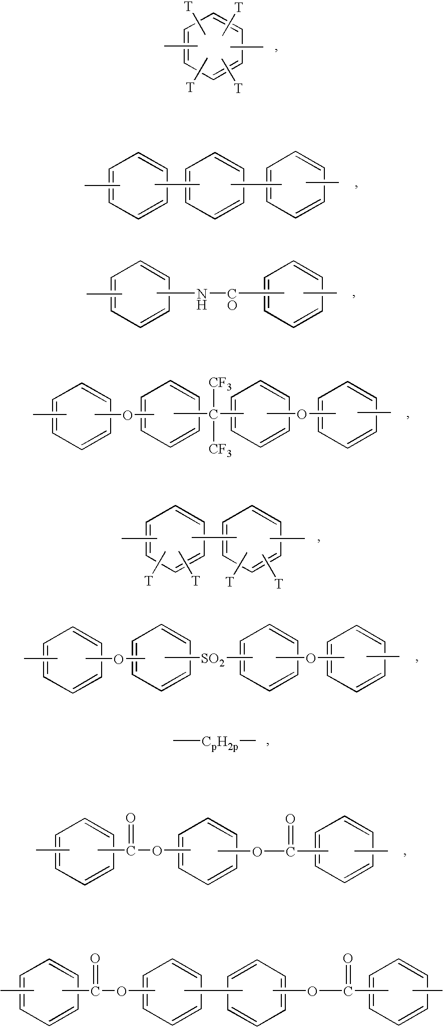
(wherein p is an integer from 1 to 20.)
(T represents H, F, Cl, Br, I, or MeO, an alkyl group having 1 to 20 carbons).
Group (II)

13. The photosensitive resin composition according to claim 11, wherein said acid dianhydride is represented by the general formula (7): 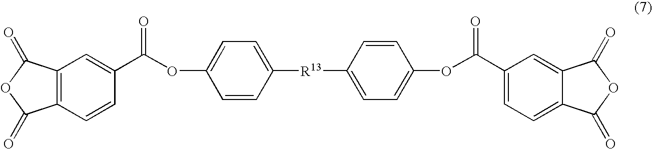
(wherein R¹³ is —O—, —CO—, a single bond, —C(CF₃)₂—, —C(CH₃)₂—, —COO—, or —SO₂—).

14. The photosensitive resin composition according to claim 1 or 2, wherein said soluble polyimide (A) has a glass transition temperature from 100° C. to 300° C.

15. The photosensitive resin composition according to claim 1 or 2, having an elastic coefficient after curing from 10 to 3,000 MPa.

16. The photosensitive resin composition according to claim 1 or 2, further having a pylolysis starting temperature after curing of not lower than 300° C.

17. The photosensitive resin composition according to claim 1 or 2, further having a curing temperature of not higher than 200° C.

18. The photosensitive resin composition according to claim 1 or 2, further having soldering heat resistance (300° C.) after curing at least for 3 minutes.

19. The photosensitive resin composition according to claim 1 or 2, further having a coefficient of thermal expansion after curing from 20 ppm to 500 ppm.

20. The photosensitive resin composition according to claim 1 or 2, wherein said photoreaction initiator has a radical development potency using at least either of g line or i line.

21. The photosensitive resin composition according to claim 1 or 2, further having a glass transition temperature after curing from 50° C. to 300° C.

22. The photosensitive resin composition according to claim 1 or 2, wherein said component (B) is a copolymerization monomer having a carbon-carbon double bond.

23. The photosensitive resin composition according to claim 22, wherein said component (B) is a polyfunctional (meta) acrylic compound consisting of a polyfunctional (meta) acrylic compound and/or its similar material.

24. The photosensitive resin composition according to claim 23, wherein said polyfunctional (meta) acrylic compound is bi-functional and has a repeated unit of (—O—CH₂CH₂—).

25. The photosensitive resin composition according to claim 24, wherein said component (B) is at least one kind of diacrylate selected from Bisphenol F EO-modefied diacrylate, Bisphenol A EO-modified diacrylate or Bisphenol S EO denatured diacrylate.

26. The photosensitive resin composition according to claim 1 or 2, further comprising 100 parts by weight of component (A) and 1 to 200 parts by weight of component (B).

27. The photosensitive resin composition according to claim 2, comprising as essential component
(A) said soluble polyimide 100 parts by weight
(B) a compound having at least one aromatic ring and two carbon-carbon double bonds in one molecule 1 to 200 parts by weight, and
(C) a photoreaction initiator and/or sensitizer 0.1 to 50 parts by weight.

28. The photosensitive resin composition according to claim 1 or 2, comprising (A) said soluble polyimide, (B) a compound having at least one aromatic ring and two carbon-carbon double bonds in a molecule, and (C) a photoreaction initiator and/or a sensitizer,
wherein the component (A) is contained from 30 to 90 parts by weight in relative to 100 parts by weight of the total weight of (A) and (B), the component (B) is contained from 10 to 70 parts by weight in relative to 100 parts by weight of the total weight of (A) and (B), and the component(C) is contained from 0.01 to 10 parts by weight in relative to 100 parts by weight of the total weight of (A) and (B).

29. A photosensitive film comprising a resin composition according to claims 1 to 2, said photosensitive resin can be laminated at not higher than 150° C.

30. The photosensitive film according to claim 29, having a compression bonding temperature in B-stage state from 20° C. to 150° C.

31. A method for manufacturing a photosensitive film comprising a process of applying an organic solvent solution of the photosensitive resin composition according to claim 1 or 2 onto a base film and drying.

32. A solder resist comprising at least the photosensitive resin composition according to claim 1 or 2.

33. The solder resist comprising at least the photosensitive resin composition according to claim 1 or 2, said solder resist being soluble when not exposed to light and insoluble in alkali water solution by polymerization reaction caused by the exposure to light.

34. A cover lay film comprising at least the photosensitive resin composition according to claim 1 or 2, wherein the cover lay film has a compression bonding temperature from 20° C. to 150° C.

35. The cover lay film comprising the photosensitive resin composition according to claim 1 or 2, wherein said cover lay being insoluble in alkali water solution by polymerization reaction caused by the exposure to light soluble in the solution when not exposed to light.

36. The cover lay film according to claim 34 or 35, having resolution not greater than line width/space width=100/100 μm.

37. A cover lay film comprising a three-layer structure sheet obtained by laminating a base film, a photosensitive film, and a protective film laminated in order,
wherein the protective film comprises (a) a copolymer film of polyethylene and an ethylene vinyl alcohol resin and (b) a laminate film of a polyethylene film, and a bonded surface with the photosensitive film can be formed on the copolymer film (a) side of the protective film.

38. The cover lay film according to claim 37, wherein said photosensitive film has a thickness from 5 to 75 μm.

39. The cover lay film according to claim 37, wherein said copolymer film (a) consisting of said protective film has a thickness from 2 to 50 μm, and said polyethylene film (b) has a thickness of 10 to 50 μm.

40. The cover lay film according to claim 37, wherein said base film is a polyethylene terephthalate film.

41. The cover lay film according to any one of claim 34 or 37, used for a flexible printed circuit board.

42. The cover lay film according to any one of claim 34 or 37, used for a suspension for a hard disk.

43. The cover lay film according to any one of claim 34 or 37, used for a head part of a hard disk memory device.

44. A printed circuit board having a lamination of the cover lay film according to any one of claim 34 or 37.
